(19) United States
(12) Patent Application Publication
(10) Pub. No.: US 2011/0287244 A1
(43) Pub. Date: Nov. 24, 2011

(54) HYDROPHILIC FILM

(75) Inventors: Yuichiro Murayama, Kanagawa (JP); Yoshiaki Kondo, Shizuoka (JP)

(73) Assignee: Fujifilm Corporation, Tokyo (JP)

(21) Appl. No.: 13/147,087

(22) PCT Filed: Jan. 29, 2010
(86) PCT No.: PCT/JP2010/051286

§ 371 Date: Jul. 29, 2011

(30) Foreign Application Priority Data
Jan. 30, 2009 (JP) 2009-020607

(51) Int. Cl. B32B 3/00; B32B 27/36

(52) U.S. Cl. 428/220; 428/480

(57) ABSTRACT

A hydrophilic film comprising a hydrophilic layer formed with a hydrophilic composition on a polyester film, wherein the hydrophilic composition contains 80% by weight or more of a hydrophilic polymer based on a total solid content of the hydrophilic composition.

### TECHNICAL FIELD

The present invention relates to a hydrophilic film having a hydrophilic layer formed by using a hydrophilic composition containing a hydrophilic polymer on a polyester film.

### BACKGROUND ART

Techniques for imparting antifogging property by attaching a hydrophilic film having a hydrophilic composition coated thereon on a mirror, for example, a mirror for bathroom or washstand or a window of house or building are known (see Patent Documents 1 to 6).

However, the techniques described in Patent Documents 1 to 5 have problems in that sustainment of the antifogging property is insufficient, in that the coated hydrophilic layer dissolves to deteriorate visibility and in that due to rubbing, for example, with a wet cloth scratches are formed on the surface of coated layer to deteriorate visibility. Further, the technique of Patent Document 6 is not a method of coating a layer having an antifogging property but a method where the antifogging property is imparted by incorporating a heater in a mirror and it has disadvantages in that a large-scale equipment is required and the cost increases.

### PRIOR ART DOCUMENT

### Patent Document

Patent Document 1: JP-A-2002-322422
Patent Document 2: JP-A-2008-150454
Patent Document 3: JP-A-2008-156530
Patent Document 4: JP-A-2008-195553
Patent Document 5: JP-A-2001-40294
Patent Document 6: JP-A-8-317841

### DISCLOSURE OF THE INVENTION

### Problems that the Invention is to Solve

An object of the present invention is to provide a hydrophilic film excellent in the sustainability of antifogging effect, rubbing resistance and self-cleaning property.

### Means for Solving the Problems

(1) A hydrophilic film comprising a hydrophilic layer formed by using a hydrophilic composition on a polyester film, wherein the hydrophilic composition contains 80% by weight or more of a hydrophilic polymer based on a total solid content of the hydrophilic composition.
(2) The hydrophilic film as described in (1) above, wherein the hydrophilic polymer contains at least one polar group selected from a group shown below and an alkoxysilyl group:
Polar group: —CONH₂, —COOM and —OH

(wherein M represents a hydrogen atom, an alkali metal or an alkaline earth metal);
Alkoxysilyl group: —Si—(OR)ₙR₃₋ₙ

(wherein R each independently represents —CH₃, —C₂H₅ or —C₃H₇, and n represents 2 or 3).
(3) The hydrophilic film as described in (1) or (2) above, which has an intermediate layer formed by using a composition containing at least one compound selected from tetramethoxysilane, methyltrimethoxysilane, tetraethoxysilane and methyltriethoxysilane between the polyester film and the hydrophilic layer.
(4) The hydrophilic film as described in (3) above, wherein the polar group of the hydrophilic polymer is at least one group selected from —CONH₂, —COOM and —OH and the intermediate layer is formed by using a composition containing at least one compound selected from tetramethoxysilane and methyltrimethoxysilane.
(5) The hydrophilic film as described in (3) or (4) above, wherein a thickness of the hydrophilic layer and the intermediate layer is from 30 to 200 nm.
(6) The hydrophilic film as described in any one of (1) to (5) above, wherein a water droplet contact angle on a surface of the hydrophilic layer after repeating 100 cycles of spraying water on the surface of the hydrophilic layer and drying at 80° C. for 5 seconds is 15° or less.

### Advantage of the Invention

The present invention relates to a hydrophilic film having a hydrophilic layer having an extremely high hydrophilicity on a polyester film and exerts an excellent antifogging property. Since the hydrophilic layer does not contain a hydrophilic inorganic material as typified by colloidal silica or the like and contains, as a main component, a hydrophilic polymer, for example, a polymer having both a polar group having a high hydrophilicity such as acrylamide and an alkoxysilyl group capable of forming a crosslinking structure having a high hydrophilicity by hydrolysis, it exhibits a tough and excellent antifogging property and is excellent in a self-cleaning property. Also, after repeating bedewing and drying, water stain hardly adheres and the antifogging property can be sustained for a long period of time. It also has a feature in that even when oil stains or the likes adhere thereto, they are easily removed by washing with water. In addition, it has rubbing resistance in that scratches are hardly formed even when it is repeatedly rubbed, for example, with a wet cloth. Moreover, since the effects described above can be achieved with a thin layer in comparison with prior art, visibility and design of a member to which the hydrophilic film is attached are less damaged.

### MODE FOR CARRYING OUT THE INVENTION

The invention will be described in detail below.

The hydrophilic film according to the invention is a hydrophilic film having a hydrophilic layer formed by using a hydrophilic composition on a polyester film, wherein the hydrophilic composition contains 80% by weight or more of a hydrophilic polymer based on the total solid content of the hydrophilic composition.

### [Hydrophilic Polymer]

The hydrophilic composition according to the invention contains 80% by weight or more of a hydrophilic polymer based on the total solid content of the hydrophilic composition.

The hydrophilic polymer is not particularly restricted and as a preferred main chain structure which the hydrophilic polymer has, for example, an acrylic resin, a methacrylic resin, a polyvinyl acetal resin, a polyurethane resin, a polyurea resin, a polyimide resin, a polyamide resin, an epoxy resin, a polystyrene resin, a novolac type phenolic resin, a polyester resin, a synthesis rubber and a natural rubber are exemplified. In particular, an acrylic resin or a methacrylic resin is preferred and an acrylic resin is more preferred for the reason of excellence in adhesion property to a base material made of polyester. The hydrophilic polymer may be a copolymer and the copolymer may be a random copolymer.

As the hydrophilic polymer, at least any one of a hydrophilic polymer (I) containing a structure represented by formula (I-1) and a structure represented by formula (I-2), a hydrophilic polymer (II) containing a structure represented by formula (II-1) and a structure represented by formula (II-2) and a hydrophilic polymer (III) containing a structure represented by formula (III-1) and a structure represented by formula (III-2) is preferred.

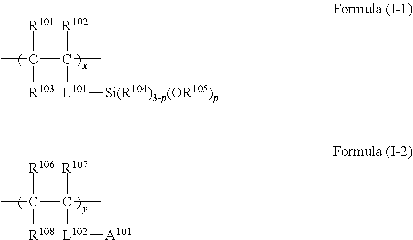

In formulae (I-1) and (I-2), R¹⁰¹ to R¹⁰⁸ each independently represents a hydrogen atom or a hydrocarbon group. p represents an integer from 1 to 3. L¹⁰¹ and L¹⁰² each independently represents a single bond or a polyvalent organic connecting group. x and y each represents a composition ratio and x represents a number satisfying 0<x<100 and y represents a number satisfying 0<y<100. A¹⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{C} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

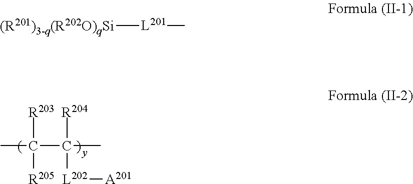

In formulae (II-1) and (II-2), R²⁰¹ to R²⁰⁵ each independently represents a hydrogen atom or a hydrocarbon group. q represents an integer from 1 to 3. L²⁰¹ and L²⁰² each independently represents a single bond or a polyvalent organic connecting group. A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(Rₑ) or —PO₃(R_{d})(Rₑ), wherein Rₐ, R_{b} and R_{C} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

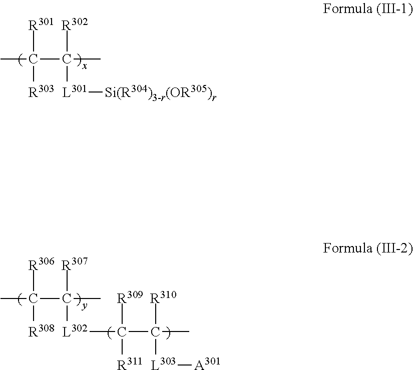

In formulae (III-1) and (III-2), R³⁰¹ to R³¹¹ each independently represents a hydrogen atom or a hydrocarbon group. r represents an integer from 1 to 3. L³⁰¹ to L³⁰³ each independently represents a single bond or a polyvalent organic connecting group. x and y each represents a composition ratio and x represents a number satisfying 0<x<100 and y represents a number satisfying 0<y<100. A³⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N (Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{c} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

### [Hydrophilic Polymer (I) Containing Structure Represented by Formula (I-1) and Structure Represented by Formula (I-2)]

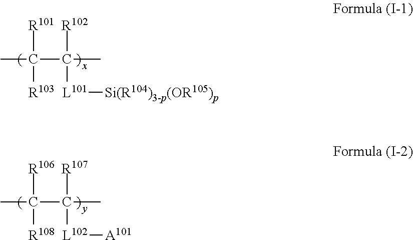

In formulae (I-1) and (I-2), R¹⁰¹ to R¹⁰⁸ each independently represents a hydrogen atom or a hydrocarbon group. p represents an integer from 1 to 3. L¹⁰¹ to L¹⁰² each represents a single bond or a polyvalent organic connecting group. x and y each represents a composition ratio and x represents a number satisfying 0<x<100 and y represents a number satisfying 0<y<100. A¹⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{C} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

In formulae (I-1) and (I-2), R¹⁰¹ to R¹⁰⁸ each independently represents a hydrogen atom or a hydrocarbon group. The hydrocarbon group includes an alkyl group, an aryl group and the like and is preferably a straight-chain, branched or cyclic alkyl group having from 1 to 8 carbon atoms. Specific examples thereof include a methyl group, an ethyl group, a propyl group, a butyl group, a pentyl group, a hexyl group, a heptyl group, an octyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group and a cyclopentyl group. Each of R¹⁰¹ to R¹⁰⁸ is preferably a hydrogen atom, a methyl group or an ethyl group from the standpoint of the effects and ease in availability.

The hydrocarbon group may further have a substituent. When the alkyl group has a substituent, the substituted alkyl group is composed of a combination of a substituent and an alkylene group and as the substituent a monovalent nonmetallic atomic group exclusive of a hydrogen atom is used. Preferable examples thereof include a halogen atom (—F, —Br, —Cl or —I), a hydroxy group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group,
an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and its conjugated base group (hereinafter referred to as a “sulfonato group”), an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, a phosphono group (—PO₃H₂) and its conjugated base group (hereinafter referred to as a “phosphonato group”), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and its conjugated base group (hereinafter referred to as an “alkylphosphonato group”), a monoarylphosphono group (—PO₃H(aryl)) and its conjugated base group (hereinafter referred to as an “arylphosphonato group”), a phosphonooxy group (—OPO₃H₂) and its conjugated base group (hereinafter referred to as a “phosphonatooxy group”), a dialkylphosphonooxy group (—OPO₃(alkyl)₂), a diarylphosphonooxy group (—OPO₃(aryl)₂), an al kylarylphosphonooxy group (—OPO₃(alkyl)(aryl)), a monoalkylphosphonooxy group (—OPO₃H(alkyl)) and its conjugated base group (hereinafter referred to as an “alkylphosphonatooxy group”), a monoarylphosphonooxy group (—OPO₃H(aryl)) and its conjugated base group (hereinafter referred to as an “arylphosphonatooxy group”), a morpholino group, a cyano group, a nitro group, an aryl group, an alkenyl group and an alkynyl group.

In the substituents, specific examples of the alkyl group include those described for the alkyl group in R¹⁰¹ to R¹⁰⁸. Specific examples of the aryl group include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxycarbonylphenyl group, a phenoxycarbonylphenyl group, an N-phenylcarbamoylphenyl group, a phenyl group, a cyanophenyl group, a sulfophenyl group, a sulfonatophenyl group, a phosphonophenyl group and a phosphonatophenyl group. Also, examples of the alkenyl group include a vinyl group, a 1-propenyl group, a 1-butenyl group, a cinnamyl group and a 2-chloro-1-ethenyl group. Examples of the alkynyl group include an ethynyl group, a 1-propynyl group, a 1-butynyl group and a trimethylsilylethynyl group. Examples of G₁ in the acyl group (G₁CO—) include a hydrogen atom and the above-described alkyl group and aryl group.

Of the substituents, a halogen atom (—F, —Br, —Cl or —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, a dialkylphosphono group, a diarylphosphono group, a monoalkylphosphono group, an alkylphosphonato group, a monoarylphosphono group, an arylphosphonato group, a phosphonooxy group, a phosphonatooxy group, an aryl group and an alkenyl group are more preferred.

On the other hand, as an alkylene group in the substituted alkyl group, a divalent organic residue resulting from elimination of any one of hydrogen atoms on an alkyl group having from 1 to 20 carbon atoms can be preferably exemplified. The alkylene group is more preferably a straight-chain alkylene group having from 1 to 12 carbon atoms, still more preferably from 1 to 8 carbon atoms, a branched alkylene group having from 3 to 12 carbon atoms, still more preferably from 3 to 8 carbon atoms, and a cyclic alkylene group having from 5 to 10 carbon atoms, still more preferably from 5 to 8 carbon atoms. Prefered specific examples of the substituted alkyl group which is obtained by combining the above-described substituent with the alkylene group include a chloromethyl group, a bromomethyl group, a 2-chloroethyl group, a trifluoromethyl group, a hydroxymethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-oxyethyl group, a 2-oxypropyl group, a carboxypropyl group, a methoxycarbonylethyl group, an allyloxycarbonylbutyl group,
a chlorophenoxycarbonylmethyl group, a carbamoylmethyl group, an N-methylcarbamoylethyl group, an N,N-dipropylcarbamoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonooxypropyl group, a phosphonatooxybutyl group, a benzyl group, a phenethyl group, an a-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group and a 3-butynyl group.

From the standpoint of hydrophilicity, of the groups described above, a hydroxymethyl group is preferred.

L¹⁰¹ and L¹⁰² each represents a single bond or a polyvalent organic connecting group. The term “single bond” as used herein means that the main chain of the polymer and X are directly connected without a connecting chain.

When each of L¹⁰¹ and L¹⁰² represents a polyvalent organic connecting group, L¹⁰¹ or L¹⁰² represents a polyvalent connecting group comprising nonmetallic atom and is preferably composed of one or more atoms selected from from 0 to 60 carbon atoms, from 0 to 10 nitrogen atoms, from 0 to 50 oxygen atoms, from 0 to 100 hydrogen atoms and from 0 to 20 sulfur atoms. Specifically, it is preferably selected from —N<, an aliphatic group, an aromatic group, a heterocyclic group and a combination thereof and is preferably a divalent connecting group of —O—, —S—, —CO—, —NH— or a combination containing —O—, —S—, —CO— or —NH—.

More specific examples of the connecting group include structural units shown below and combinations of these structural units.

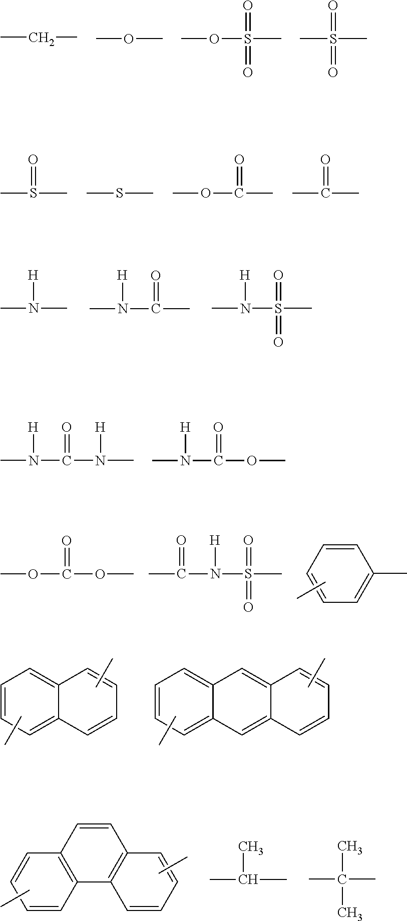

In formulae (I-1) and (I-2), L¹⁰¹ and L¹⁰² each independently represents a single bond or a polyvalent organic connecting group. The term “single bond” as used herein means that the main chain of the polymer and A¹⁰¹ or Si atom are directly connected without a connecting chain.

In formula (I-1), L¹⁰¹ is preferably a single bond or a connecting group having one or more structures selected from the group consisting of —CH₂—, —CONH—, —NHCONH—, —OCONH—, —SO₂NH— and —SO₃—. L¹⁰¹ more preferably contains —CH₂— and —CONH— and is still more preferably —CONH—(CH₂)ₙ₁— (wherein n1 represents an integer form 1 to 5, preferably from 1 to 4, and more preferably 2 or 3).

In formula (I-2), L¹⁰² is preferably a single bond.

In formula (I-2), A¹⁰¹ represents —OH, —OR, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(Rₑ), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{C} each independently represents a hydrogen atom or a straight-chain, branched or cyclic alkyl group (preferably having from 1 to 8 carbon atoms), R_{d} represents a straight-chain, branched or cyclic alkyl group (preferably having from 1 to 8 carbon atoms), Rₑ and R_{f} each independently represents a hydrogen atom, a straight-chain, branched or cyclic alkyl group (preferably having from 1 to 8 carbon atoms), an alkali metal, an alkaline earth metal or an onium, and R_{g} represents a halide ion, an inorganic anion or an organic anion. Also, in —CON(Rₐ)(R_{b}), —N(Rₐ)(R_{b}), —OCON(Rₐ)(R_{b}), —NHCON(Rₐ)(R_{b}), —SO₂N(Rₐ)(R_{b}), —N(Rₐ)(R_{b})(R_{c}), —N(Rₐ)(R_{b})(R_{c})(R_{g}), —PO₃(Rₑ) (R_{f}), —OPO₃(Rₑ)(R_{f}) or —PO₃(R_{d})(Rₑ), Rₐ to R_{g} may be combined with each other to form a ring and the ring formed may be a hetero ring containing a hetero atom, for example, an oxygen atom, a sulfur atom or a nitrogen atom. Rₐ to R_{g} may further have a substituent and the substituent capable of being introduced includes those described for the alkyl group when each of R¹⁰¹ to R¹⁰⁸ represents the alkyl group

In Rₐ to R_{f}, as the straight-chain, branched or cyclic alkyl group, specifically, a methyl group, an ethyl group, a propyl group, a butyl group, a pentyl group, a hexyl group, a heptyl group, an octyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group or the like is suitably exemplified.

In Rₐ to R_{g}, as the alkali metal, lithium, sodium, potassium or the like, as the alkaline earth metal, barium or the like, and as the onium, an ammonium, an iodonium, a sulfonium or the like are suitably exemplified, respectively.

As the halide ion, a fluoride ion, a chloride ion or a bromide ion is exemplified. As the inorganic anion, a nitrate anion, a sulfate anion, a tetrafluoroborate anion, a hexafluorophosphate anion or the like, and as the organic anion, a methanesulfonate anion, a trifluoromethanesulfonate anion, a nonafluorobutanesulfonate anion, a p-toluenesulfonate anion or the like are suitably exemplified, respectively.

As A¹⁰¹, specifically, —NHCOCH₃, —CONH₂, —CON(CH₃)₂, —COOH, —SO₃⁻NMe₄⁺, −SO₃⁻K⁺, −(CH₂CH₂O)ₙH, a morpholyl group or the like is preferred, and —NHCOCH₃, —CONH₂, —CON(CH₃)₂, —SO₃⁻K⁺ or —(CH₂CH₂O)ₙH is more preferred. In the above, n represents preferably an integer form 1 to 100.

p represents an integer from 1 to 3, preferably 2 or 3, and more preferably 3.

It is preferred that R^{101,} R¹⁰² and R¹⁰³ are hydrogen atoms respectively and R¹⁰⁵ is a hydrocarbon group. R¹⁰⁵ is more preferably an alkyl group giving from 1 to 12 carbon atoms, and still more preferably an alkyl group giving from 1 to 6 carbon atoms.

In the hydrophilic polymer containing the structure represented by formula (I-1) and the structure represented by formula (I-2), x and y each represents a composition ratio of the structural unit represented by formula (I-1) and the structural unit represented by formula (I-2) in the hydrophilic polymer. x represents a number satisfying 0<x<100 and y represents a number satisfying 0<y<100. x is preferably a number satisfying 1<x<90, and more preferably a number satisfying 1<x<50. y is preferably a number satisfying 10<y<99, and more preferably a number satisfying 50<y<99.

The copolymerization ratio in the hydrophilic polymer containing of the structure represented by formula (I-1) and the structure represented by formula (I-2) can be appropriately set so that the amount of the structure represented by formula (I-2) having a hydrophilic group falls within the range described above. A rate of a molar ratio (y) of the structural unit represented by formula (I-2) to a molar ratio (x) of the structural unit represented by formula (I-1) having a hydrolyzable silyl group is preferably in a range of y/x=30/70 to 99/1, more preferably in a range of y/x=40/60 to 98/2, and most preferably in a range of y/x=50/50 to 97/3. When y/x is 30/70 or more, the hydrophilicity is not insufficient, whereas when y/x is 99/1 or less, an amount of the hydrolyzable silyl group is enough to achieve sufficient curing thereby ensuring the film strength.

A weight average molecular weight of the polymer containing the structure represented by formula (I-1) and the structure represented by formula (I-2) is preferably from 1,000 to 1,000,000, more preferably from 1,000 to 500,000, and most preferably from 1,000 to 200,000.

Specific examples of the hydrophilic polymer containing the structure represented by formula (I-1) and the structure represented by formula (I-2) are set forth below together with the weight average molecular weight (M.W.) thereof, but the invention should not be construed as being limited thereto. The polymers specifically set forth below indicate random copolymers or block copolymers containing the respective structural units in the molar ratios as described.

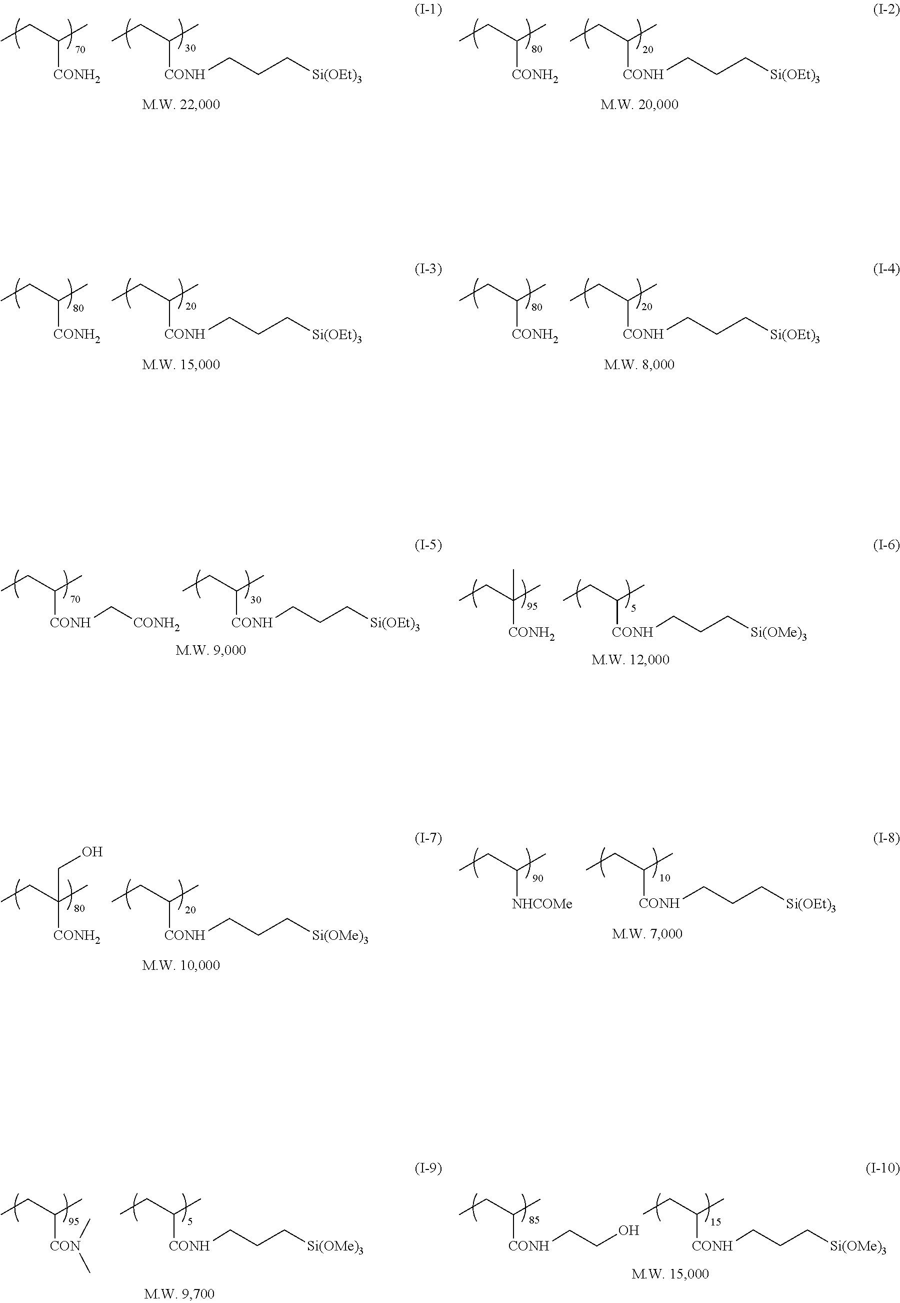

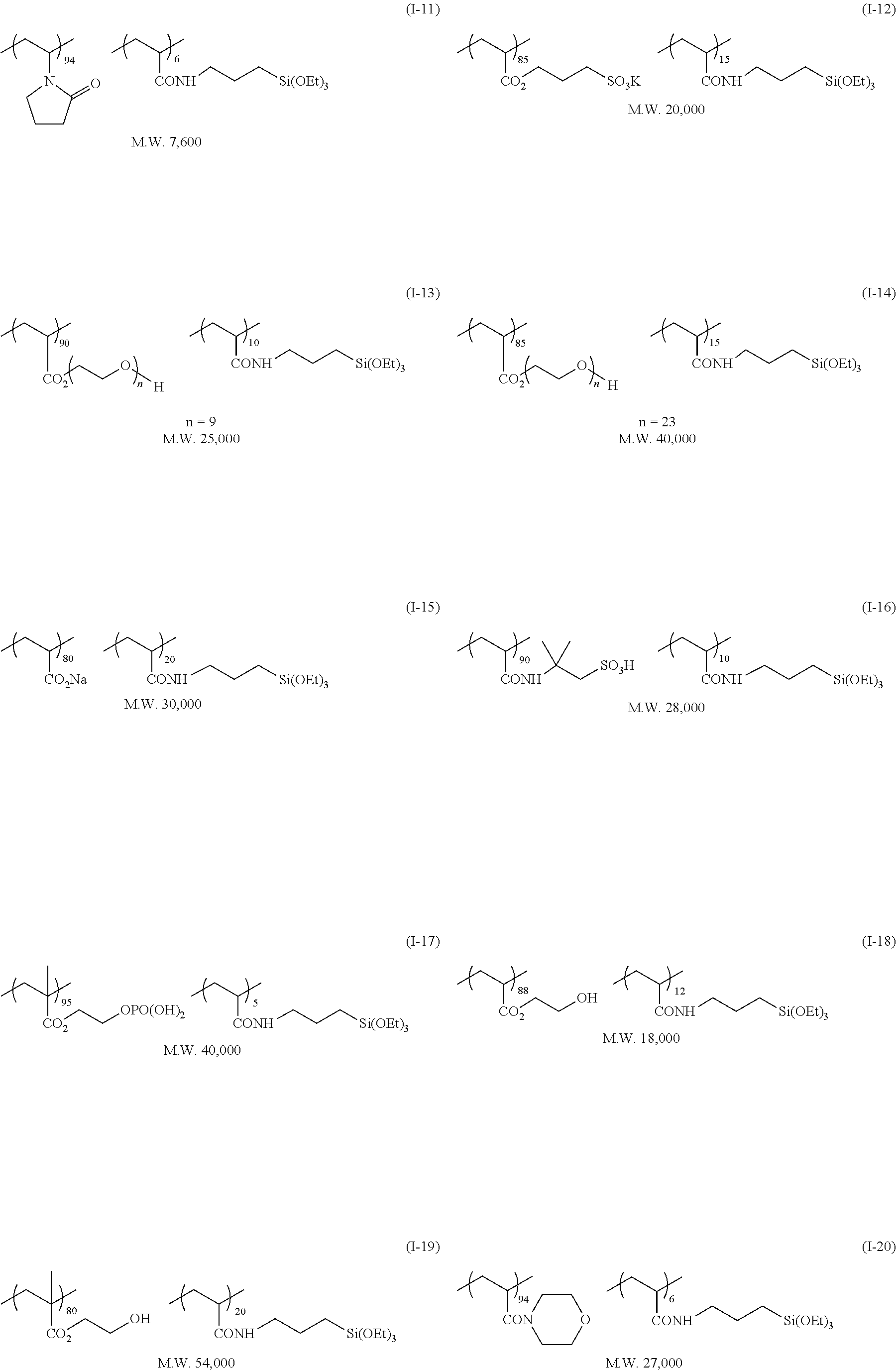

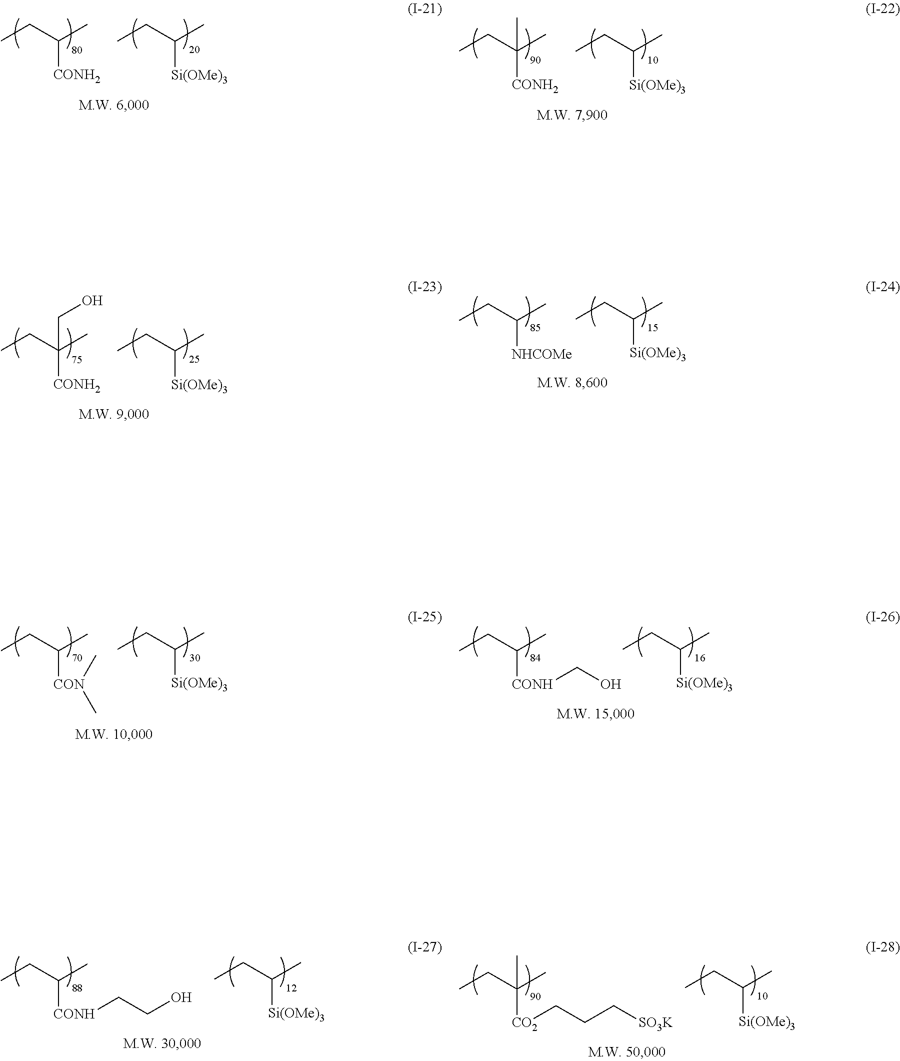

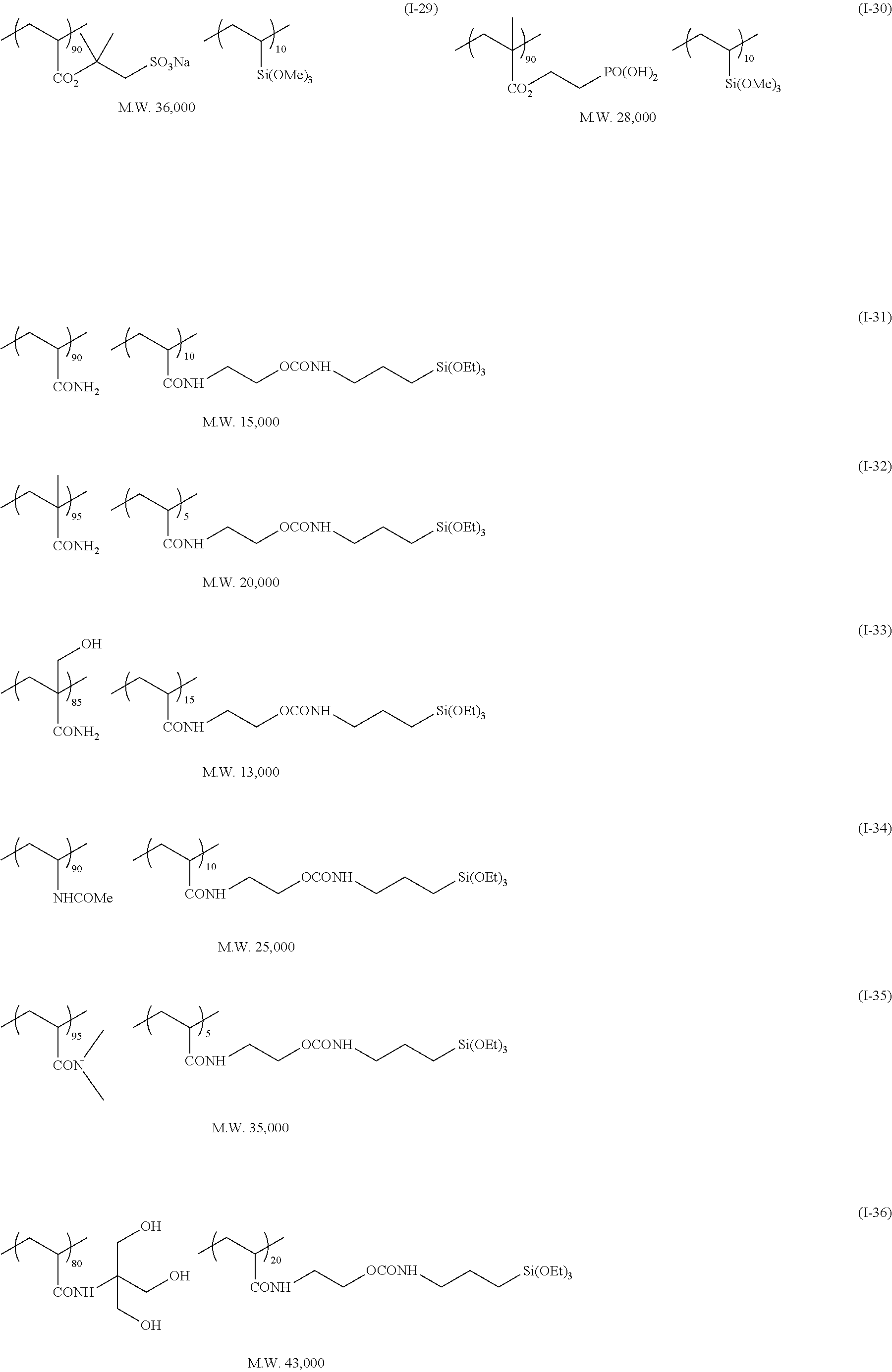

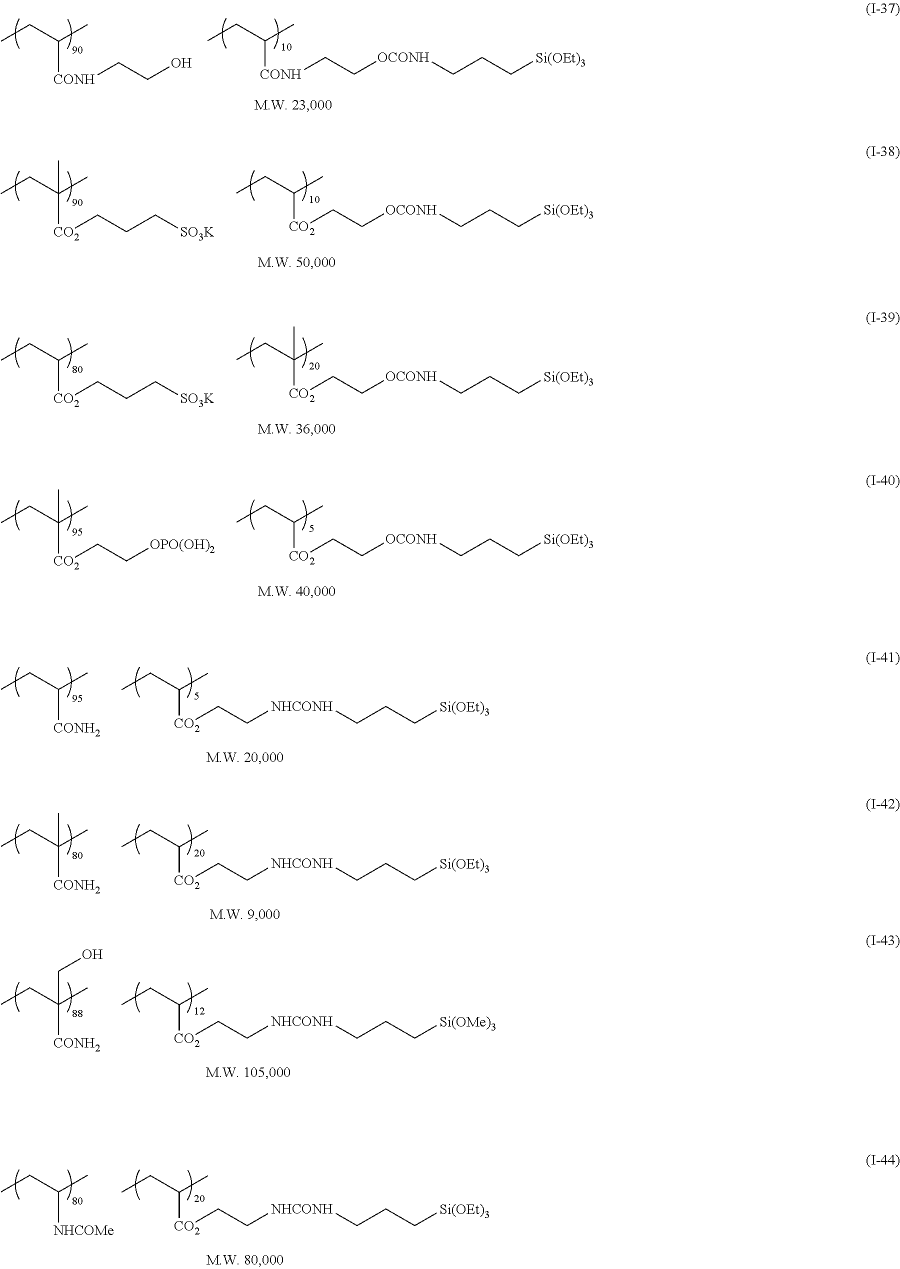

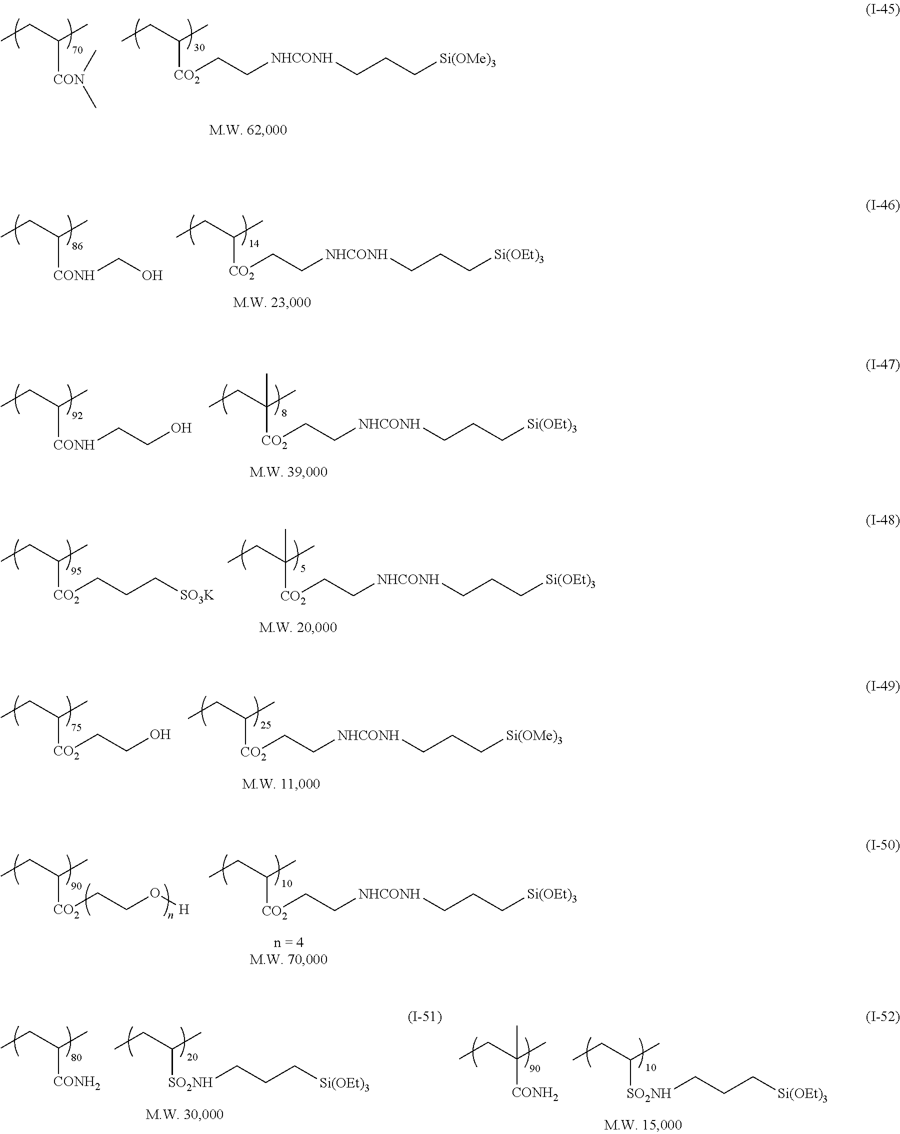

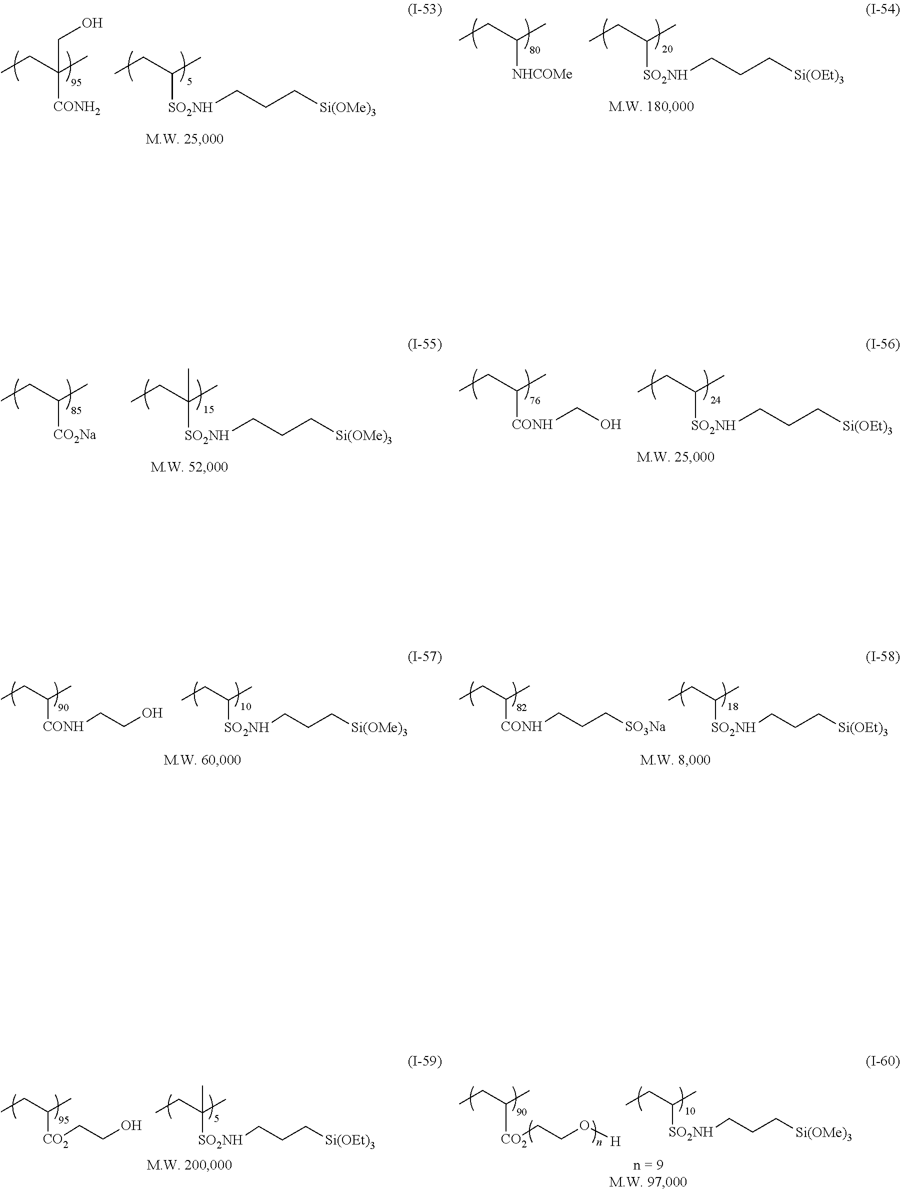

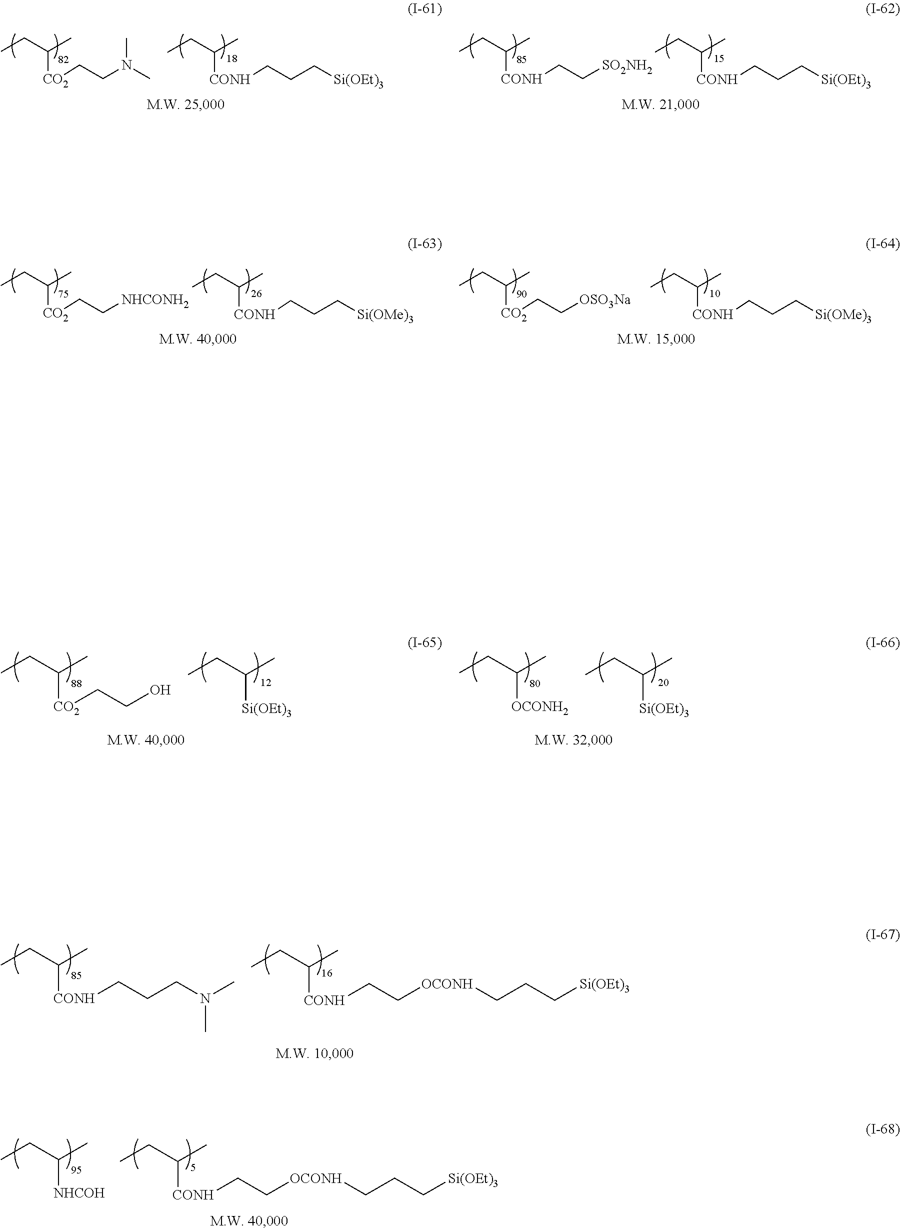

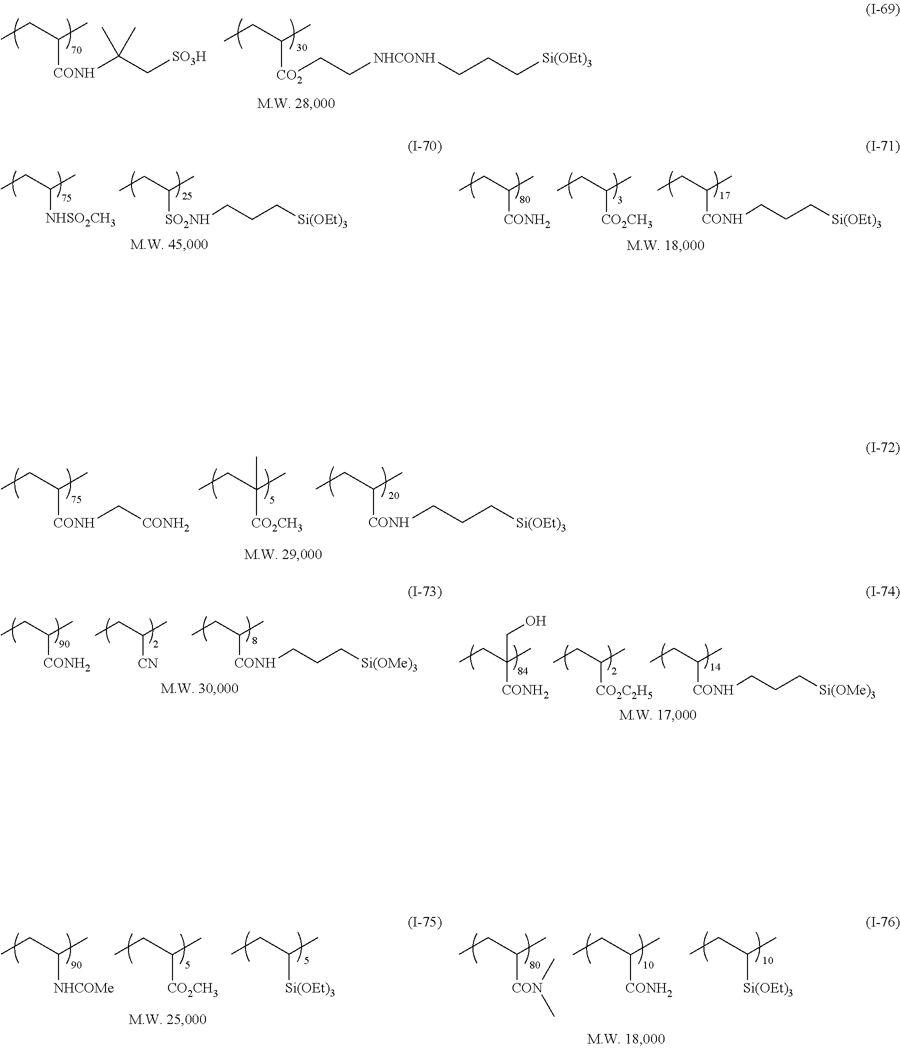

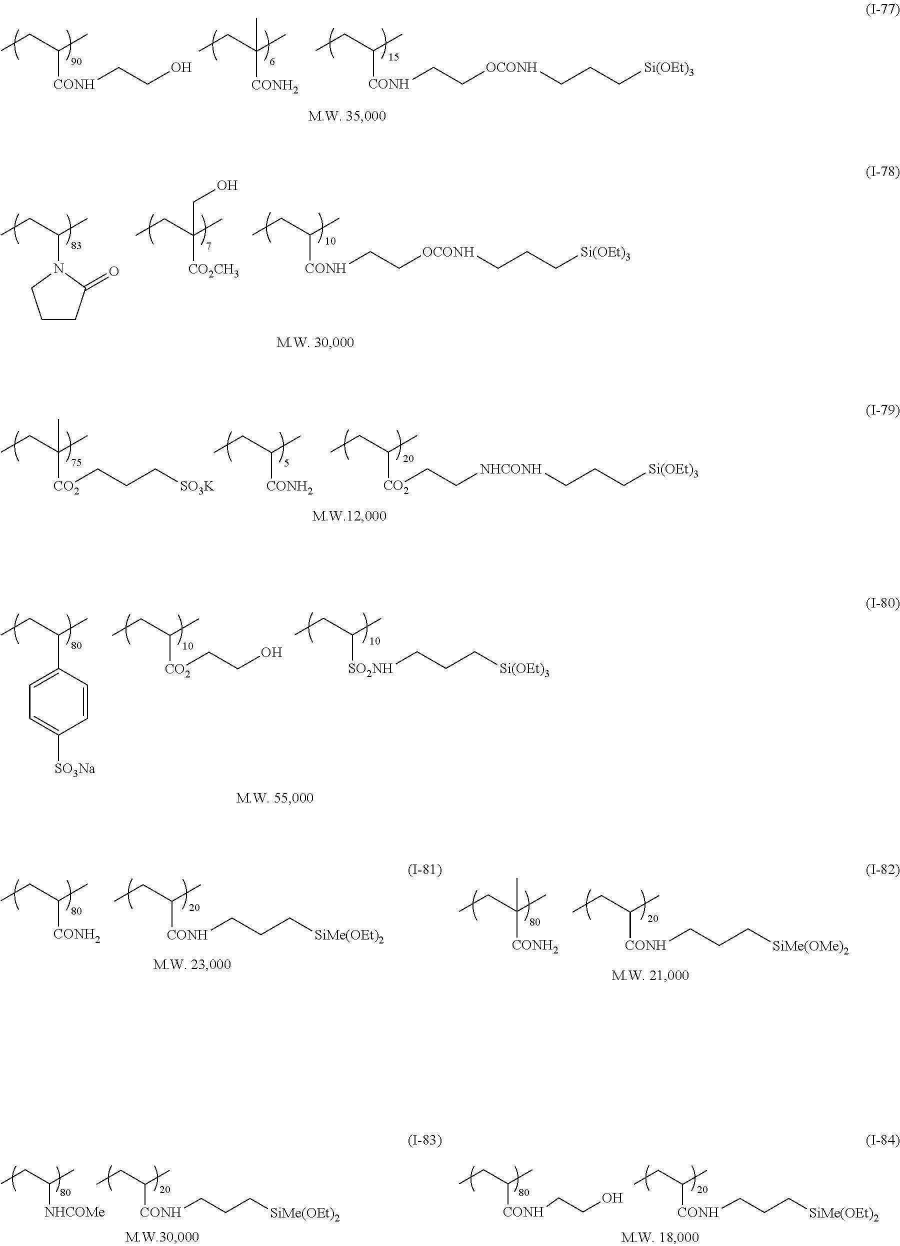

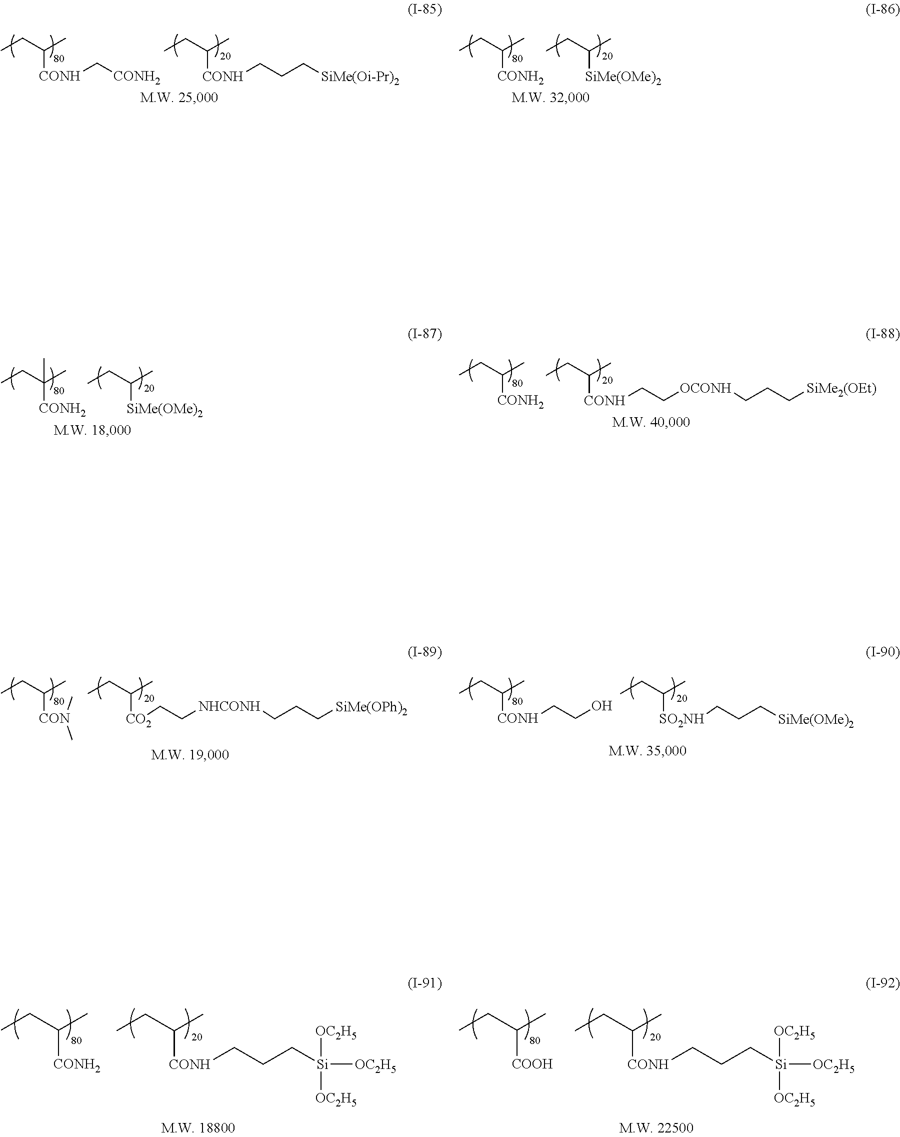

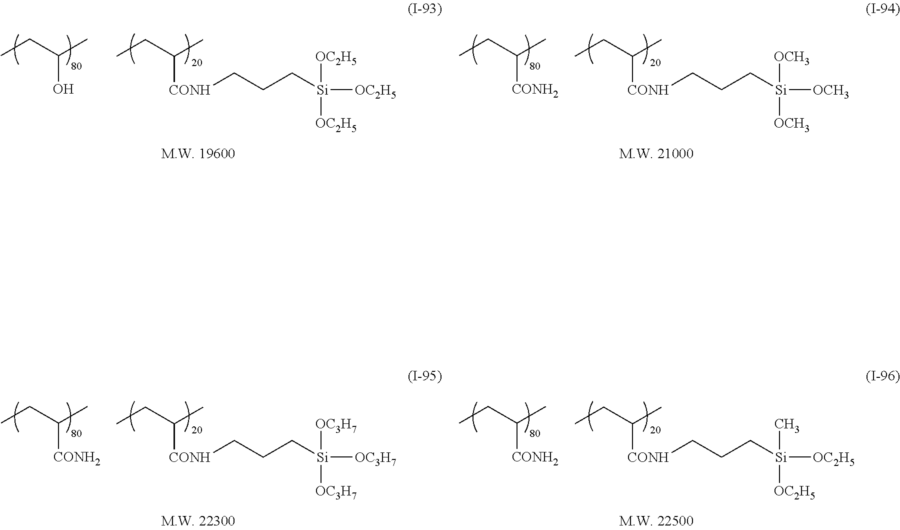

Respective compounds for synthesizing the hydrophilic polymer containing of the structure represented by formula (I-1) and the structure represented by formula (1-2) are commercially available and can also be easily synthesized.

As the radical polymerization method for synthesizing the hydrophilic polymer containing the structure represented by formula (I-1) and the structure represented by formula (I-2), any of conventionally known methods can be used.

Specifically, ordinary radical polymerization methods are described, for example, in Shin Kobunshi Jikkengaku 3 (1996, Kyoritsu Shuppan Co., Ltd.), Kobunshi no Gosei to Hanno 1 (edited by The Society of Polymer Science, Japan, 1992, Kyoritsu Shuppan Co., Ltd.), Shin Jikken Kagaku Koza 19 (1978, Maruzen Co., Ltd.), Kobunshi Kagaku (I) (edited by The Chemical Society of Japan, 1996, Maruzen Co., Ltd.) and Kobunshi Gosei Kagaku, (Busshitsu Kogaku Koza, 1995, Tokyo Denki University Press) and these methods can be applied.

### [Hydrophilic Polymer (II) Containing Structure Represented by Formula (II-1) and Structure Represented by Formula (II-2)]

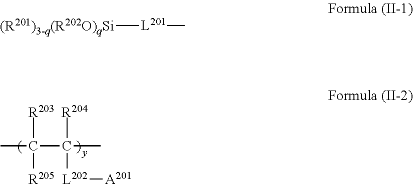

In formulae (II-1) and (II-2) R²⁰¹ to R²⁰⁵ each independently represents a hydrogen atom or a hydrocarbon group. q represents an integer from 1 to 3. L²⁰¹ and L²⁰² each represents a single bond or a polyvalent organic connecting group. A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —(Rₐ)(R_{b})(Rₑ), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{C} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

The hydrophilic polymer (II) containing the structure represented by formula (II-1) and the structure represented by formula (II-2) preferably contains the structural unit represented by formula (II-2) and a partial structure represented by formula (II-1) at a terminal of the polymer chain.

In formulae (II-1) and (II-2), R²⁰¹ to R²⁰⁵ each independently represents a hydrogen atom or a hydrocarbon group. When each of R²⁰¹ to R²⁰⁵ represents a hydrocarbon group, the hydrocarbon group includes an alkyl group, an aryl group and the like and is preferably a straight-chain, branched or cyclic alkyl group having from 1 to 8 carbon atoms. Specific examples thereof are same as those described for R¹⁰¹ to R¹⁰⁸ in formulae (I-1) and (I-2) above.

L²⁰¹ and L²⁰² each independently represents a single bond or a polyvalent organic connecting group. The term “single bond” as used herein means that the main chain of the polymer and A²⁰¹ or Si atom are directly connected without a connecting chain. When each of L²⁰¹ and L²⁰² represents the polyvalent organic connecting group, specific examples and preferred examples thereof include those described for L¹⁰¹ in formula (I-1) above.

A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —COON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c}(R_{g}), —N(Rₑ)(R_{f}), —OPO₃(Rₑ)(R_{f}) or —PO₃(R_{d})(Rₑ). Specific examples and preferred examples of A²⁰¹ include those described for A¹⁰¹ in formula (I-2) above.

q represents an integer from 1 to 3, preferably 2 or 3, and more preferably 3.

L²⁰¹ and L²⁰² each more preferably represents —CH₂CH₂CH₂S—, —CH₂S—, —CONHCH(CH₃)CH₂—, —CONH—, —CO—, —CO₂— or —(CH₂)ₙ₁. L²⁰¹ more preferably contains —CH₂—, and is still more preferably —(CH₂)ₙ₁— (wherein n1 represents an integer from 1 to 5, preferably from 1 to 4, and more preferably 2 or 3).

L²⁰² is preferably a single bond.

The hydrophilic polymer containing of the structure represented by formula (II-1) and the structure represented by formula (II-2) can be synthesized, for example, by radical polymerization of a hydrophilic monomer (for example, acrylamide, acrylic acid or potassium salt of 3-sulfopropyl methacrylate) in the presence of a chain transfer agent (described in Radical Jugo Handbook (NTS Inc., Mikiharu Kamachi, Tsuyosi Endo) or an Iniferter (described in Macromolecules, 1986, 19, p 287-(Otsu)). Examples of the chain transfer agent include 3-mercaptopropionic acid, 2-aminoethanethiol hydrochloride, 3-mercaptopropanol, 2-hydroxyethyldisulfide and 3-mercaptopropyltrimethoxysilane. Also, a hydrophilic monomer (for example, acrylamide) may be subjected to radical polymerization not using a chain transfer agent but using a radical polymerization initiator having a reactive group.

The hydrophilic polymer containing of the structure represented by formula (II-1) and the structure represented by formula (II-2) can be synthesized by radical polymerization using a radical polymerizable monomer represented by formula (i) shown below and a silane coupling agent having a chain transfer property in radical polymerization represented by formula (ii) shown below. Since the silane coupling agent (ii) has the chain transfer property, a polymer having the silane coupling group introduced into a terminal of the polymer main chain can be synthesized in the radical polymerization.

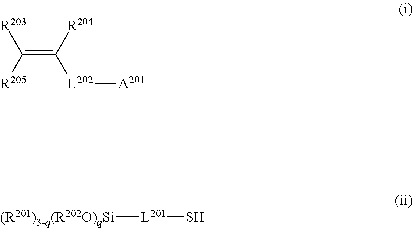

In formulae (i) and (ii), R²⁰¹ to R²⁰⁵, L²⁰¹, L²⁰², A²⁰¹ and q are same as those defined in formula (II-1) above. These compounds are commercially available and also can be easily synthesized. The radical polymerizable monomer represented by formula (i) has a hydrophilic group A²⁰¹ and the monomer constitutes one structural unit in the hydrophilic polymer.

In the hydrophilic polymer (II) containing of the structure represented by formula (II-1) and the structure represented by formula (II-2), the molar number of the structural unit of formula (II-2) is preferably in a range from 1,000 to 10 times, more preferably in a range from 500 to 20 times, most preferably in a range from 200 to 30 times, higher than the molar number of the structural unit of formula (II-1) having a hydrolyzable silyl group. When the molar number of the structural unit of formula (II-2) to the molar ration of the structural unit of formula (II-1) is 30 times or more, the hydrophilicity is not insufficient, whereas when it is 200 times or less, an amount of the hydrolyzable silyl group is enough to achieve sufficient curing thereby ensuring the film strength.

A weight average molecular weight of the hydrophilic polymer (II) containing the structure represented by formula (II-1) and the structure represented by formula (II-2) is preferably from 1,000 to 1,000,000, more preferably from 1,000 to 500,000, and most preferably from 1,000 to 200,000.

Specific examples of the hydrophilic polymer (II) preferably used in the invention are set forth below, but the invention should not be construed as being limited thereto. In the specific examples, * denote a connecting position to the polymer.

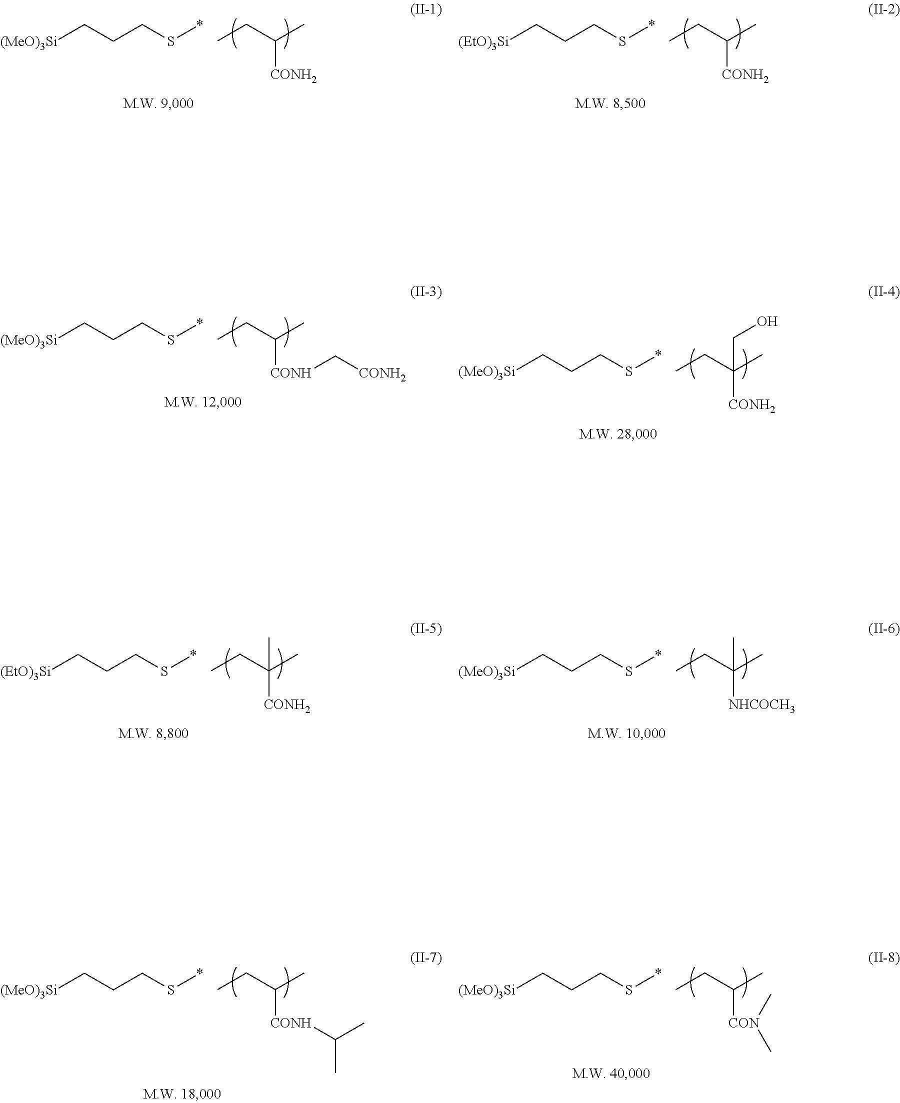

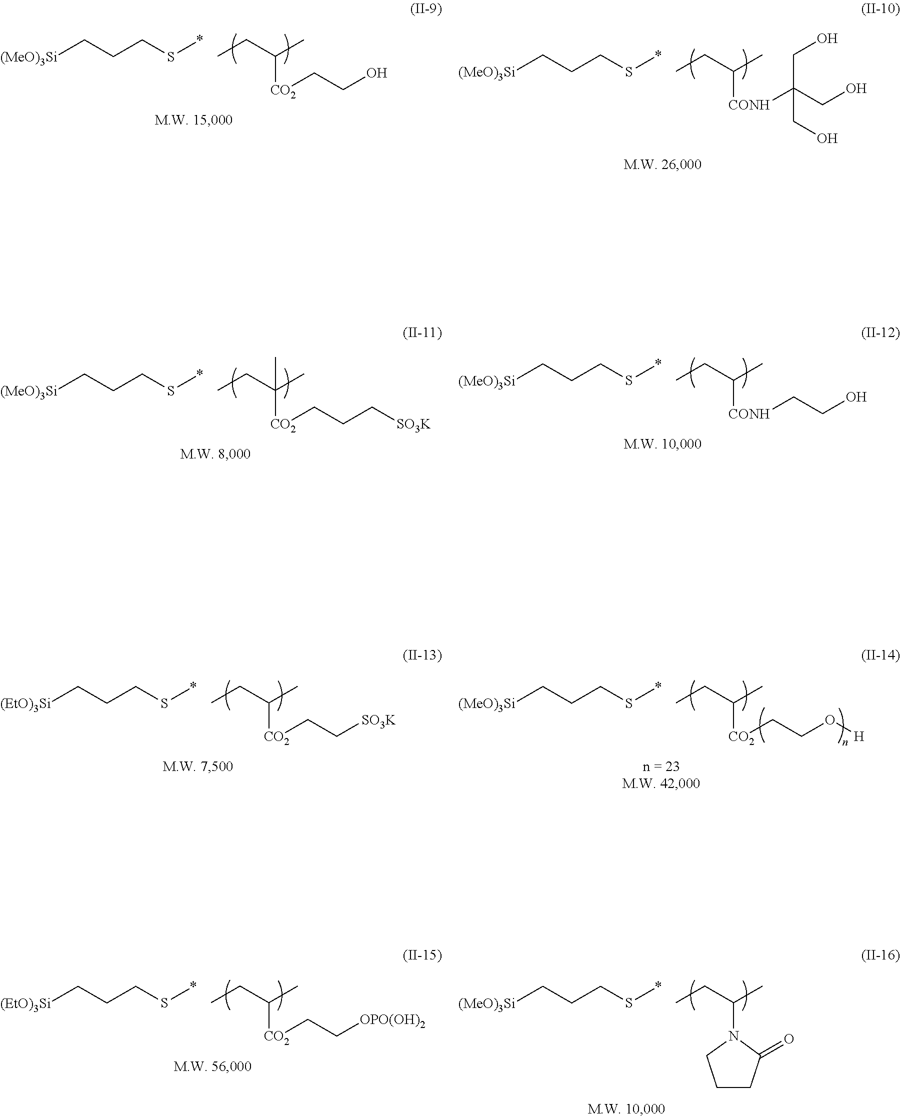

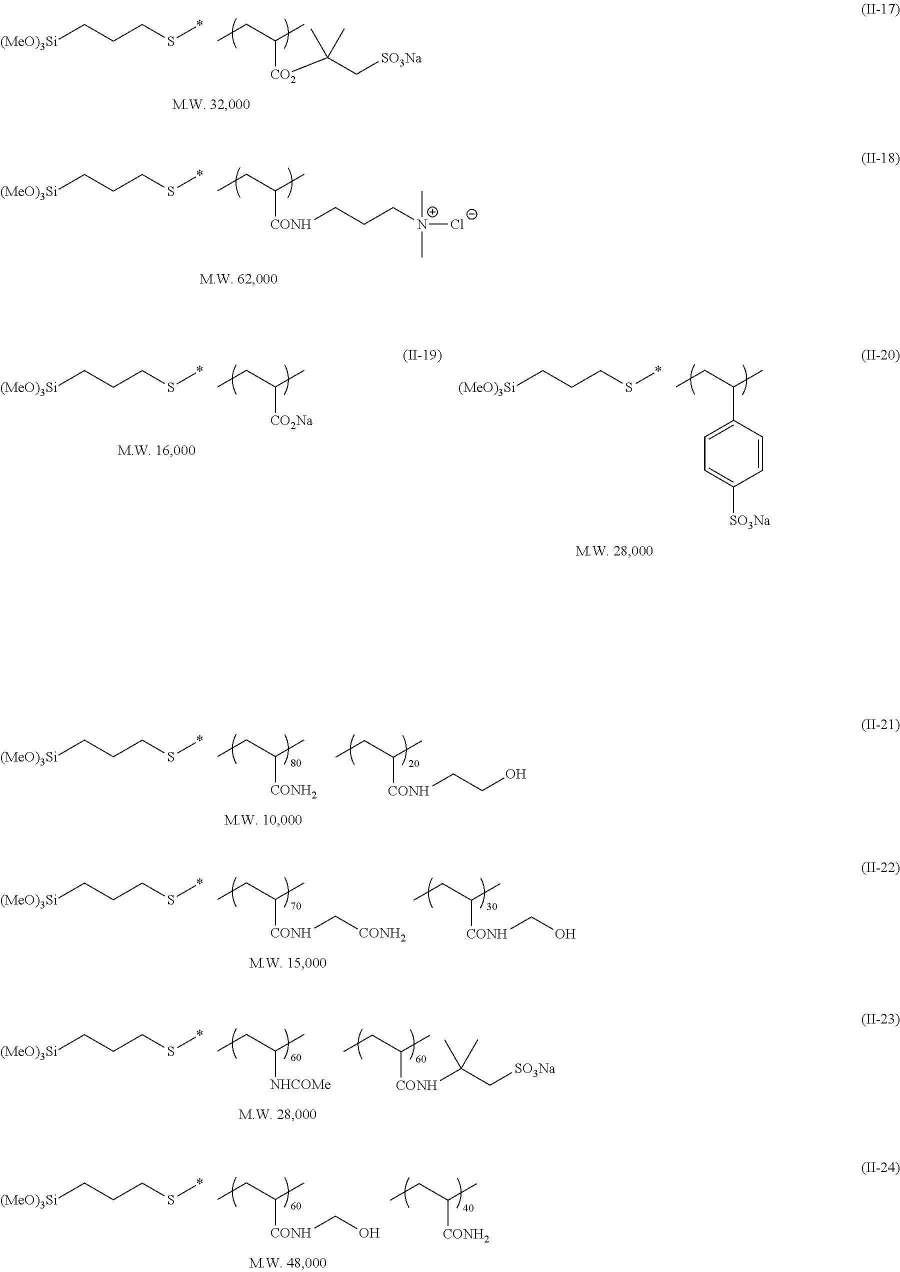

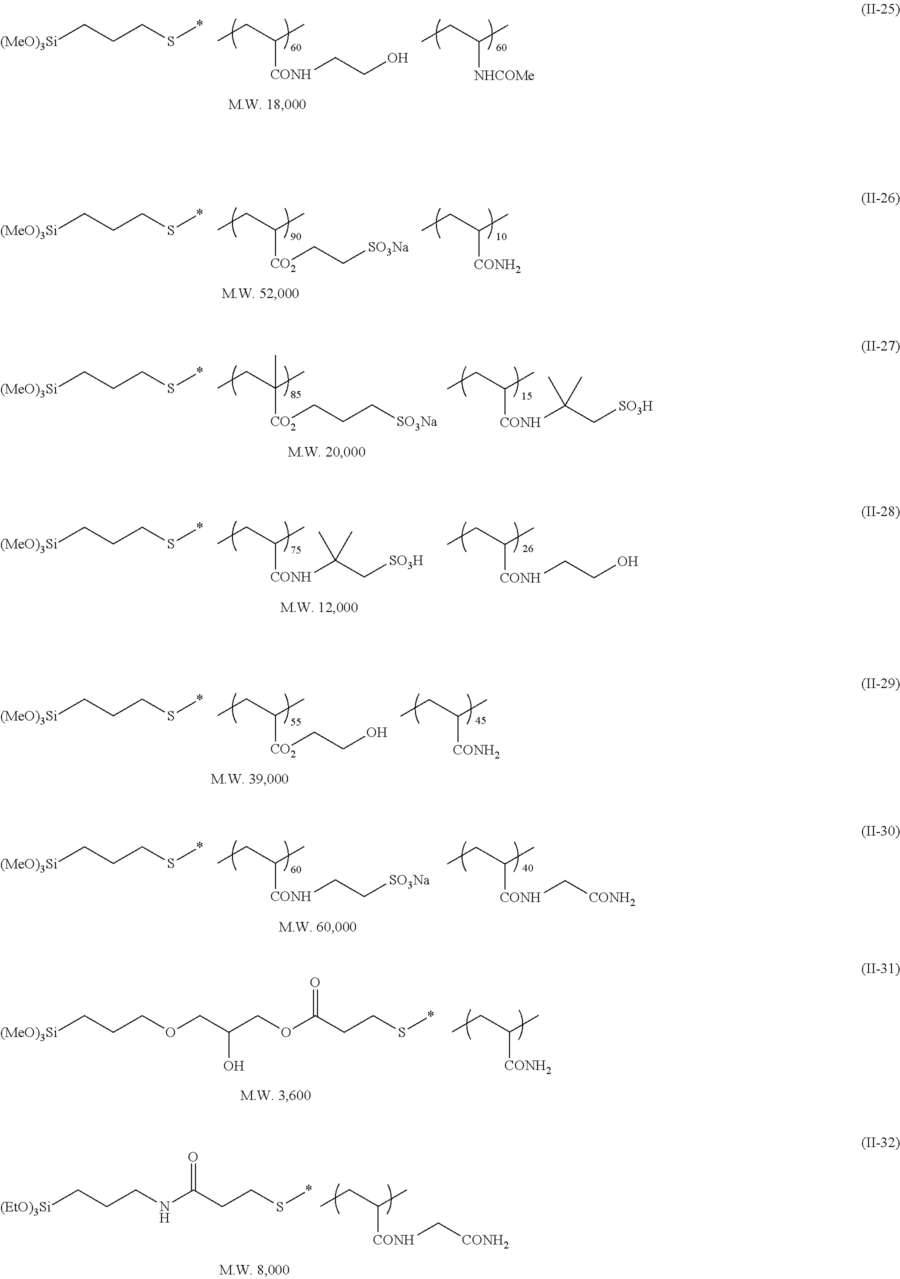

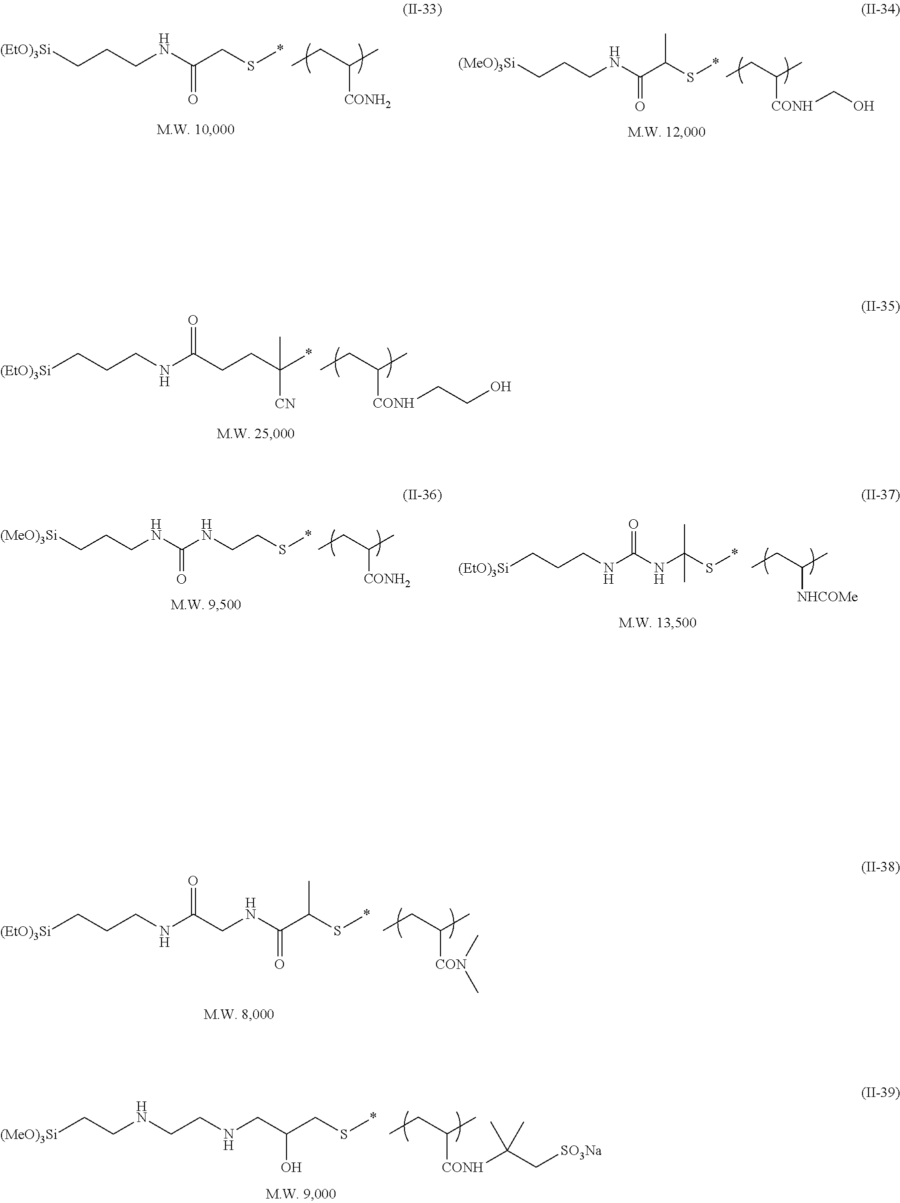

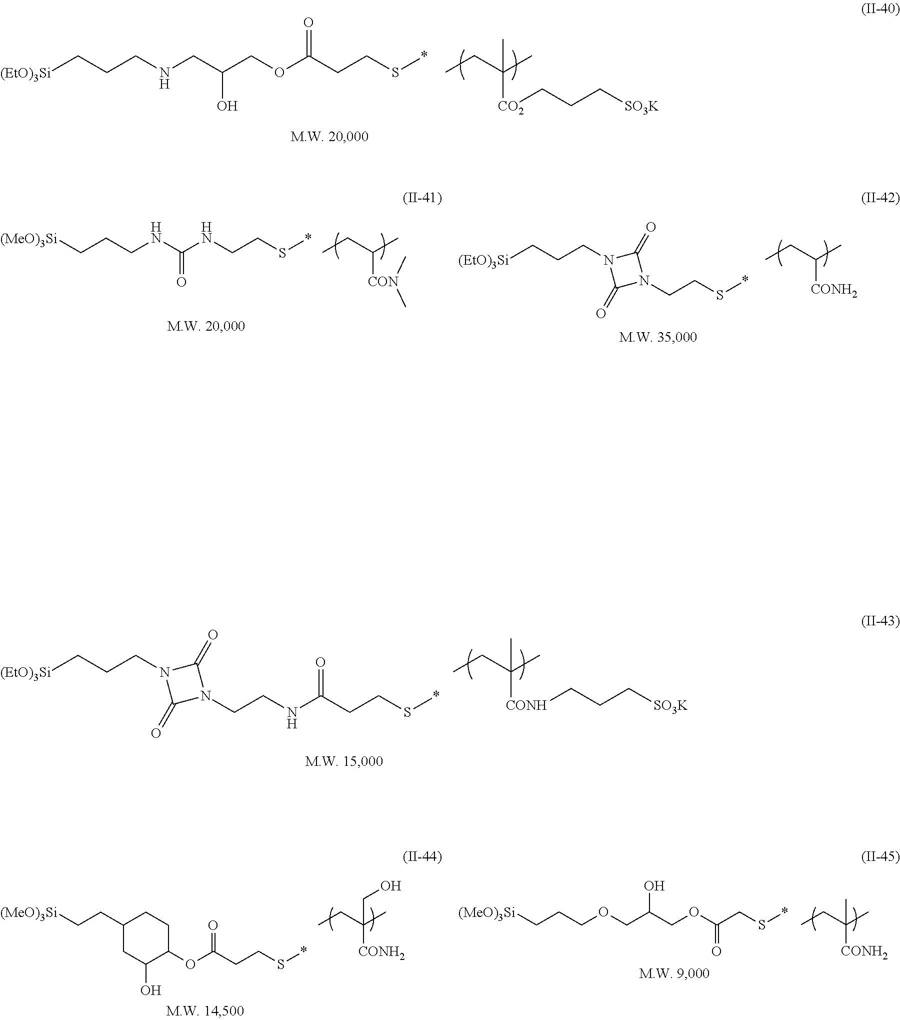

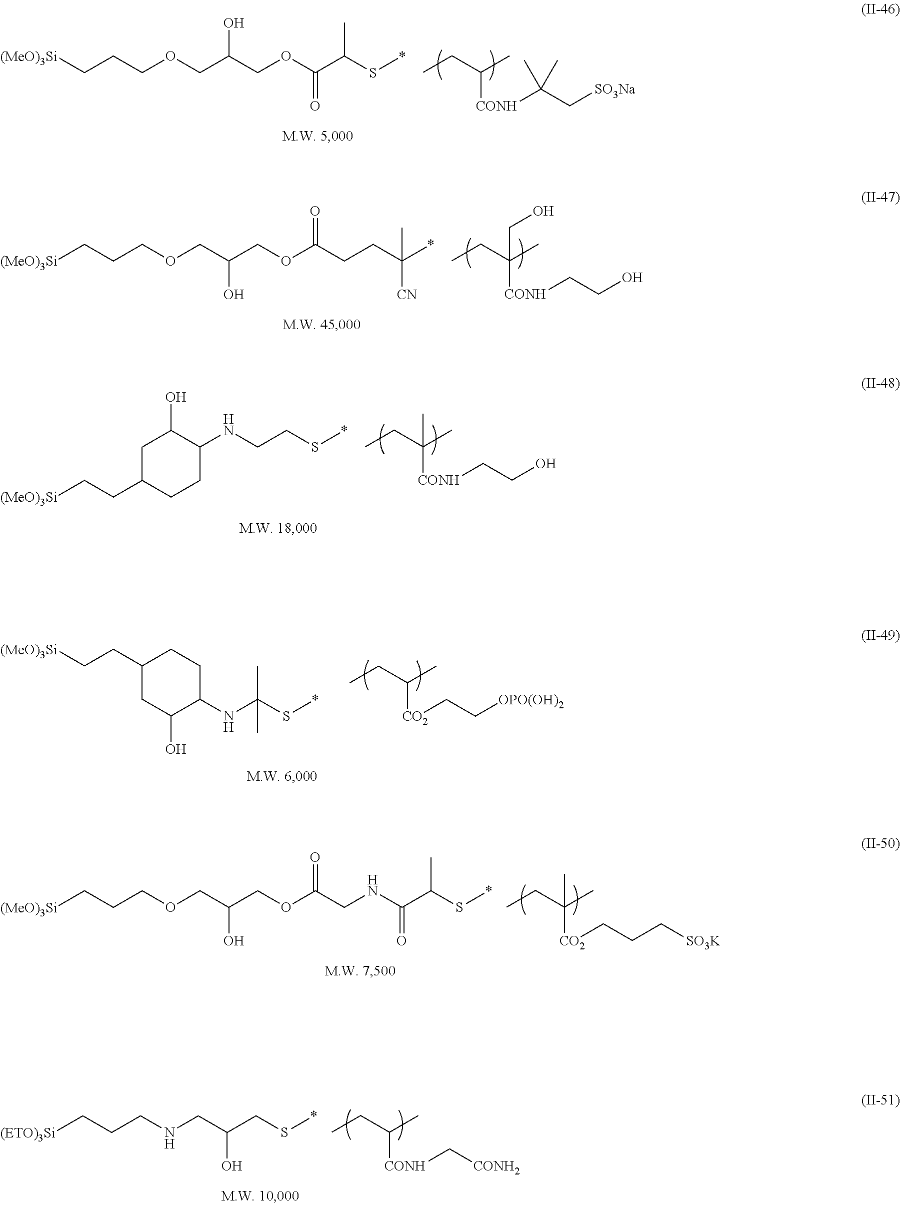

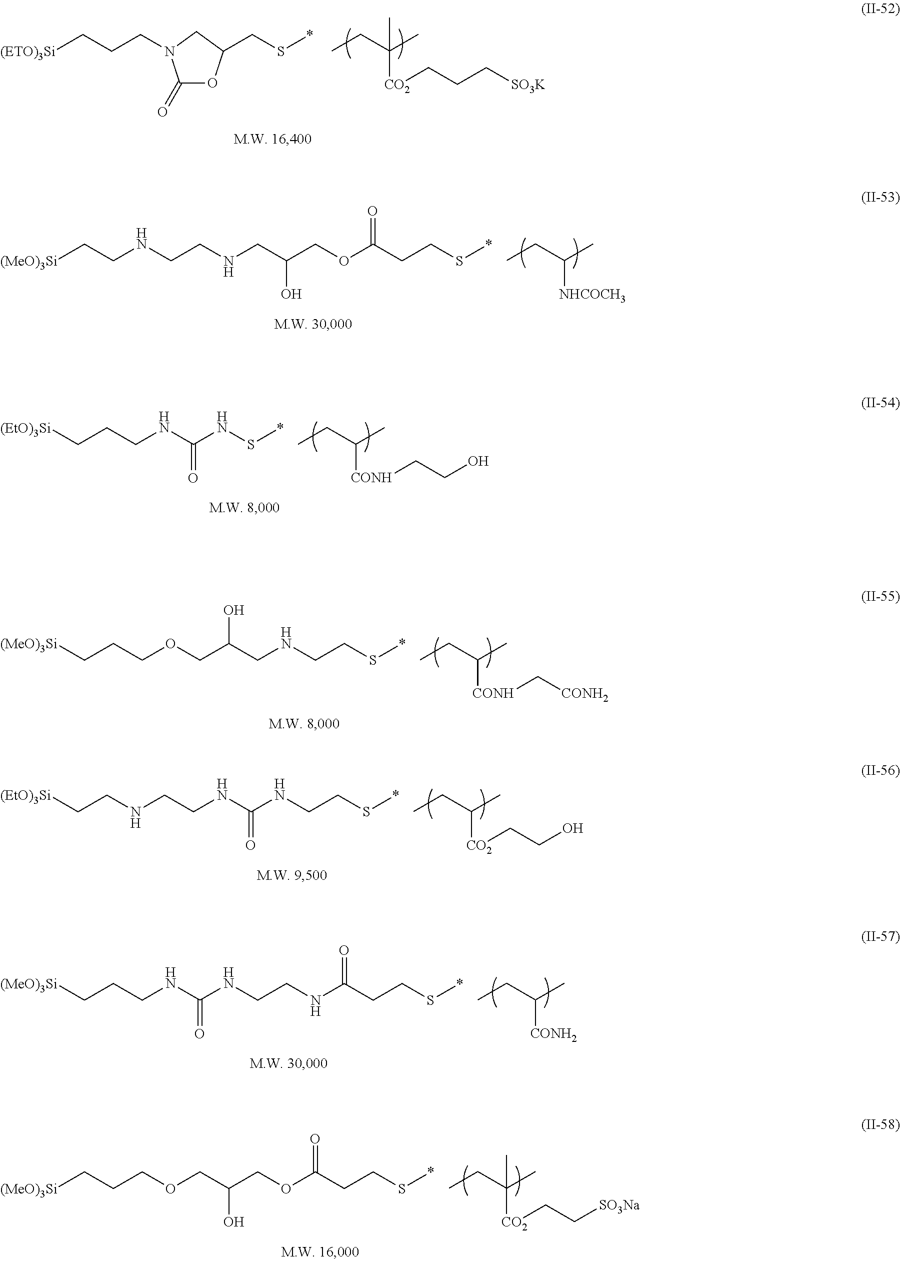

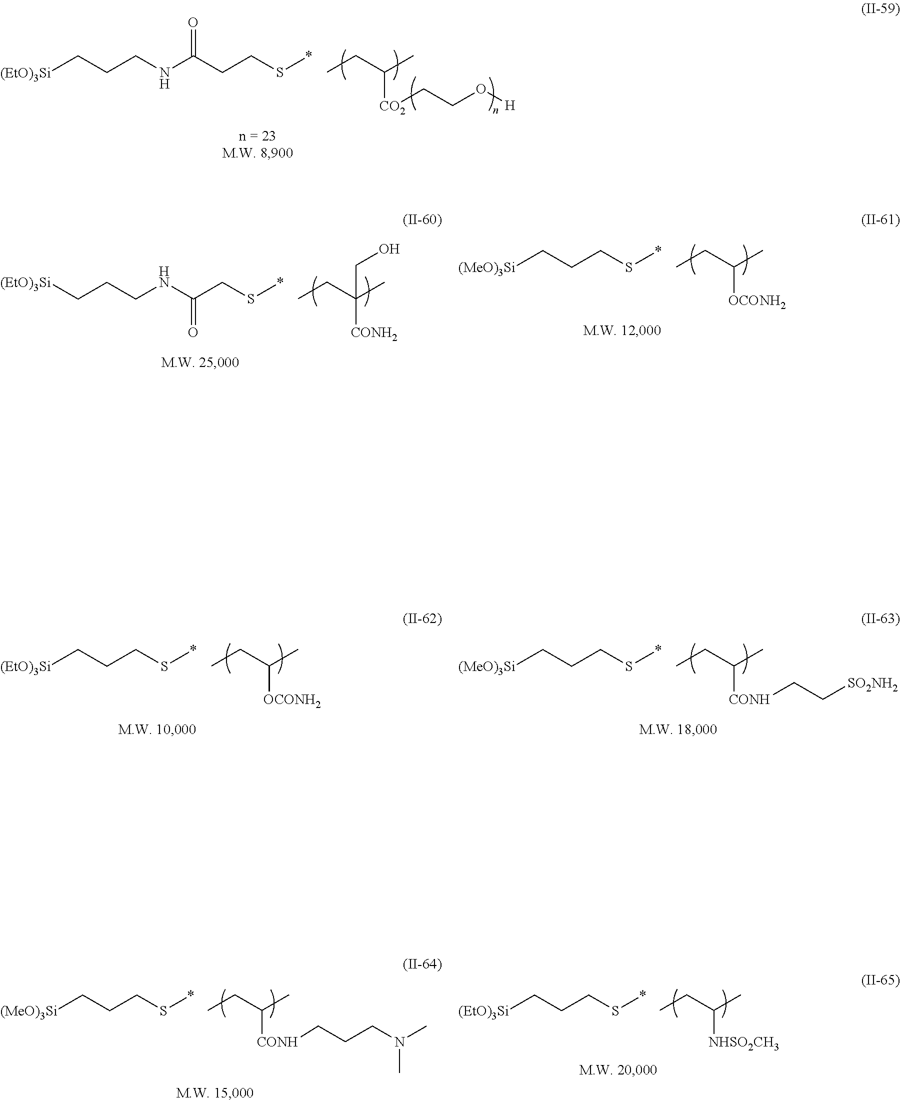

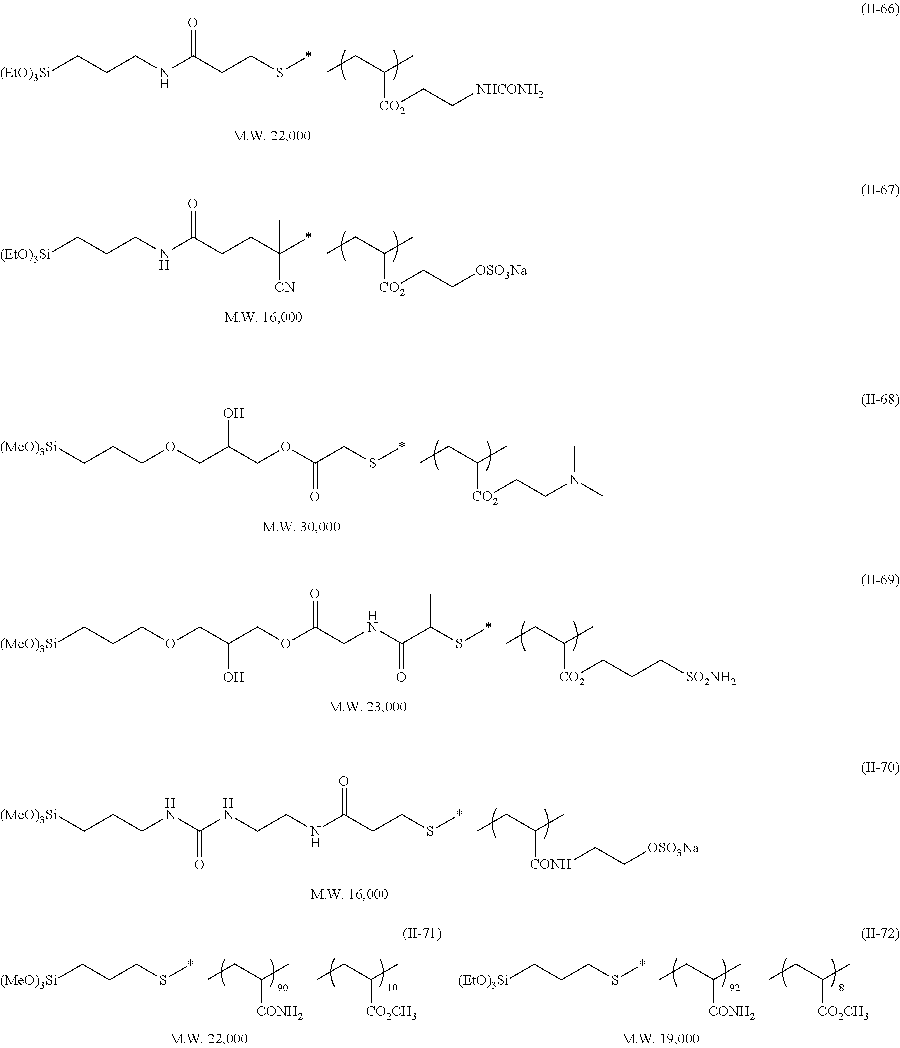

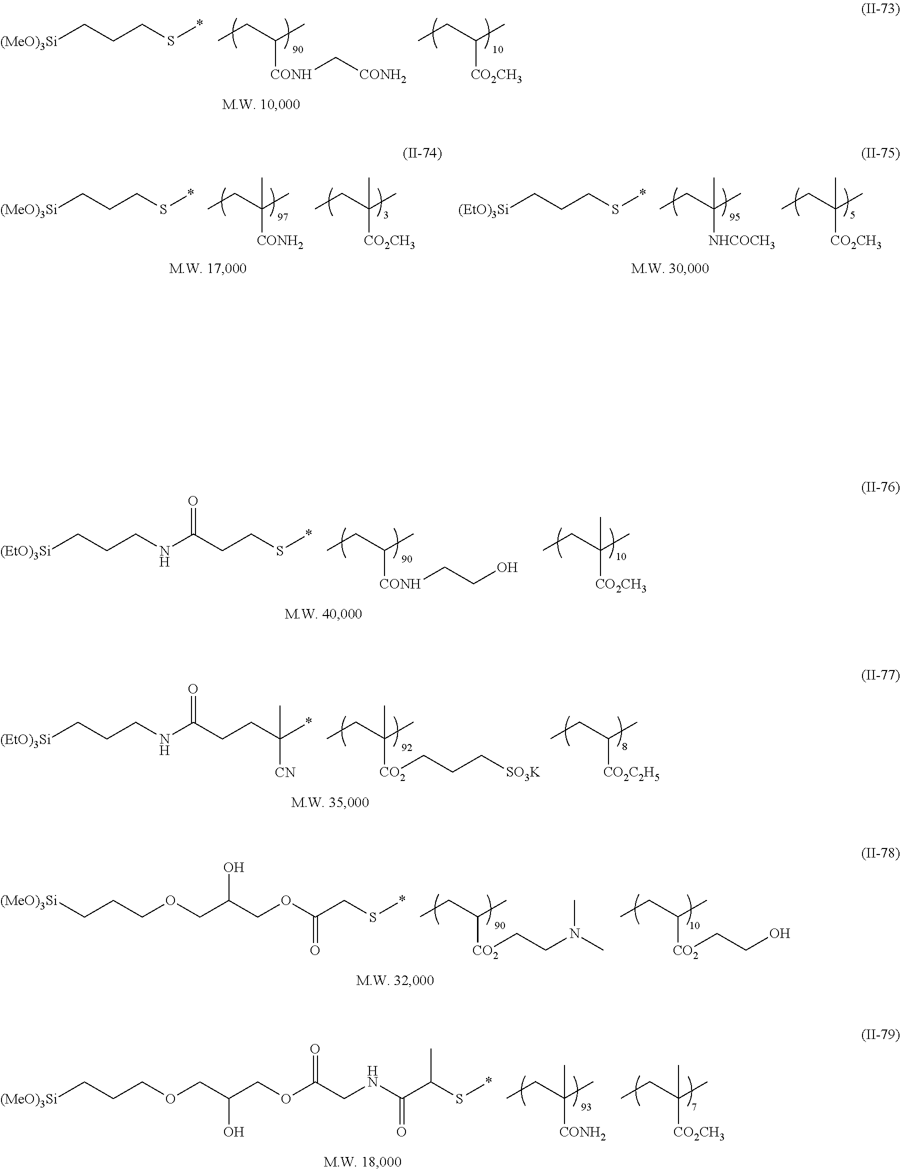

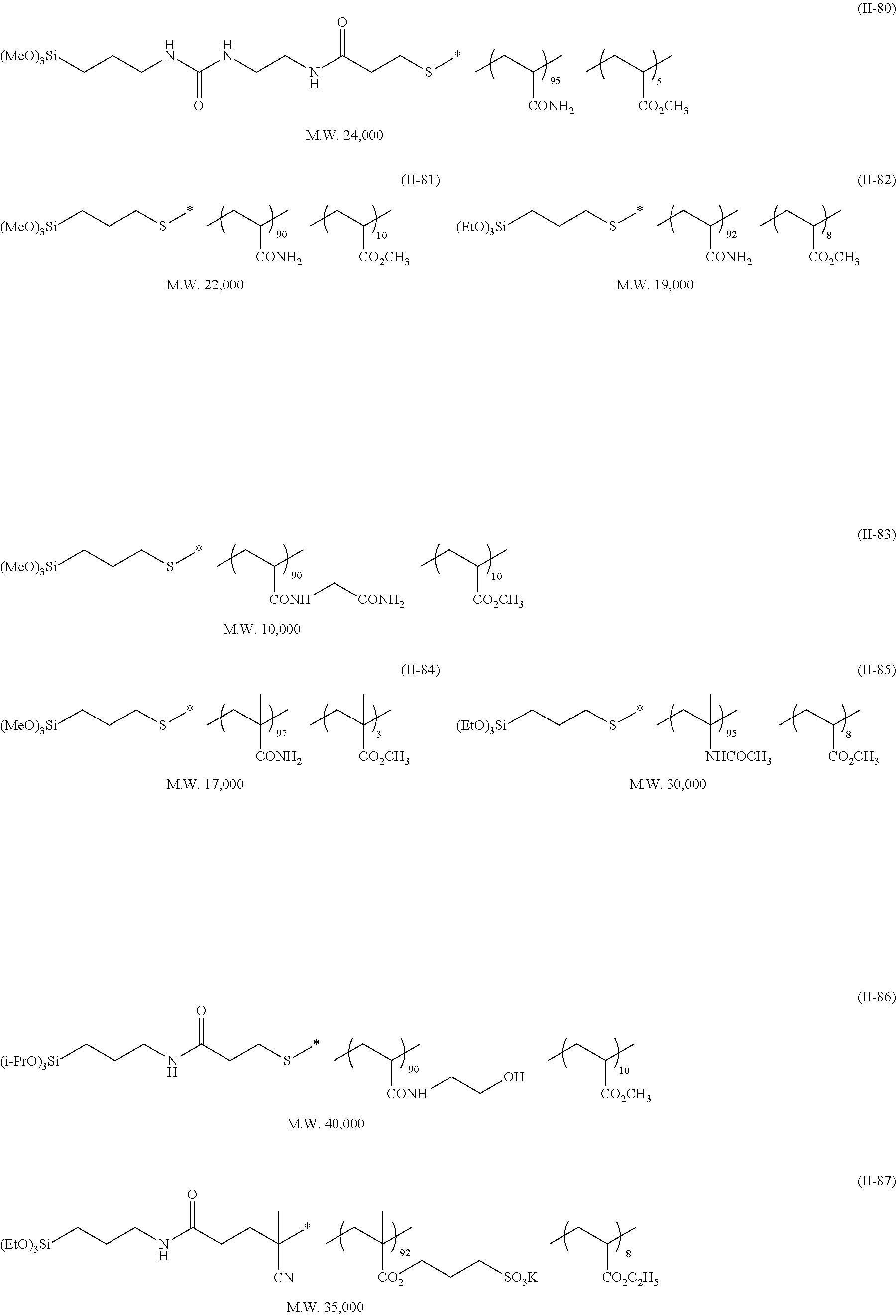

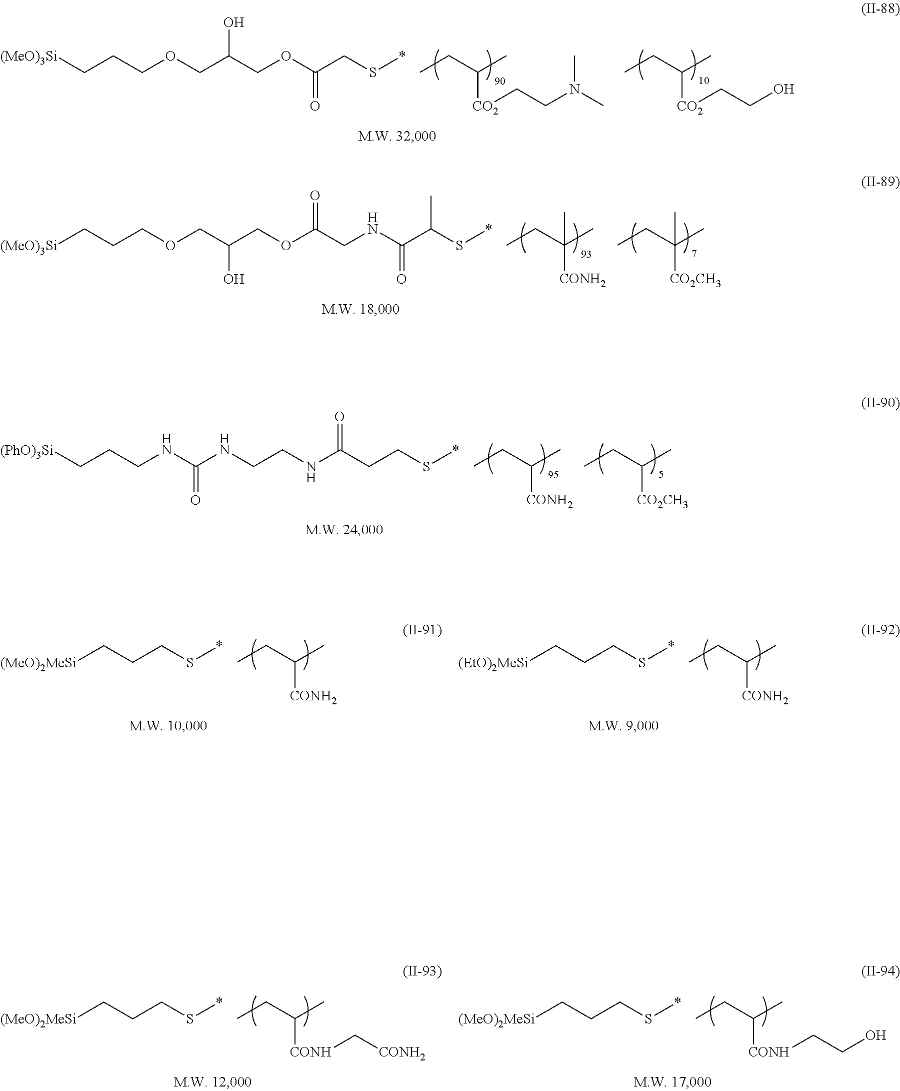

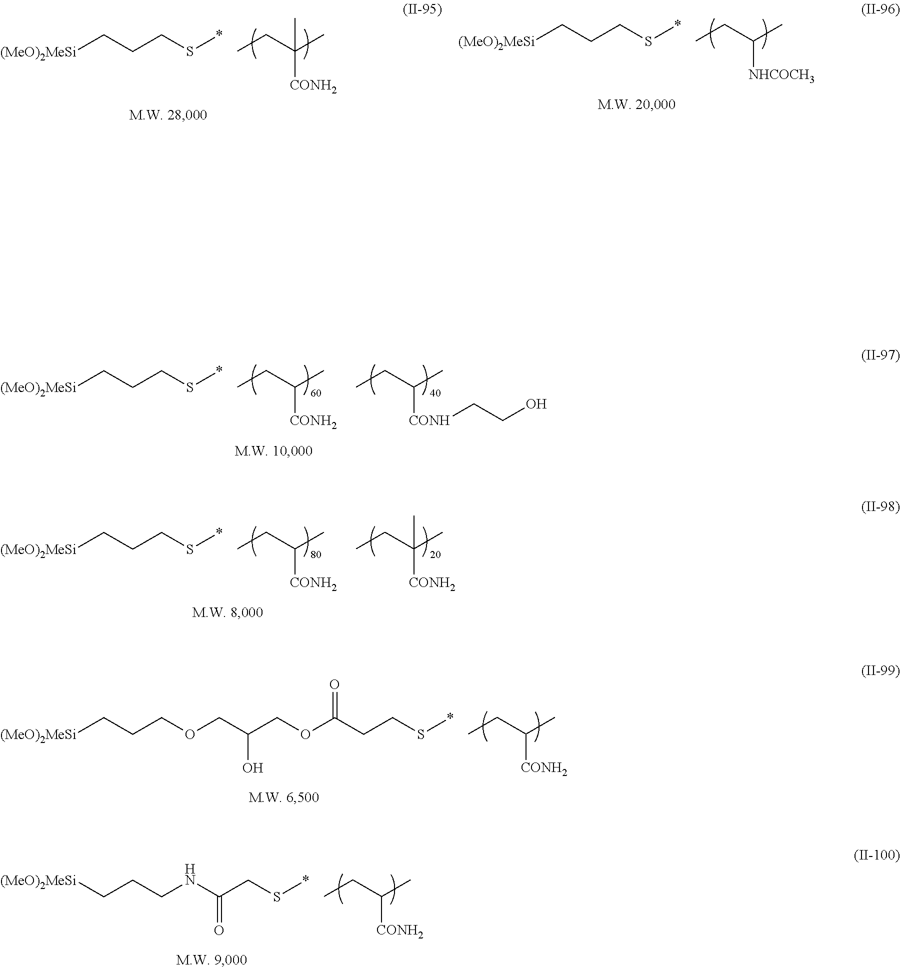

| | | Weight Average |
|---|---|---|
| | | Molecular Weight |
| (II-101) | 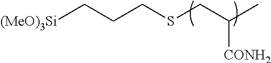 | 5,000 |
| (II-102) | 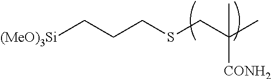 | 6,000 |
| (II-103) | 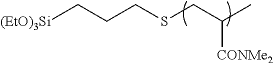 | 10,000 |
| (II-104) | 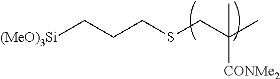 | 8,000 |
| (II-105) | 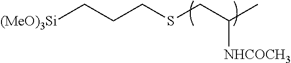 | 15,000 |
| (II-106) | 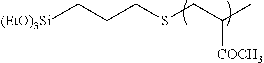 | 10,000 |
| (II-107) | 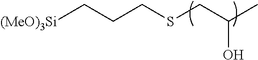 | 30,000 |
| (II-108) | 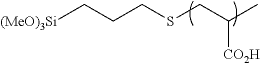 | 5,000 |
| (II-109) | 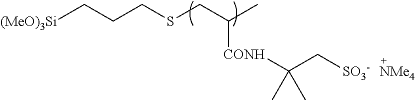 | 10,000 |
| (II-110) | 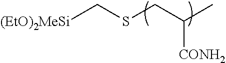 | 20,000 |
| (II-111) | 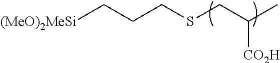 | 7,000 |
| (II-112) | 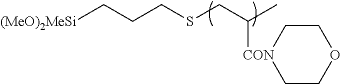 | 15,000 |
| (II-113) | 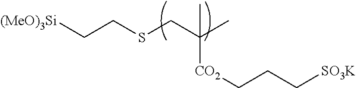 | 5,000 |

### [Hydrophilic Polymer (III) Containing Structure Represented by Formula (III-1) and Structure Represented by Formula (III-2)]

The hydrophilic polymer (III) contains the structure represented by formula (III-1) shown below and the structure represented by formula (III-2) shown below. The hydrophilic polymer (III) is preferably a hydrophilic graft polymer wherein a side chain having a hydrophilic group is introduced into a backbone polymer having a reactive group.

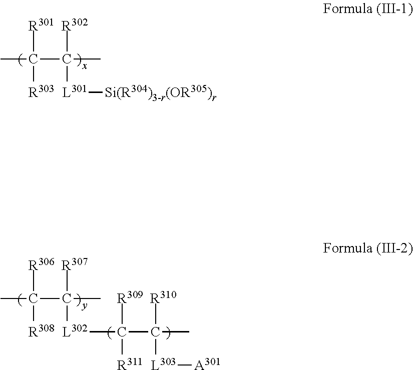

In formulae (III-1) and (III-2), R³⁰¹ to R³¹¹ each independently represents a hydrogen atom or a hydrocarbon group. r represents an integer from 1 to 3. L³⁰¹ to L³⁰³ each represents a single bond or a polyvalent organic connecting group. x and y each represents a composition ratio and x represents a number satisfying 0<x<100 and y represents a number satisfying 0<y<100. A³⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, OSO₃Rₑ, —SO₂R_{d}, —NHSO₂R_{d}, —SO₂N(Rₐ(R_{b}), —N(Rₐ)(R_{b})(Rₑ), —N(Rₐ)(R_{b})(R_{c})(R_{g}), —PO₃(Rₑ)(R_{f}) or —PO₃(R_{d})(Rₑ), wherein Rₐ, R_{b} and R_{C} each independently represents a hydrogen atom or a straight-chain, branched or cyclic alkyl group, R_{d} represents a straight-chain, branched or cyclic alkyl group, Rₑ and R_{f} each independently represents a hydrogen atom, a straight-chain, branched or cyclic alkyl group, an alkali metal, an alkaline earth metal or an onium, and R_{g} represents a halide ion, an inorganic anion or an organic anion.

In formulae (III-1) and (III-2) shown above, R³⁰¹ to R³¹¹ each independently represents a hydrogen atom or a hydrocarbon group. When each of R³⁰¹ to R³¹¹ represents a hydrocarbon group, the hydrocarbon group includes an alkyl group, an aryl group and the like and is preferably a straight-chain, branched or cyclic alkyl group having from 1 to 8 carbon atoms. Specific examples thereof include those described for R¹⁰¹ to R¹⁰⁸ in formulae (I-1) and (I-2) above and the preferred examples thereof are also same as those described above.

L³⁰¹, L³⁰² and L³⁰³ each independently represents a single bond or a polyvalent organic connecting group. The term “single bond” as used herein means that the main chain of the polymer and A³⁰¹, the side chain or Si atom are directly connected without a connecting chain. When each of L³⁰¹, L³⁰² and L³⁰³ represents the polyvalent organic connecting group, specific examples and preferred examples thereof include those described for L¹⁰¹ in formula (I-1) above.

A³⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N (Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ). Specific examples and preferred examples of A²⁰¹ include those described for A¹⁰¹ in formula (I-2) above.

r represents an integer from 1 to 3, preferably 2 or 3, and more preferably 3.

The hydrophilic graft polymer can be prepared by using a method ordinarily known as a synthesis method of graft polymer. Specifically, ordinary synthesis methods of graft polymer are described in Fumio Ide, Graft Jugo to Sono Oyo, Kobunshi Kankokai (1977) and Shin Kobunshi Jikkengaku 2, Kobunshi no Gosei•Hanna (edited by The Society of Polymer Science, Japan, 1995, Kyoritsu Shuppan Co., Ltd.) and these methods can be applied.

The synthesis methods of graft polymer are basically classified into 3 groups, (1) method of polymerizing a branch monomer from a backbone polymer, (2) method of connecting a branch polymer to a backbone polymer, and (3) a method of copolymerizing a branch monomer to a backbone polymer (macromer method). Although the hydrophilic graft polymer for use in the invention can be prepared by employing any of these three methods, (3) macromer method is particularly excellent from the standpoint of production aptitude and control of film structure.

The synthesis of graft polymer using a macromonomer is described in Shin Kobunshi Jikkengaku 2, Kobunshi no Gosei•Hanno (edited by The Society of Polymer Science, Japan, 1995, Kyoritsu Shuppan Co., Ltd.) above. It is also described in detail in Yuya Yamashita, Macromonomer no Kagaku to Kogyo, 1989, Industrial Publishing & Consulting, Inc. The graft polymer for use in the invention can be synthesized by copolymerization of a hydrophilic macromonomer (corresponding to a precursor of a hydrophilic polymer side chain) synthesized according to the method described above with a monomer having a reactive group.

Particularly useful hydrophilic macromonomer includes a macromonomer derived from a monomer having a carboxyl group, for example, acrylic acid or methacrylic acid, a sulfonic acid type macromonomer derived from a monomer, for example, 2-acrylamido-2-methylpropanesulfonic acid, vinylstyrenesulfonic acid or their salts, an amide type macromonomer derived from acrylamide, methacrylamide or the like, an amide type macromonomer derived from an N-vinylcarboxylic acid amide monomer, for example, N-vinylacetamide or N-vinylformamide, a macromonomer derived from a monomer containing a hydroxyl group, for example, hydroxyethyl methacrylate, hydroxyethyl acrylate or glycerol monomethacrylate, and a macromonomer derived from a monomer containing an alkoxy group or an ethylene oxide group, for example, methoxyethyl acrylate, methoxypolyethylene glycol acrylate or polyethylene glycol acrylate. Further, a monomer having a polyethylene glycol chain or a polypropylene glycol chain can also usefully used as the macromonomer according to the invention. In the macromonomers, a weight average molecular weight (hereinafter, simply referred to as a molecular weight) of useful polymer is in a range from 400 to 100,000, preferably in a range from 1,000 to 50,000, and particularly preferably in a range from 1,500 to 20,000. It is preferred that when the molecular weigh is 400 or more, the effective hydrophilicity is achieved, whereas when it is 100,000 or less, polymerizability with a copolymerization monomer forming a main chain tens to increase.

In the hydrophilic polymer (III) containing the structure represented by formula (III-1) and the structure represented by formula (III-2), x is preferably a number satisfying 1<x<90, and more preferably a number satisfying 1<x<50. y is preferably a number satisfying 10<y<99, and more preferably a number satisfying 50<y<99.

The copolymerization ratio of the hydrophilic polymer (III) can be appropriately set so that the amount of the structure represented by formula (III-2) having a hydrophilic group is in the range described above. A rate of a molar ratio (y) of the structural unit represented by formula (III-2) to a molar ratio (x) of the structural unit represented by formula (III-1) having a hydrolyzable silyl group is preferably in a range of y/x=30/70 to 99/1, more preferably in a range of y/x=40/60 to 98/2, and most preferably in a range of y/x=50/50 to 97/3. When y/x is 30/70 or more, the hydrophilicity is not insufficient, whereas when y/x is 99/1 or less, an amount of the hydrolyzable silyl group is enough to achieve sufficient curing thereby ensuring the film strength.

A weight average molecular weight of the hydrophilic polymer (III) is preferably 1,000,000 or less, more preferably from 1,000 to 1,000,000, and still more preferably from 20,000 to 100,000. The weight average molecular weight of 1,000,000 or less is preferred because the solubility of the polymer in a solvent do not degrade at the time of preparing a coating solution for forming a hydrophilic layer and viscosity of the coating solution decreases so that a uniform layer is readily formed and a problem does not occur in the handling property.

Specific examples of the hydrophilic polymer (III) containing the structure represented by formula (III-1) and the structure represented by formula (III-2) are set forth below together with the weight average molecular weight (M.W.) thereof, but the invention should not be construed as being limited thereto. The polymers specifically set forth below indicate random copolymers or block copolymers containing the respective structural units in the molar ratios as described.

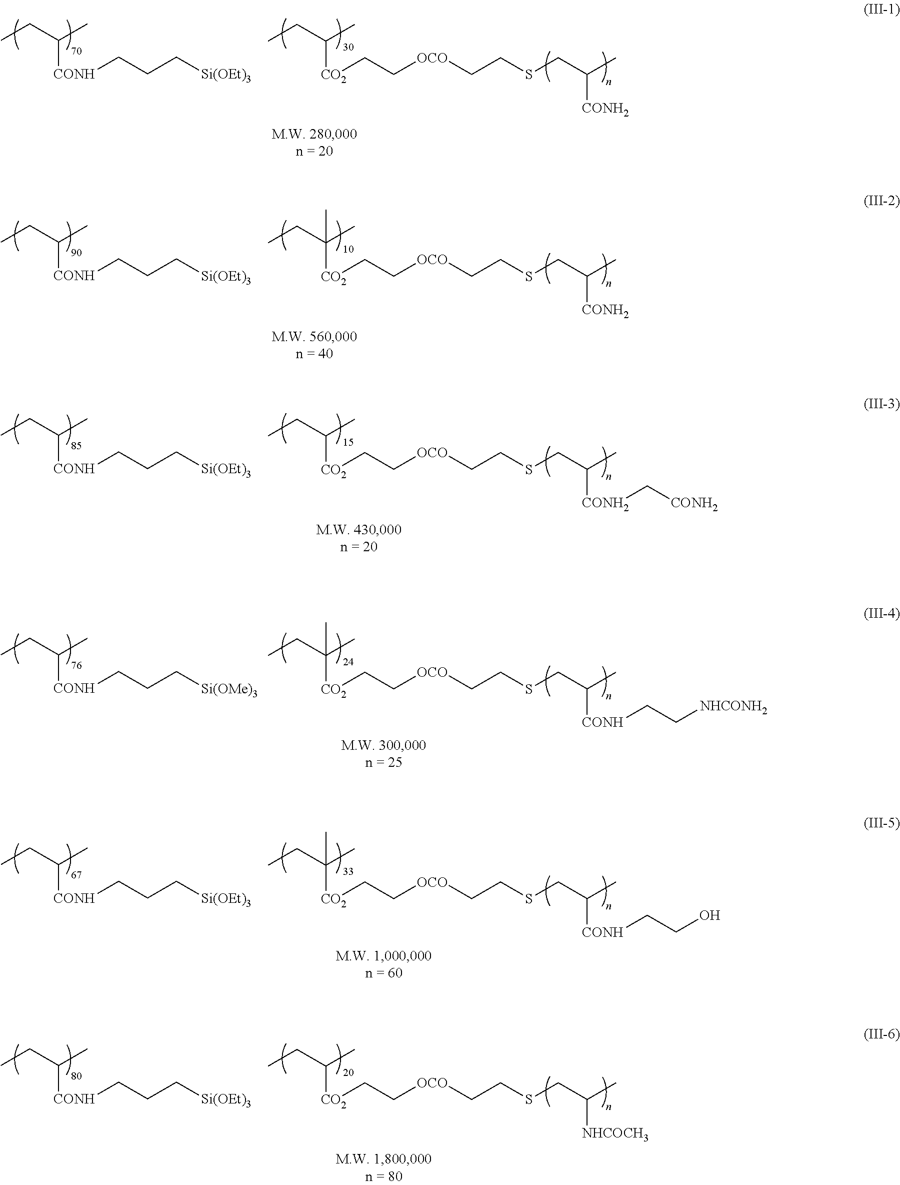

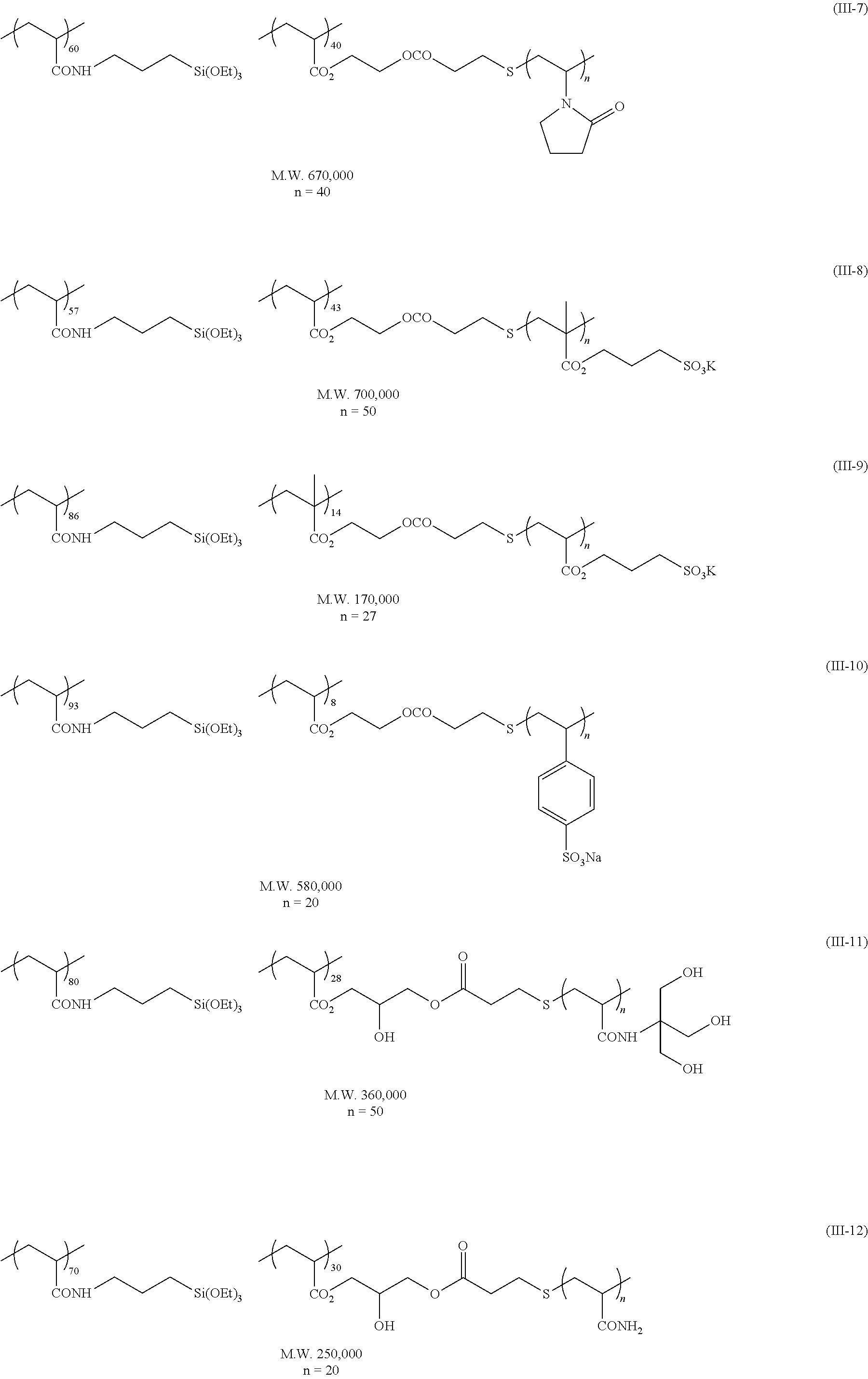

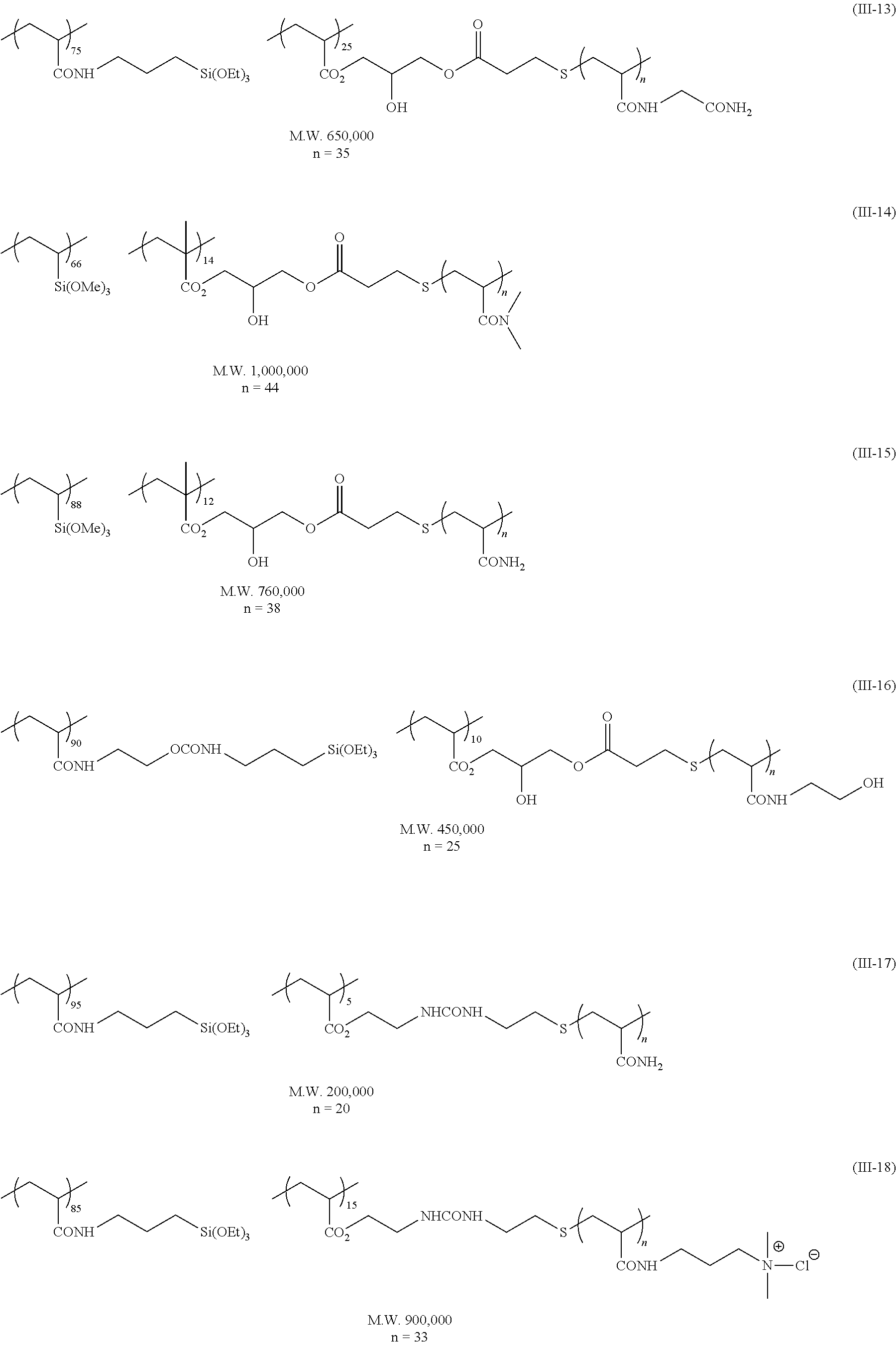

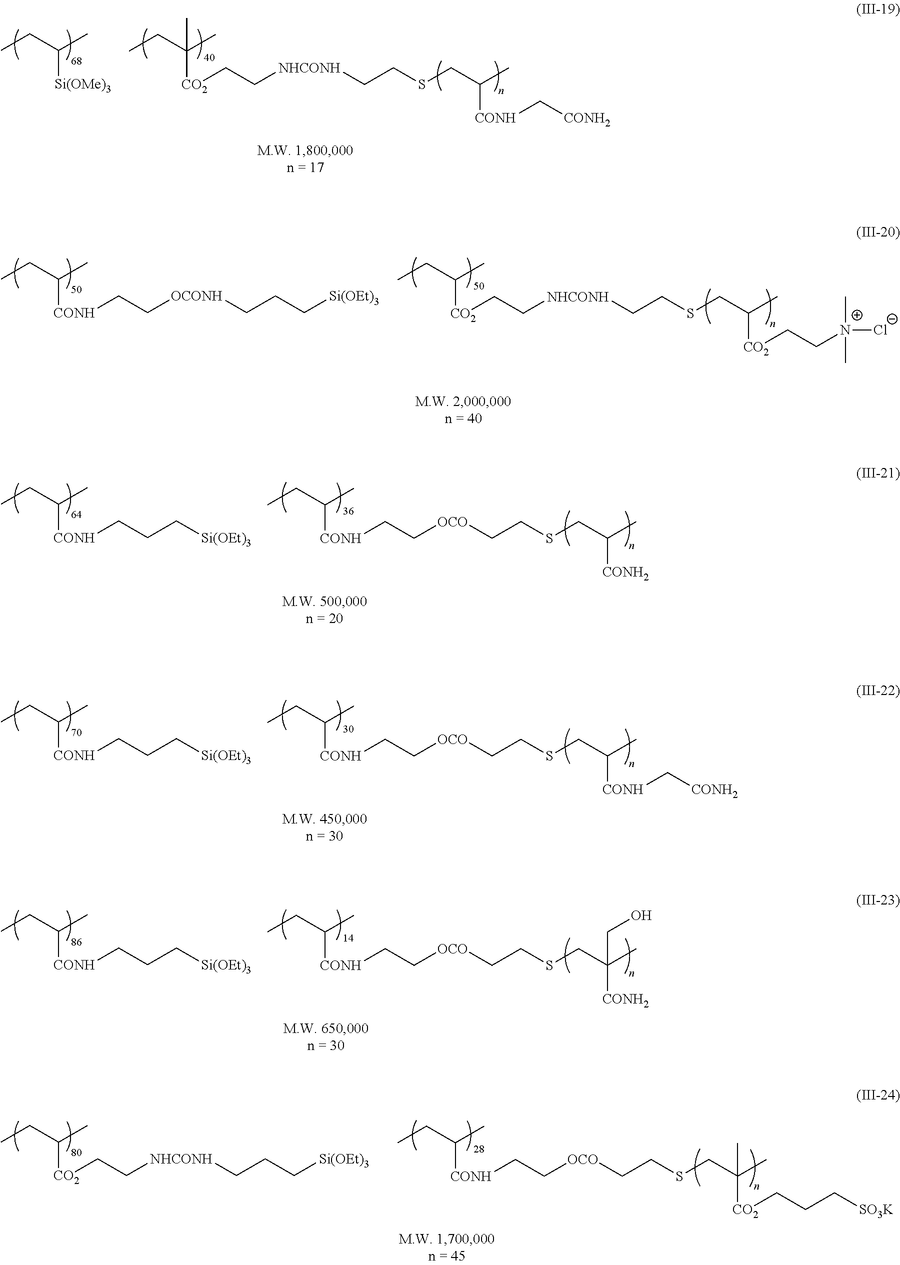

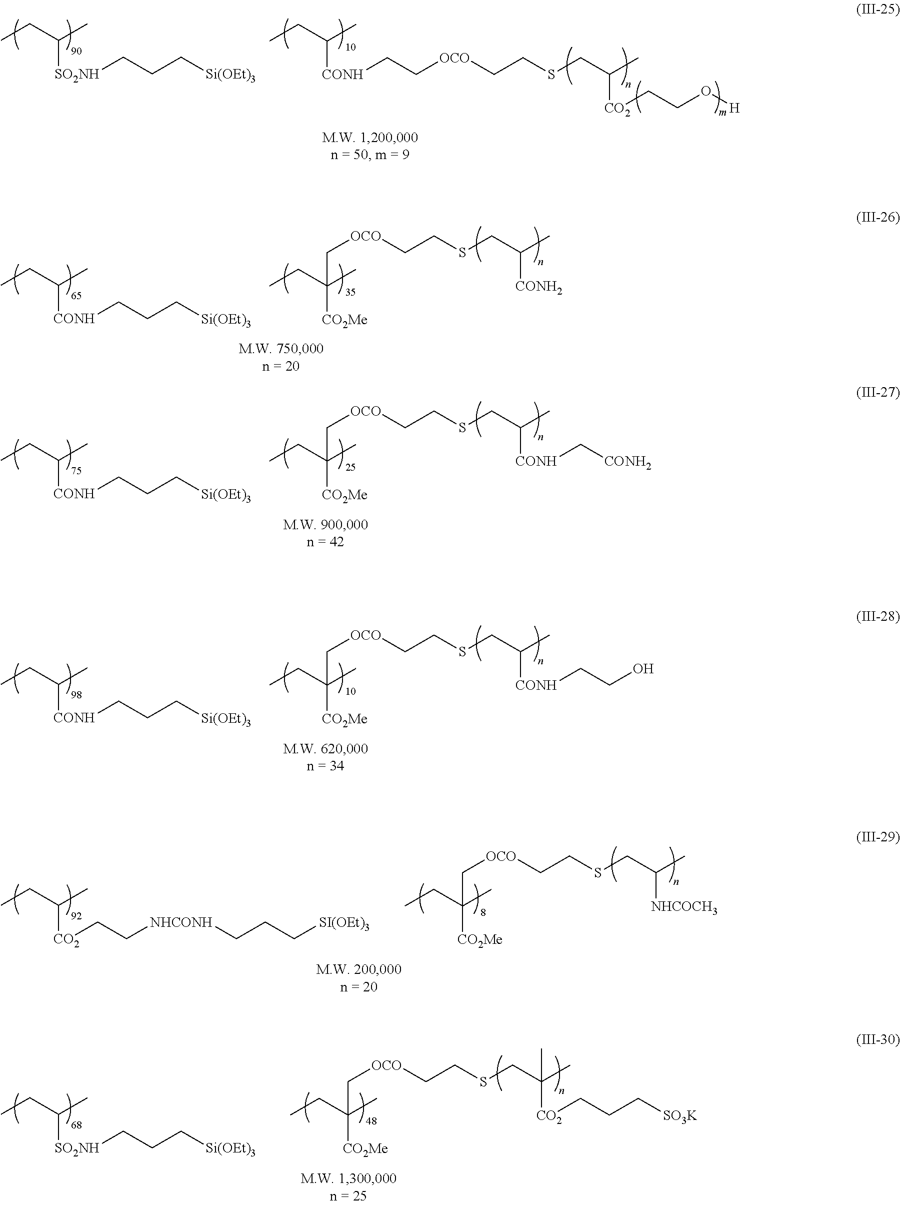

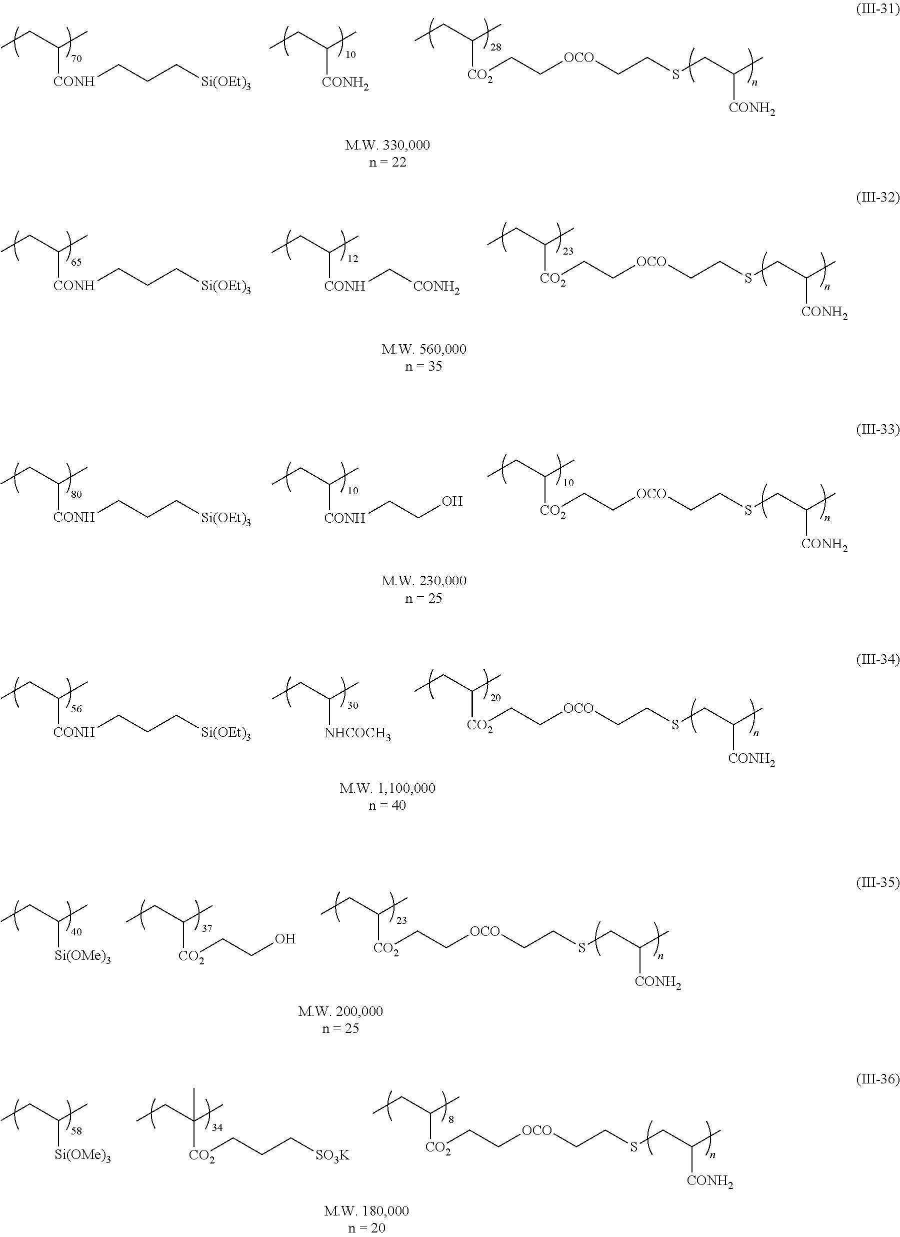

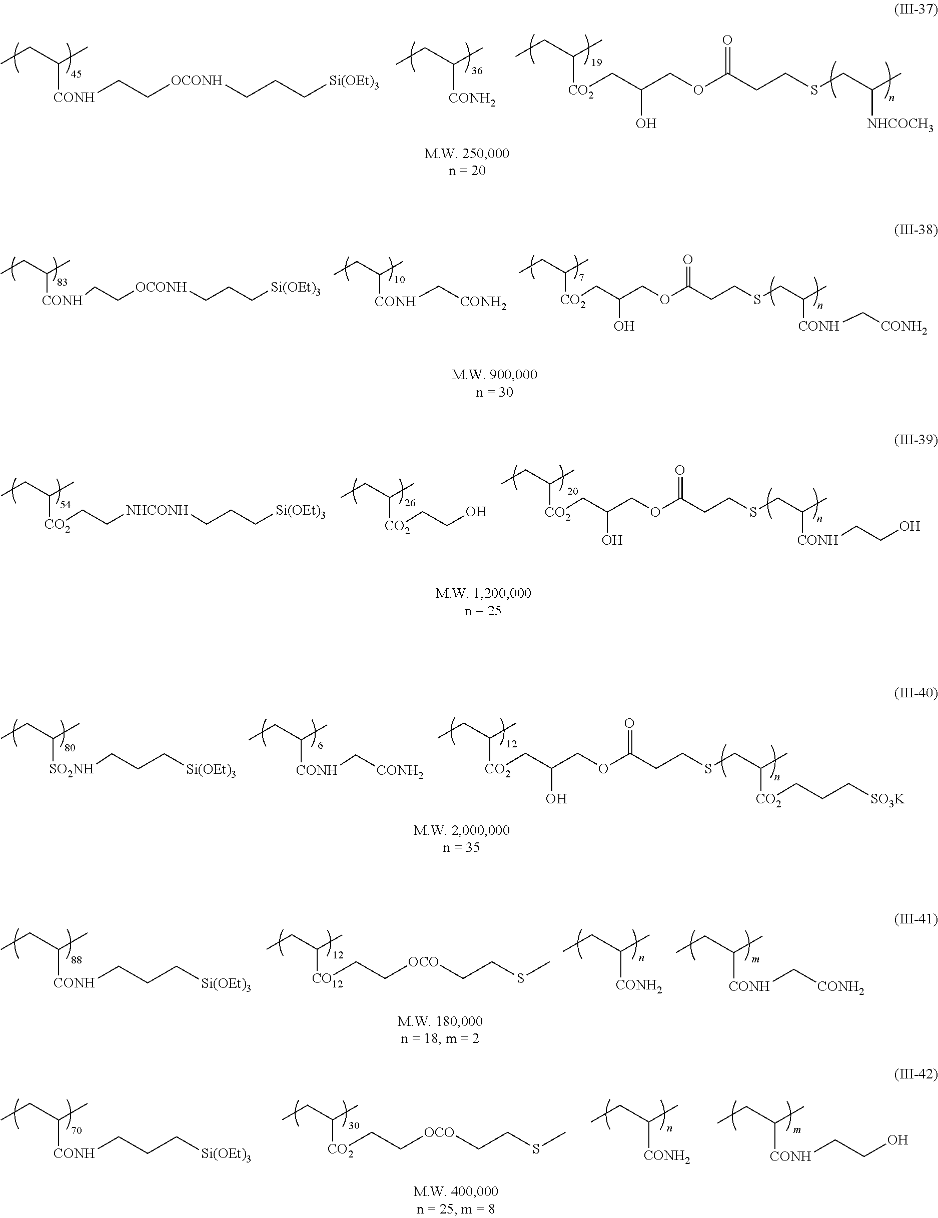

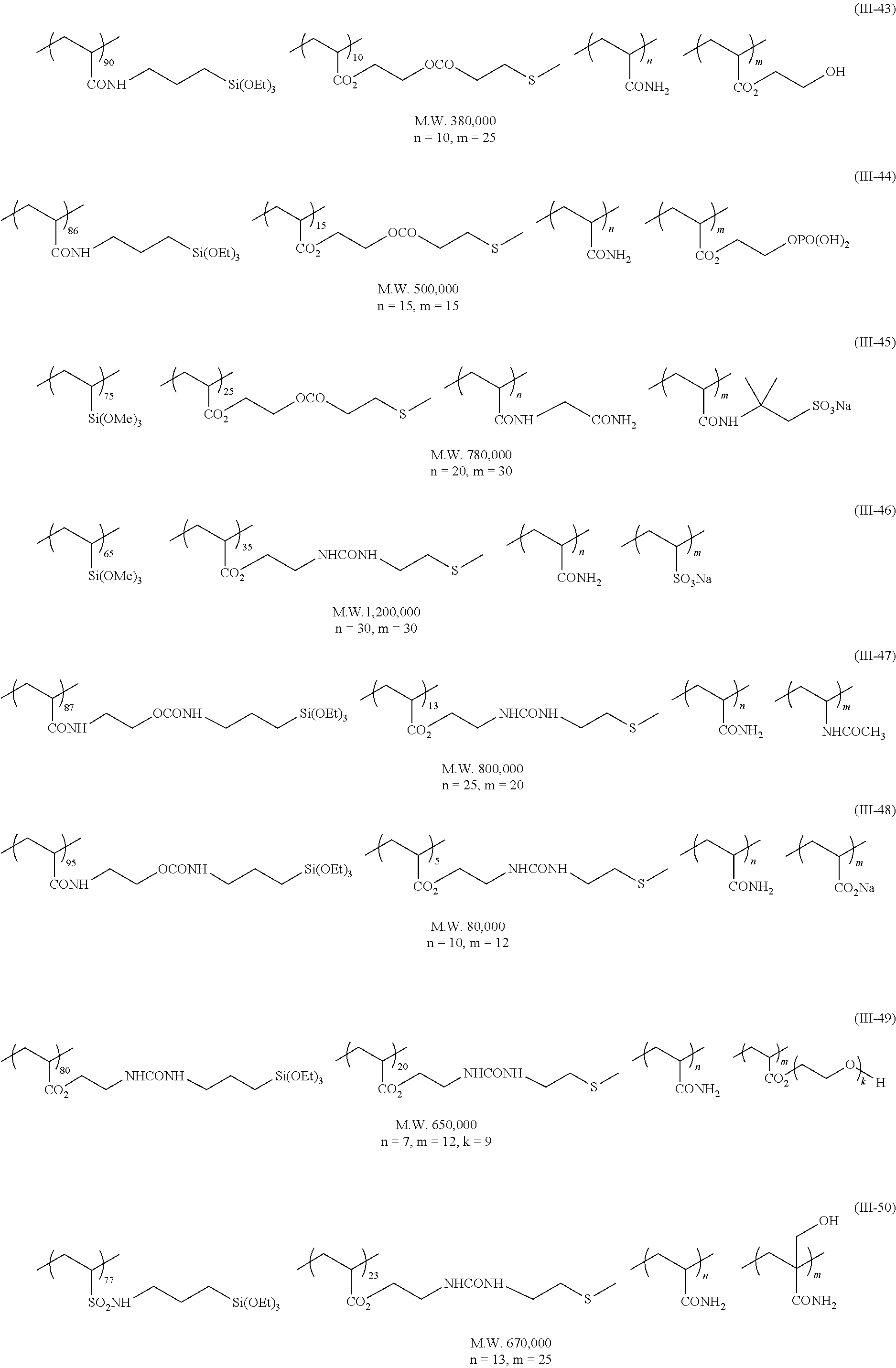

Of the hydrophilic polymers (I), (II) and (III), the hydrophilic polymer (I) or (II) is preferred, and the hydrophilic polymer (I) is more preferred. Further, the case containing the hydrophilic polymers (I) and (II) is also preferred.

The hydrophilic polymer (I), (II) or (III) may be a copolymer with other monomer. Other monomer to be used includes known monomer, for example, an acrylate, a methacrylate, an acrylamide, a methacrylamide, a vinyl ester, a styrene, acrylic acid, methacrylic acid, acrylonitrile, maleic anhydride or maleimide. Various physical properties, for example, film-forming property, film strength, hydrophilicity, hydrophobicity, solubility, reactivity or stability can be improved by the copolymerization with such a monomer.

Specific examples of the acrylate include methyl acrylate, ethyl acrylate, (n- or iso-)propyl acrylate, (n-, iso-, sec- or tert-)butyl acrylate, amyl acrylate, 2-ethylhexyl acrylate, dodecyl acrylate, chloroethyl acrylate, 2-hydroxyethyl acrylate, 2-hydroxypropyl acrylate, 2-hydroxypentyl acrylate, cyclohexyl acrylate, allyl acrylate, trimethylolpropane monoacrylate, pentaerythritol monoacrylate, benzyl acrylate, methoxybenzyl acrylate, chlorobenzyl acrylate, hydroxybenzyl acrylate, hydroxyphenethyl acrylate, dihydroxyphenethyl acrylate, furfuryl acrylate, tetrahydrofurfuryl acrylate, phenyl acrylate, hydroxyphenyl acrylate, chlorophenyl acrylate, sulfamoylphenyl acrylate and 2-(hydroxyphenylcarbonyloxy)ethyl acrylate.

Specific examples of the methacrylate include methyl methacrylate, ethyl methacrylate, (n- or iso-) propyl methacrylate, (n-, iso-, sec- or tert-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 2-hydroxypentyl methacrylate, cyclohexyl methacrylate, allyl methacrylate, trimethylolpropane monomethacrylate, pentaerythritol monomethacrylate, benzyl methacrylate, methoxybenzyl methacrylate, chlorobenzylmethacrylate, hydroxybenzyl methacrylate, hydroxyphenethyl methacrylate, dihydroxyphenethyl methacrylate, furfuryl methacrylate, tetrahydrofurfuryl methacrylate, phenyl methacrylate, hydroxyphenyl methacrylate, chlorophenyl methacrylate, sulfamoylphenyl methacrylate and 2-(hydroxyphenylcarbonyloxy)ethyl methacrylate.

Specific examples of the acrylamide include acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide and N-hydroxyethyl-N-methylacrylamide.

Specific examples of the methacrylamide include methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide and N-hydroxyethyl-N-methylmethacrylamide.

Specific examples of the vinyl ester include vinyl acetate, vinyl butyrate and vinyl benzoate.

Specific examples of the styrene include styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorosyrene, dichlorostyrene, bromostyrene, iodostyrene, fluorostyrene and carboxystyrene.

Although a ratio of such other monomer to be used in the synthesis of the copolymer is necessary to be an amount sufficient for improving various physical properties, the ratio is preferred to be not too large in order to achieve the sufficient function as the hydrophilic layer and to fully obtain the advantages of adding the hydrophilic polymer (I), hydrophilic polymer (II) and/or hydrophilic polymer (III). Therefore, the total ratio of other monomer in the hydrophilic polymer (I), hydrophilic polymer (II) and/or hydrophilic polymer (III) is preferably 80% by weight or less, and more preferably 50% by weight or less.

Measurement of the copolymerization ratio of the hydrophilic polymer (I), hydrophilic polymer (II) or hydrophilic polymer (III) can be conducted by a nuclear magnetic resonator (NMR) or an infrared spectrophotometer using a calibration curve prepared with a standard substance.

The hydrophilic composition according to the invention may contain one kind of the hydrophilic polymer or two or more kinds thereof.

From the standpoint of curability and hydrophilicity, the hydrophilic polymer is used in an amount from 80% by weight or more, preferably from 80 to 95% by weight, more preferably from 80 to 90% by weight, based on the total solid content of the hydrophilic composition.

The hydrophilic polymer forms a crosslinked film in the state of a mixture with a hydrolysis and polycondensation product of a metal alkoxide. The hydrophilic polymer that is an organic component participates in film strength and film flexibility. In particular, when viscosity of the hydrophilic polymer is in a range from 0.1 to 100 mPa·s (aqueous 5% solution, measured at 20° C.), preferably in a range from 0.5 to 70 mPa·s, still more preferably in a range from 1 to 50 mPa·s, the good film properties are obtained.

Further, the hydrophilic polymer is preferably a hydrophilic polymer containing at least one polar group selected from a group shown below and an alkoxysilyl group.
Polar group: —CONH₂, —COOM and —OH

(wherein M represents a hydrogen atom, an alkali metal or an alkaline earth metal)
Alkoxysilyl group: —Si—(OR)ₙR₃₋ₙ

(wherein R each independently represents —CH₃, —C₂H₅ or —C₃H₇, and n represents 2 or 3)

M of —COOM that is a polar group is more preferably a hydrogen atom.

The polar group is preferably at least any one of —CONH₂, —COOH and —OH.

The alkoxysilyl group is preferably at least any one of tetramethoxysilane and methyltrimethoxysilane.

It is more preferred that both the polar group and the alkoxysilyl group fall within the preferred ranges described above.

The hydrophilic polymer may contain a hydrophilic group in addition to the polar group and alkoxysilyl group described above. The hydroxy group includes, for example, —NHCOR, —NHCO₂R, —NHCONR₂, —NR₂, —CONR₂, —OCONR₂, —COR, —OR, —OM, —CO₂R, —SO₃M, —OSO₃M, —SO₂R, —NHSO₂R, —SO₂NR₂, —PO₃M, —OPO₃M, —(CH₂CH₂O)ₙH, —(CH₂CH₂O)ₙCH₃ and —NR₃Z¹. In the formulae, R, which may be the same or different when plural R are present, each represents a hydrogen atom, an alkyl group (preferably a straight-chain, branched or cyclic alkyl group having from 1 to 18 carbon atoms), an aryl group or an aralkyl group, M represents a hydrogen atom, an alkyl group, an alkali metal, an alkaline earth metal or an onium, n represents an integer (preferably an integer from 1 to 100), and Z¹ represents a halide ion. Also, when plural R are present as in —OCONR₂, R may be combined with each other to form a ring and the ring formed may be a hetero ring containing a hetero atom, for example, an oxygen atom, a sulfur atom or a nitrogen atom. R may further have a substituent and the substituent is same as the substituent capable of being introduced into the alkyl group for R¹⁰¹ in the hydrophilic polymer (I) described above.

R preferably includes, specifically, a methyl group, an ethyl group, a propyl group, a butyl group, a pentyl group, a hexyl group, a heptyl group, an octyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group and the like. M includes a hydrogen atom, an alkali metal, for example, lithium, sodium or potassium, an alkaline earth metal, for example, calcium or barium, and an onium, for example, ammonium, iodonium or sulfonium.

The hydrophilic group preferably includes —NHCOCH₃, —CON(CH₃)₂, —SO₃⁻NMe₄⁺, —SO₃⁻K⁺, —(CH₂CH₂O)ₙH, a morpholyl group and the like, and more preferably —NHCOCH₃, —CON(CH₃)₂, —SO₃⁻K⁺ and —(CH₂CH₂O)ₙH.

The hydrophilic composition according to the invention may contain other components as described below in addition to the hydrophilic polymer.

### [Crosslinking Agent]

In the case where the hydrophilic composition contains the hydrophilic polymer (II) described above, the hydrophilic composition preferably contains a crosslinking agent in order to obtain good curability. In the case where the hydrophilic composition contains the hydrophilic polymer (I) or (II) described above, good curability can be obtained without containing a crosslinking agent, but the hydrophilic composition may contain a crosslinking agent in order to obtain a layer having exceptional film strength.

As the crosslinking agent, an alkoxide compound (hereinafter, also referred to as a metal alkoxide) containing an element selected from Si, Ti, Zr and Al is particularly preferred. The metal alkoxide is a hydrolyzable polymerizable compound having a functional group capable of undergoing hydrolysis and polycondensation in its structure and exerting a function as a crosslinking agent so that the metal alkoxides undergo the polycondensation with each other to form a strong crosslinked film having a crosslinked structure and the metal alkoxide can also form a chemical bond with the hydrophilic polymer. The metal alkoxide can be represented by formula (V-1) or (V-2) shown below. In the formulae, R²⁰ represents a hydrogen atom, an alkyl group or an aryl group, R²¹ and R²² each represents an alkyl group or an aryl group, Z represents Si, Ti or Zr, and m represents an integer from 0 to 2. When each of R²⁰ and R²¹ represents an alkyl group, a number of carbon atoms included in the alkyl group is preferably from 1 to 4. The alkyl group and the aryl group may each have a substituent, and examples of the substituent which can be introduced include a halogen atom, an amino group and a mercapto group. The metal oxide is a low-molecular weight compound and preferably has a molecular weight of 2,000 or less.

(R²⁰)ₘ—Z—(OR²¹)₄₋ₘ (V-1)

Al—(OR²²)₃ (V-2)

Specific examples of the metal alkoxide represented by formula (V-1) or (V-2) are set forth below, but the invention should not be construed as being limited thereto.

In the case where Z represents Si, that is, the hydrolyzable compound contains silicon, examples thereof include trimethoxysilane, tetramethoxysilane, tetraethoxysilane, tetrapropoxysilane, methyltrimethoxysilane, dimethyldimethoxysilane, γ-chloropropyltriethoxysilane, γ-mercaptopropyltrimethoxysilane, γ-aminopropyltriethoxysilane, phenyltrimethoxysilane and diphenyldimethoxysilane. Of the compounds, trimethoxysilane, tetramethoxysilane, tetraethoxysilane, methyltrimethoxysilane, dimethyldimethoxysilane and phenyltrimethoxysilane are particularly preferred.

In the case where Z represents Ti, that is, the hydrolyzable compound contains titanium, examples thereof include trimethoxy titanate, tetramethoxy titanate, triethoxy titanate, tetraethoxy titanate, tetrapropoxy titanate, chlorotrimethoxy titanate, chlorotriethoxy titanate, ethyltrimethoxytitanate, methyltriethoxy titanate, ethyltriethoxy titanate, diethyldiethoxy titanate, phenyltrimethoxy titanate and phenyltriethoxy titanate. In the case where Z represents Zr, that is, the hydrolyzable compound contains zirconium, examples thereof include zirconates which correspond to the titanium-containing compounds illustrated above.

Also, in the case where the central metal is Al, that is, the hydrolyzable compound contains aluminum, examples thereof include trimethoxy aluminate, triethoxy aluminate, tripropoxy aluminate and triisopropoxy aluminate.

Of the compounds described above, tetramethoxysilane, tetraethoxysilane, methyltrimethoxysilane and methyltriethoxysilane are particularly preferred.

The metal alkoxide compound containing metal selected from Si, Ti, Zr and Al is preferably used in an amount from 0 to 20% by weight, more preferably in an amount from 10 to 15% by weight, based on the total solid content of the hydrophilic composition.

### [Curing Catalyst]

In the hydrophilic composition according to the invention, by dissolving the hydrophilic polymer and, if desired, the crosslinking agent in a solvent and thoroughly stirring the solution, the components undergo hydrolysis and polycondensation to form an organic-inorganic hybrid sol liquid, and by the sol liquid a hydrophilic layer having high hydrophilicity and high film strength is formed. In the preparation of the organic-inorganic hybrid sol liquid, it is preferred to use a curing catalyst in order to accelerate the hydrolysis and polycondensation reaction. Use of the curing catalyst makes it possible to set a drying temperature for film-forming of the hydrophilic layer at a low level so that thermal deformation of an antibacterial agent or on the polyester film can be inhibited.

As the curing catalyst which can be used in the invention, a catalyst capable of hydrolyzing and polycondensing the crosslinking agent described above and accelerating a reaction for forming a bond with the hydrophilic polymer is selected, and an acid or basic compound is used as it is or an acid or basic compound is used in the state that it is dissolved in a solvent, for example, water or an alcohol (hereinafter, these catalysts are also referred to inclusively as an acidic catalyst and a basic catalyst, respectively). In dissolving the acid or basic compound in a solvent, its concentration is not particularly limited and may be appropriately selected depending on the characteristics of the acid or basic compound to be used, the desired content of the catalyst or the like. In the case where the concentration of the acid or basic compound which constitutes the catalyst is high, the rate of hydrolysis and polycondensation tends to become fast. However, when the basic catalyst of a high concentration is used, a precipitate may be formed in the sol solution in some cases and thus, when the basic catalyst is used, its concentration is desirably not more than 1 N as calculated in terms of concentration in the aqueous solution.

The kind of the acidic catalyst or basic catalyst is not particularly limited. When it is required to use a catalyst having high concentration, a catalyst constituted of an element which does not substantially remain in the coated layer after drying is desired. Specifically, examples of the acidic catalyst include a hydrogen halide, for example, hydrochloric acid, nitric acid, sulfuric acid, sulfurous acid, hydrogen sulfide, perchloric acid, hydrogen peroxide, carbonic acid, a carboxylic acid, for example, formic acid or acetic acid, a substituted carboxylic acid represented by the structural formula of RCOOH wherein R is substituted with other element or a substituent and a sulfonic acid, for example, benzenesulfonic acid, and examples of the basic compound include an ammoniacal base, for example, aqueous ammonia and an amine, for example, ethylamine or aniline.

Also, in addition to the catalyst described above, a Lewis acid catalyst composed of a metal complex can be preferably used. A particularly preferred catalyst is a metal complex catalyst and the metal complex is composed of a metal element selected from Groups 2A, 3B, 4A and 5A of the periodic table and an oxo or hydroxy oxygen-containing compound selected from a β-diketone, a ketoester, a hydroxycarboxylic acid and its ester, an amino alcohol and an enolic active hydrogen compound.

Of the constituent metal elements, the elements of Group 2A, for example, Mg, Ca, Sr or Ba, the elements of Group 3B, for example, Al or Ga, the elements of Group 4A, for example, Ti or Zr and the elements of Group 5A, for example, V, Nb or Ta are preferred and they form the complexes having an excellent catalytic effect respectively. Among them, the complexes with any of Zr, Al and Ti are excellent and preferred.

The oxo or hydroxy oxygen-containing compound constituting a ligand of the metal complex used in the invention include a β-diketone, for example, acetylacetone (2,4-pentanedione) or 2,4-heptanedione, a ketoester, for example, methyl acetoacetate, ethyl acetoacetate or butyl acetoacetate, a hydroxycarboxylic acid and its ester, for example, lactic acid, methyl lactate, salicylic acid, ethyl salicylate, phenyl salicylate, malic acid, tartaric acid or methyl tartrate, an ketoalcohol, for example, 4-hydroxy-4-methyl-2-pentanone, 4-hydroxy-2-pentanone, 4-hydroxy-4-methyl-2-heptanone or 4-hydroxy-2-heptanone, an amino alcohol, for example, monoethanolamine, N,N-dimethylethanolamine, N-methylmonoethanolamine, diethanolamine or triethanolamine, an enolic active compound, for example, methylolmelamine, methylolurea, methylolacrylamide or diethyl malonate and a compound derived from acetylacetone (2,4-pentanedione) by introducing a substituent into the methyl group, methylene group or carbonyl carbon thereof.

A preferred ligand is acetylacetone or an acetylacetone derivative. The acetylacetone derivative indicates a compound derived from acetylacetone by introducing a substituent into the methyl group, methylene group or carbonyl carbon thereof in the invention. Examples of the substituent for the methyl group of acetylacetone include a straight-chain or branched alkyl group, an acyl group, a hydroxyalkyl group, a carboxyalkyl group, an alkoxy group and an alkoxyalkyl group each having from 1 to 3 carbon atoms. Examples of the substituent for the methylene group of acetylacetone include a carboxyl group, and a straight-chain or branched carboxyalkyl group and a hydroxyalkyl group each having from 1 to 3 carbon atoms. Examples of the substituent for the carbonyl carbon of acetylacetone include an alkyl group having from 1 to 3 carbon atoms, and in this case, a hydrogen atom is attached to the carbonyl oxygen to form a hydroxyl group.

Preferred specific examples of the acetylacetone derivative include ethylcarbonylacetone, n-propylcarbonylacetone, isopropylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone and diacetone alcohol.

Among them, acetylacetone and diacetylacetone are particularly preferred. The complex of the acetylacetone derivative and the metal element is a mononuclear complex having from 1 to 4 molecular ligands of the acetylacetone derivative per one metal element therein. In the case where the number of the coordinatable bonds of the metal element is greater than the total number of the coordinatable bonds of the acetylacetone derivative, a ligand widely used in an ordinary complex, for example, a water molecule, a halide ion, a nitro group or an ammonio group may be coordinated in the complex.

Preferred examples of the metal complex include tris(acetylacetonato)aluminum complex, di(acetylacetonato)aluminum•aquo complex, mono(acetylacetonato)aluminum•chloro complex, di(diacetylacetonato)aluminum complex, ethylacetoacetate aluminum diisopropylate, aluminum tris(ethylacetoacetate), cyclic aluminum oxide isopropylate, tris(acetylacetonato)barium complex, di(acetylacetonato)titanium complex, tris(acetylacetonato)titanium complex, diisopropoxy•bis(acetylacetonato)titanium complex, zirconium tris(ethylacetoacetate) and zirconium tris(benzoate) complex. They are excellent in stability in a water-based coating solution and gelation promoting effect in a sol-gel reaction at drying with heating. Among them, ethylacetoacetate aluminum diisopropylate, aluminum tris(ethylacetoacetate), di(acetylacetonato)titanium complex and zirconium tris(ethylacetoacetate) are particularly preferred.

Although description of a counter salt of the metal complex described above is omitted in the specification, the kind of the counter salt may be any water-soluble salt capable of maintaining the charge of the complex compound neutral and the form of salt capable of ensuring stoichiometric neutrality, for example, a nitrate, a hydrohalide, a sulfate or a phosphate is used.

The behavior of the metal complex in a silica sol-gel reaction is described in detail in J. Sol-Gel Sci. and Tec., 16, 209 (1999). As for the reaction mechanism, the following scheme may be presumed. Specifically, in a coating solution, the metal complex has a coordination structure and is stable. In the dehydration condensation reaction which begins in the process of drying by heating after coating, the metal complex is believed to promote crosslinking in the mechanism like that of an acid catalyst. In any event, use of the metal complex can satisfy all of the improvements in time-lapse stability of the coating solution and the film surface quality, high hydrophilicity and high durability.

The curing catalyst is used preferably in a range from 0 to 20% by weight, more preferably in a range from 10 to 15% by weight, in terms of a non-volatile component in the hydrophilic composition according to the invention. The curing catalysts may be used individually or in combination of two or more thereof.

### [Other Additives]

### (Surfactant)

In the invention, a surfactant is preferably used in order to improve surface state of layer coated from the hydrophilic composition described above. Examples of the surfactant include a nonionic surfactant, an anionic surfactant, a cationic surfactant, an amphoteric surfactant and a fluorine-based surfactant.

The nonionic surfactant for use in the invention is not particularly restricted and conventionally known nonionic surfactants can be used. Examples thereof include a polyoxyethylene alkyl ether, a polyoxyethylene alkylphenyl ether, a polyoxyethylene polystyrylphenyl ether, a polyoxyethylene polyoxypropylene alkyl ether, a glycerin fatty acid partial ester, a sorbitan fatty acid partial ester, a pentaerythritol fatty acid partial ester, a propylene glycol mono-fatty acid ester, a sucrose fatty acid partial ester, a polyoxyethylene sorbitan fatty acid partial ester, a polyoxyethylene sorbitol fatty acid partial ester, a polyethylene glycol fatty acid ester, a polyglycerin fatty acid partial ester, a polyoxyethylenated castor oil, a polyoxyethylene glycerin fatty acid partial ester, a fatty acid diethanolamide, an N,N-bis-2-hydroxyalkylamine, a polyoxyethylene alkylamine, a triethanolamine fatty acid ester, a trialkylamine oxide, polyethylene glycol and a copolymer of polyethylene glycol and polypropylene glycol.

The anionic surfactant for use in the invention is not particularly restricted and conventionally known anionic surfactants can be used. Examples thereof include a fatty acid salt, an abietic acid salt, a hydroxyalkanesulfonic acid salt, an alkanesulfonic acid salt, a dialkylsulfosuccinic ester salt, a straight-chain alkylbenzenesulfonic acid salt, a branched alkylbenzenesulfonic acid salt, an alkylnaphthalenesulfonic acid salt, an alkylphenoxypolyoxyethylene propylsulfonic acid salt, a polyoxyethylene alkylsulfophenyl ether salt, an N-methyl-N-oleyltaurin sodium salt, an N-alkylsulfosuccinic acid monoamide disodium salt, a petroleum sulfonic acid salt, a sulfated beef tallow oil, a sulfuric ester salt of a fatty acid alkyl ester, an alkylsulfuric ester salt, a polyoxyethylene alkyl ether sulfuric ester salt, a fatty acid monoglyceride sulfuric ester salt, a polyoxyethylene alkylphenyl ether sulfuric ester salt, a polyoxyethylene styrylphenyl ether sulfuric ester salt, an alkylphosphoric ester salt, a polyoxyethylene alkyl ether phosphoric ester salt, a polyoxyethylene alkylphenyl ether phosphoric ester salt, a partially saponified product of a styrene/maleic anhydride copolymer, a partially saponified product of an olefin/maleic anhydride copolymer and a naphthalenesulfonic acid salt formalin condensate.

The cationic surfactant for use in the invention is not particularly restricted and conventionally known cationic surfactants can be used. Examples thereof include an alkylamine salt, a quaternary ammonium salt, a polyoxyethylene alkylamine salt and a polyethylene polyamine derivative.

The amphoteric surfactant for use in the invention is not particularly restricted and conventionally known amphoteric surfactants can be used. Examples thereof include a carboxybetaine, an aminocarboxylic acid, a sulfobetaine, an aminosulfuric ester and an imidazoline.

In the surfactants described above, the term “polyoxyethylene” can also be replaced with “polyoxyalkylene”, for example, polyoxymethylene, polyoxypropylene or polyoxybutylene. In the invention, such surfactants can also be used.

Examples of the fluorine-based surfactant for use in the invention include a fluorine-based surfactant containing a perfluoroalkyl group in the molecule thereof. Examples of such a fluorine-based surfactant include an anionic type, for example, a perfluoroalkylcarboxylic acid salt, a perfluoroalkylsulfonic acid salt or a perfluoroalkylphosphoric ester; an amphoteric type, for example, a perfluoroalkylbetaine; a cationic type, for example, a perfluoroalkyltrimethylammonium salt; and a nonionic type, for example, a perfluoroalkylamine oxide, a perfluoroalkyl ethylene oxide adduct, an oligomer containing a perfluoroalkyl group and a hydrophilic group, an oligomer containing a perfluoroalkyl group and an oleophilic group, an oligomer containing a perfluoroalkyl group, a hydrophilic group and an oleophilic group and a urethane containing a perfluoroalkyl group and an oleophilic group. Also, fluorine-based surfactants described in JP-A-62-170950, JP-A-62-226143 and JP-A-60-168144 are preferably exemplified.

The surfactant is more preferably an anionic surfactant.

The surfactant is preferably used in a range from 0.001 to 30% by weight, more preferably in a range from 0.01 to 20% by weight in terms of a non-volatile component in the hydrophilic composition according to the invention. Also, the surfactants can be used individually or in combination of two or more thereof.

Specific examples of preferred surfactant are set forth below, but the invention should not be construed as being limited thereto.

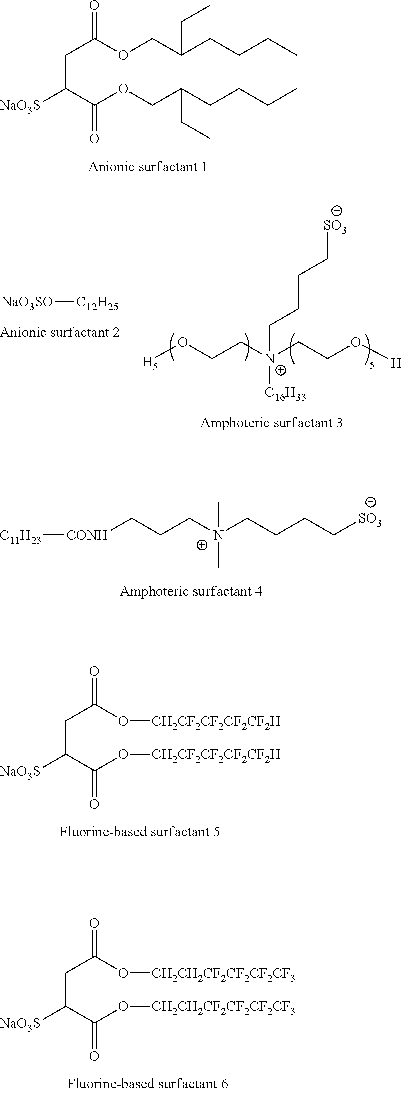

A more hydrophilic surface can be formed by using the surfactant in combination with the hydrophilic polymer containing at least the structural unit represented by formula (I-a) and the structural unit represented by formula (I-b). Although its mechanism is not sufficiently clarified, it is presumed that, as the surfactant which is a low molecular weight compound migrates into the coated film surface layer in the course of drying of the coated film, the hydrophilic segment in the polymer segment is attracted to the hydrophilic moiety of the surfactant, thereby achieving the high hydrophilicity.

### (Antioxidant)

For the purpose of improving the stability of the hydrophilic film according to the invention, an antioxidant can be added to the coating solution for forming the hydrophilic layer. Examples of the antioxidant include those described in EP-A-223739, EP-A-309401, EP-A-309402, EP-A-310551, EP-A-310552, EP-A-459416, DE-A-3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449 and U.S. Pat. Nos. 4,814,262 and 4,980,275.

The amount of the antioxidant added can be appropriately selected depending upon the purpose and is preferably from 0.1 to 8% by weight in terms of a solid content.

### (Polymer Compound)

Various polymer compounds may be added to the coating solution for forming the hydrophilic layer of the hydrophilic film according to the present invention to the extent that the hydrophilicity of the layer is not damaged in order to control the physical property of the hydrophilic layer. As the polymer compound, an acrylic polymer, a polyvinyl alcohol resin, a polyvinyl butyral resin, a polyurethane resin, a polyamide resin, a polyester resin, an epoxy resin, a phenolic resin, a polycarbonate resin, a polyvinyl formal resin, shellac, a vinyl resin, an acrylic resin, a rubber resin, a wax and other natural resin are exemplified. Two or more kinds of the polymer compounds may be used in combination. Among them, a vinyl copolymer obtained by copolymerization of acrylic monomers is preferred. Further, a copolymer containing as a structural unit, “carboxyl group-containing monomer”, “alkyl methacrylate” or “alkyl acrylate” is preferably used as a copolymerization composition of polymer binder.

In addition, if desired, the hydrophilic composition may contain, for example, a leveling additive, a mat agent, a wax for controlling the physical property of layer or a tackifier for improving the adhesion property to a polyester film to the extent that the hydrophilicity is not damaged.

The tackifier specifically includes, for example, a tacky polymer of high molecular weight described in JP-A-2001-49200, pages 5 to 6 (for example, a copolymer composed of an ester of (meth)acrylic acid with an alcohol having an alkyl group having from 1 to 20 carbon atoms, an ester of (meth)acrylic acid with an alicyclic alcohol having from 3 to 14 carbon atoms and an ester of (meth)acrylic acid with an aromatic alcohol having from 6 to 14 carbon atoms) and a tackiness-imparting resins of low molecular weight having a polymerizable unsaturated bond.

### [Preparation of Hydrophilic Composition]

Preparation of the hydrophilic composition can be carried out by dissolving the hydrophilic polymer, and appropriately, the crosslinking agent, the curing catalyst and other additives in a solvent and stirring the resulting solution. The curing catalyst is preferably mixed immediately before the coating on a polyester film. Specifically, it is preferred to coat the hydrophilic composition from immediately after mixing the curing catalyst until one hour after mixing the curing catalyst.

When the hydrophilic composition is coated after mixing the curing catalyst and allowing it to stand for a long period of time, the viscosity of the hydrophilic composition increases so that a defect, for example, coating unevenness may arise in some cases.

Although it is also preferred that other components are mixed immediately before coating the hydrophilic composition, the hydrophilic composition may be stored for a long period of time after mixing other components.

In the preparation, the reaction temperature is preferably from room temperature to 80° C. and the reaction time, that is, a time of continuing stirring, is preferably in the range from 1 to 72 hours. The stirring promotes the hydrolysis and polycondensation of the hydrophilic polymer and the crosslinking agent to provide an organic-inorganic hybrid sol liquid.

The solvent which is used in the preparation of the hydrophilic composition is not particularly limited so far as it is able to uniformly dissolve or disperse the components and preferably includes an aqueous solvent, for example, methanol, ethanol or water.

As described above, the preparation of the organic-inorganic hybrid sol liquid (hydrophilic composition) for forming a hydrophilic layer from the hydrophilic composition utilizes a sol-gel method. The sol-gel method is described in detail in books, for example, Sumio Sakuhana, Sol-gel Ho no Kagaku, published by Agne Shofu Sha (1988) and Hiroshi Hirashima, Saishin Sol-gel Ho niyoru Kinosei Hakumaku Sakusei Gijutsu, published by Sogo Gijutsu Center (1992). The methods described in the documents can be applied to the preparation of the hydrophilic composition according to the invention.

The hydrophilic film can be obtained by coating a solution containing such a hydrophilic composition on a polyester film and drying.

The drying temperature is a temperature at which the resin does not deform. It is preferably from 30 to 200° C., and more preferably from 80 to 180° C.

When the drying temperature is too low, the crosslinking reaction does not proceed sufficiently to result in low coated film strength whereas, when the drying temperature is too high, cracks are liable to be formed in the coated film to cause partially insufficient antifogging property.

The drying time is preferably from 5 to 30 seconds, and more preferably from 10 to 30 seconds.

When the drying time is too short, due to insufficient drying the coated film strength may decrease in some cases. When the drying time is prolonged more than is necessary, the productivity reduces.

The solid content concentration of the hydrophilic composition is preferably from 1 to 20% by weight, and more preferably from 3 to 10% by weight.

The hydrophilic composition can be coated by a known coating method without particular limitation. For example, an air doctor coating, a blade coating, a rod coating, an extrusion coating, an air knife coating, a squeeze coating, a dip coating, a reverse roll coating, a transfer roll coating, a gravure coating, a kiss coating, a cast coating, a spray coating or a spin coating can be utilized. With respect to theses coating methods, for example, Saishin Coating Gijutsu, published by Sogo Gijutsu Center (May 31, 1983) can be referred to.

The thickness of the hydrophilic layer is preferably from 30 to 200 nm, and more preferably from 50 to 100 nm. The thickness of 30 nm or more is preferred because the sufficient hydrophilic effect is exerted. The thickness of 200 nm or less is preferred because a defect, for example, drying unevenness is hard to occur. The thickness can be controlled, for example, by solid content concentration of the hydrophilic composition, a coil diameter of a bar coater, as well as a known method.

The center line average roughness, Ra, of the surface of the hydrophilic layer is preferably from 1 to 10 nm.

Also, Tg of the hydrophilic layer is preferably from 40 to 150° C. from the standpoint of the coated film strength. Further, the modulus of elasticity of the hydrophilic layer is preferably from 1 to 7 GPa.

The surface state of the hydrophilic layer can be controlled by adjusting surface roughness of a polyester film, viscosity of a coating solution composition for forming the hydrophilic layer, heating temperature and heating rate of the hydrophilic coated film and the like, but the invention should not be construed as being limited thereto.

The degree of hydrophilicity of the hydrophilic surface is ordinarily measured by a water droplet contact angle. In the hydrophilic layer according to the invention, the water droplet contact angle on the surface thereof is preferably 40° or less, more preferably 30° or less, and still more preferably 20° or less.

Also, it is particularly preferred that the water droplet contact angle on the surface of the hydrophilic layer after repeating 100 cycles of spraying water on the surface of the hydrophilic layer and drying at 80° C. for 5 seconds is 15° or less.

Further, when a cycle composed of spraying evenly water on the surface of the hydrophilic layer by an atomizer, exposing it to water vapor at 45° C. for 10 seconds, conducting an antifogging test of the hydrophilic layer (to measure a fogged area on the surface of the hydrophilic layer and to determine whether the fogged area is 80% or less of the total area or not), and then drying it at 80° C. for one minute is taken as one cycle and a number of cycles in which the fogged area on the surface of the hydrophilic layer becomes 80% or less in the antifogging test (a number of cycles in which the fogged area on the surface of the hydrophilic layer maintains 80% or less) is evaluated, the number of cycles is preferably 100 cycles or more, more preferably 150 cycles or more, and still more preferably 200 cycles or more. Also, the water droplet contact angle of the surface after the cycle test is preferably 20° or less, and more preferably 15° or less.

In addition, as a method for evaluating the degree of hydrophilicity on a solid surface in more detail, there is a method of measuring surface free energy. Although various methods have been proposed, the surface free energy was measured by using a Zisman plot method as one example in the invention. Specifically, the Zisman plot method is a measurement method in which, by utilizing the property in which in an aqueous solution of an inorganic electrolyte, for example, magnesium chloride its surface tension becomes large with an increase of the concentration thereof, a contact angle is measured in air under a room temperature condition using the aqueous solution; the surface tension of the aqueous solution is taken on the abscissa, whereas a value obtained by converting the contact angle to cos θ is taken on the ordinate, points of the aqueous solutions of various concentrations are plotted to obtain a linear relationship; and the surface tension at cos θ=1, that is, at a contact angle of 0° is defined as a surface free energy of the solid. The surface tension of water is 72 mN/m, and it may be said that, the larger the value of surface free energy, the higher the hydrophilicity is.

The hydrophilic layer in which the surface free energy as measured in such a method is in the range from 70 to 95 mN/m, preferably from 72 to 93 mN/m, more preferably from 75 to 90 mN/m, is excellent in the hydrophilicity and exhibits good performances.

### [Polyester Film]

The polyester film for use in the invention is not particularly limited and includes a film made of, for example, polyethylene terephthalate, polybutylene terephthalate, polynaphtylene phthalate, polyesterimide or polyetherester. Among them, polyethylene terephthalate is preferred from the standpoint of versatility. In particular, a polyester film obtained by biaxially-stretching is preferred because of high strength.

The thickness of the polyester film is preferably from 25 to 150 μm.

The range of thickness described above is preferred because the construction property of attaching on a window or glass surface is excellent.

### [Intermediate Layer]

One or more intermediate layers may be provided between the polyester film and the hydrophilic layer. The intermediate layer is not particularly limited and includes, for example, a primer layer for ensuring the adhesion property between the polyester film and the hydrophilic layer. In the primer layer a commercially available product may be used so far as the product has good wettability with the hydrophilic layer. Among them, an aqueous acrylic type is preferred. The intermediate layer preferably contains an ultraviolet absorbing agent or the like.

Further, the surface of the polyester film may be modified. As the modification method, a known method, for example, a corona treatment, a plasma treatment, a flame treatment or an alkali chemical conversion treatment can be used.

The intermediate layer is preferably formed by using a composition (hereinafter, also referred to as a composition for intermediate layer) containing a compound having a hydrolyzable alkoxysilyl group.

Among them, the intermediate layer formed by using a composition containing at least one kind compound selected from tetramethoxysilane, methyltrimethoxysilane, tetraethoxysilane, and methyltriethoxysilane is more preferred and the intermediate layer formed by using a composition containing at least one kind compound selected from tetramethoxysilane and methyltrimethoxysilane is still more preferred.

The composition for intermediate layer may contain various components in addition to the compound having a hydrolyzable alkoxysilyl group. For example, a curing catalyst or a solvent is exemplified. Among them, it is preferred to contain a curing catalyst or a solvent. The curing catalyst is not particularly restricted and includes, for example, the curing catalyst for use in the hydrophilic composition described above. In particular, titanium acetylacetonate is preferred and titanium acetylacetonate is more preferred. The curing catalyst is preferably added from 1 to 2 mol, more preferably one mol, to one mol of the hydrolyzable alkoxysilyl group.

The solvent is not particularly restricted and includes, for example, the solvent for use in the hydrophilic composition described above. In particular, distilled water, ethanol or the like is preferred.

The solid content concentration of the composition for intermediate layer is preferably from 1 to 10% by weight, and more preferably from 3 to 5% by weight.

The composition for intermediate layer can be coated by a known coating method without particular limitation. For example, an air doctor coating, a blade coating, a rod coating, an extrusion coating, an air knife coating, a squeeze coating, a dip coating, a reverse roll coating, a transfer roll coating, a gravure coating, a kiss coating, a cast coating, a spray coating or a spin coating can be utilized. With respect to theses coating methods, for example, Saishin Coating Gijutsu, published by Sogo Gijutsu Center (May 31, 1983) can be referred to.

The thickness of the intermediate layer is preferably from 30 to 200 nm. The thickness of 30 nm or more is preferred because even when a projection is present on the surface of the polyester film, the projection can be sufficiently filled and a coating defect, for example, repelling of the layer coated thereon is hard to occur. The thickness of 200 nm or less is preferred because a coated layer defect due to drying unevenness or curing shrinkage is hard to occur.

[Layer Construction when Using Hydrophilic Film]

When the hydrophilic film according to the invention is used, it can be used by appropriately adding other layer thereto depending upon the purpose, form or use place. The layer construction which is added if desired is described below.

### [Tacky Layer]

It is preferred to provide a tacky layer on the rare surface of the hydrophilic film according to the invention. The tacky layer is not particularly restricted and a known tacky layer can be used. For example, a tacky layer using a vinyl copolymer, for example, a polyethylene type, a polyvinyl chloride type, a polyvinyl alcohol type or a polyacrylic type, or a condensation type resin, for example, polyurethane, polyester, polyether or polyetherester is preferred. The glass transition temperature of the tacky layer is preferably from −20 to 20° C. in view of ease in sticking.

Among them, the tacky layer using a condensation type resin is preferred because adhesion property to the hydrophilic layer is excellent. A polyester type resin or a polyether type resin is particularly preferred.

### [Adhesion Layer]

In the case where the hydrophilic film according to the invention is attached on other substrate to use, an adhesive which is a pressure-sensitive adhesive is preferably used as an adhesion layer on the rear surface of the substrate. As the adhesive, an adhesive ordinarily used for an adhesive sheet, for example, a rubber-based adhesive, an acrylic adhesive, a silicone-based adhesive, a vinyl ether-based adhesive or a styrene-based adhesive can be used.

In the case where an optically transparent adhesive is required, an adhesive for an optical application is selected. In the case where coloration, translucence or a pattern, for example, a mat tone is required, it is possible to achieve the effect by adding a dye or an organic or inorganic fine particle to the adhesive in addition to patterning on the substrate.

In the case where a tackifier is required, a resin, for example, an adhesion-imparting resin, e.g., a rosin-based resin, a terpene-based resin, a petroleum-based resin, a styrene-based resin or hydrogenation products thereof can be used individually or as a mixture thereof.

The adhesive force of the adhesive for use in the invention is of ordinarily called strong adhesion and is 200 g/25 mm or more, preferably 300 g/25 mm or more, more preferably 400 g/25 mm or more. The term “adhesive force” as used herein is a value measured by a 180-degree peeling test according to JIS Z0237.

### [Release Layer]

In the case where the hydrophilic film according to the invention has the adhesion layer described above, a release layer can be further provided. In order to impart a releasing property, the release layer preferably contains a releasing agent. As the releasing agent, ordinarily, a silicone-based releasing agent composed of a polyorganosiloxane, a fluorine-based compound, a long-chain alkyl-modified product of polyvinyl alcohol, a long-chain alkyl-modified product of polyethyleneimine or the like can be used. Also, various releasing agents, for example, a hot melt type release agent or a monomer type release agent capable of curing a releasable monomer by radical polymerization, cationic polymerization, polycondensation reaction or the like and in addition, a copolymer type resin, for example, an acryl-silicone-based copolymer resin, an a aryl-fluorine-based copolymer resin or urethane-silicone-fluorine-based copolymer resin, a resin blend of a silicone-based resin and an acrylic resin and a resin blend of a fluorine-based resin and an acrylic resin may be used. Further, a hard coat release layer obtained by curing a curable composition containing any of a fluorine atom and/or a silicon atom and an active energy ray-polymerizable group-containing compound may be formed.

### [Other Layer]

A protective layer may be provided on the hydrophilic layer. The protective layer has a function for preventing scratching on the hydrophilic surface upon handling, transportation, storage or the like or preventing reduction of the hydrophilicity due to the adhesion of a staining substance. As the protective layer, a hydrophilic polymer layer used in the release layer can be used. The protective layer is peeled away after attaching the hydrophilic film onto an adequate substrate.

When the hydrophilic film is applied to (used or attached to) a windowpane or the like, transparency is important from the standpoint of ensuring visibility. The transparency is evaluated by measuring a light transmittance in a visible light region (from 400 to 800 nm) by a spectrophotometer. The light transmittance is preferably in a range from 100 to 70%, more preferably from 95 to 75%, and most preferably from 95 to 80%. When the light transmittance falls within the range, the hydrophilic film can be applied to various uses without obstructing the visibility.

The use of the hydrophilic film according to the invention includes, for example, a protective goggle, a sporting goggle, a protective mask shield, a sport mask shield, a helmet shield, a solar cell cover, a household equipment, a lavatory basin, a bathtub, a washstand, a lighting equipment, a kitchen ware, a dish, a dish drier, a sink, a kitchen range, a kitchen hood, a ventilating fan, a window rail, a window frame, an inside wall of tunnel, an illumination inside tunnel, a window sash, a radiation fin for heat exchanger, pavement, a mirror for bathroom or washstand, a ceiling for vinyl house, a washing and dressing table, an automobile body, a roof member for snowy country, an antenna, a power cable, each member of medical diagnosis device, a catheter for medical care, a display of personal computer or television, a container for cosmetics, a filter, an aluminum foil for automobile, a finder of camera, and a film for sticking on a surface of a mirror for bathroom or washstand, a window of house or building or the like.

### EXAMPLE

The invention will be described in more detail with reference to the following examples, but the invention should not be construed as being limited thereto. In the examples, a part means a part by weight.

### Example 1

### [Synthesis Example of Hydrophilic Polymer]

In a 500-ml three-neck flask were placed 56.9 g of acrylamide, 11.6 g of acrylamide-3-(ethoxysilyl)propyl, 140 g of ethanol and 140 g of 1-methoxy-2-propanol and under nitrogen stream at 80° C., 2.3 g of dimethyl 2,2′-azobis (2-methylpropionate) was added thereto. The mixture was maintained at the same temperature while stirring for 6 hours and then cooled to room temperature. The reaction solution was poured into 2 liters of acetone and the solid deposited was allowed to precipitate. The solid obtained was collected by decantation.

Then, the solvent was removed by drying at 30° C. until a dry weight reached to a constant mass thereby obtaining the hydrophilic polymer represented by formula 1. The dry weight of the polymer obtained was 65.6 g. As a result of measurement of weight average molecular weight of the polymer obtained by GPC (polyethylene oxide standard), the polymer was found to have the weight average molecular weight of 18,800.

The hydrophilic polymer represented by formula 2 was produced in the same manner as described above except for changing the acrylamide to acrylic acid.

The hydrophilic polymer represented by formula 3 was produced in the same manner as described above except for changing the acrylamide to vinyl alcohol.

The hydrophilic polymer represented by formula 4 was produced in the same manner as described above except for changing the acrylamide-3-(ethoxysilyl)propyl to acrylamide-3-(methoxysilyl)propyl.

The hydrophilic polymer represented by formula 5 was produced in the same manner as described above except for changing the acrylamide-3-(ethoxysilyl)propyl to acrylamide-3-(propoxysilyl)propyl.

The hydrophilic polymer represented by formula 6 was produced in the same manner as described above except for changing the acrylamide-3-(ethoxysilyl)propyl to acrylamide-methyl-2-(ethoxysilyl)propyl.

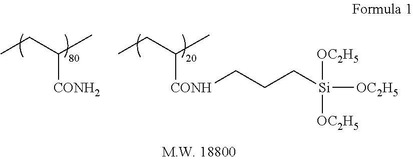

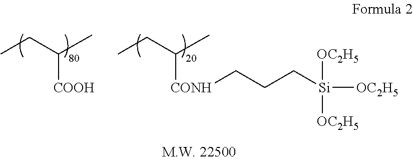

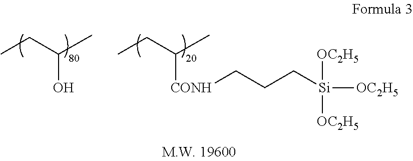

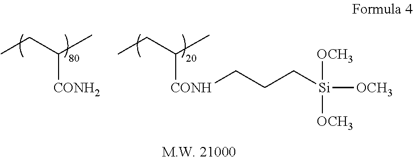

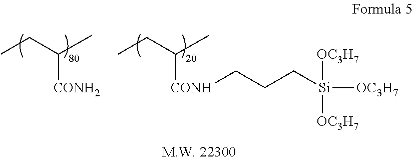

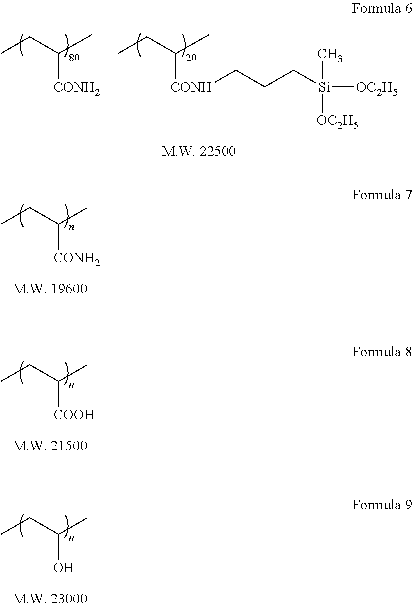

As for formulae 1 to 9, the weight average molecular weight (M.W.) is measured in terms of standard polystyrene by GPC.

### Preparation of Composition for Intermediate Layer

To 10 parts by weight of tetramethoxysilane was added titanium acetylacetonate in an amount equivalent to the mole number of the alkoxysilyl group of tetramethoxysilane and 900 parts by weight of distillated water and 1,000 parts by weight of ethanol were added thereto and the mixture was stirred at 20° C. for 30 minutes to obtain the composition for intermediate layer.

### Preparation of Hydrophilic Composition and Formation of Hydrophilic Layer

The hydrophilic polymer represented by formula 1, titanium acetylacetonate and other components were added in the amounts (% by weight) described in Table 1 and 900 parts by weight of distillated water and 1,000 parts by weight of ethanol were added per 100 parts by weight of the solid content of the mixture composed of the hydrophilic polymer, titanium acetylacetonate and other components, followed by stirring at 20° C. for 30 minutes to obtain the hydrophilic composition.

A surface of a PET film support described in Table 1 was subjected to a corona treatment in a treatment amount of 15 w·min/m² and the composition for intermediate layer described above was coated on the surface by controlling a coil diameter of a bar coater so as to have a thickness of 100 nm and dried at 180° C. for 5 seconds. On the intermediate layer was coated the hydrophilic composition described above by controlling a coil diameter of a bar coater so as to have a thickness of 100 nm, dried at 180° C. for 5 seconds and the film was rolled up.

The film roll obtained was subjected to a thermo treatment at 80° C. for 5 hours to prepare a hydrophilic film sample for Example 1.

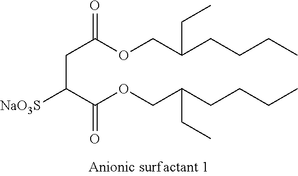

The thicknesses of the hydrophilic layer and intermediate layer were determined by observing the cross-section of the film using s scanning electron microscope.

### Example 2 to 13 and Comparative Examples 1 to 4

The hydrophilic film samples were produced in the same manner as in Example 1 except for changing the hydrophilic polymer, titanium acetylacetonate, other components, presence or absence of the intermediate layer, thickness of the hydrophilic layer and thickness of the intermediate layer as described in Table 1, respectively.

The thicknesses of the hydrophilic layer and intermediate layer were varied by controlling the solid content concentrations of the compositions, respectively.

### [Evaluation Method]

### Antifogging Sustainability

A cycle composed of spraying evenly water on the surface of the hydrophilic layer by an atomizer, exposing it to water vapor at 45° C. for 10 seconds, conducting an antifogging test of the hydrophilic layer, and then drying it at 80° C. for 1 minute is taken as one cycle and a number of cycles in which the fogged area on the surface of the hydrophilic layer becomes 80% or less in the antifogging test is evaluated (antifogging cycle test). The evaluation was conducted up to a maximum of 200 cycles.

### Appearance

The appearance of the surface of the hydrophilic layer after the antifogging cycle test described above was visually evaluated according to the criteria shown below.
Excellent: No change compared with before the antifogging cycle test.
Good: The transparency somewhat decreased compared with before the antifogging cycle test, but the visibility was maintained.
Bad: The transparency decreased and the visibility was lost.

### Water Droplet Contact Angle

The contact angle of the surface of the hydrophilic layer was determined with super pure water using a contact angle meter (DropMaster 500, produced by Kyowa Interface Science Co., Ltd.). The water droplet contact angle was determined initially and after the antifogging cycle test described above.

### Rubbing Resistance

The surface of the hydrophilic layer was repeatedly rubbed 5,000 times with nonwoven fabric (BEMCOT, produced by Asahi Kasei Fibers Corp.) wetted with distilled water at a surface pressure of 10 gf/cm² and a stroke of 30 mm and visually evaluated as follows:
Bad: Scratches were visually recognized on the surface.
Good: NO scratch was visually recognized, but the contact angle to water became 20° or more.
Excellent: NO scratch was visually recognized and the contact angle to water was less than 20°.

### Self-Cleaning Property

A circle having a diameter of 30 mm was drawn on the surface of the hydrophilic layer with an oily marker (MACKEE Black, produced by Zebra Co., Ltd.), dried at 50° C. for 10 minutes and then tap water was poured thereon at a flow rate of one liter/minute for 5 minutes to evaluate the removal of oily ink according to the criteria shown below.
Excellent: All of the oily ink was removed.
Good: 90% or more of the oily ink was removed.
Bad: Less than 90% of the oily ink was removed.

The evaluation results are shown in Table 2.

TABLE 1

| | | | | | | | | | | | Thick- | | |
|---|---|---|---|---|---|---|---|---|---|---|---|---|---|
| | | | | | | Titanium | | | | | ness | | |
| | | Hydrophilic Polymer | | | | Acetyl- | Other Components | | | | of | Intermediate | |
| | Base | | | | Content | acetonate | | Content | | Content | Hydro- | Layer | |
| | Mate- | Struc- | Polar | Alkoxysilyl | (% by | (% by | | (% by | | (% by | philic | Com- | Thick- |
| | rial | ture | Group | Group | weight) | weight) | Kind | weight) | Kind | weight) | Layer | pound | ness |
| Example 1 | PET | Form- | CONH₂ | Si(OC₂H₅)₃ | 80 | 1 | Anionic | 19 | — | — | 100 nm | TMOS | 100 nm |
| | | ula | | | | | Surfactant | | | | | | |
| | | 1 | | | | | 1 | | | | | | |
| Example 2 | PET | Form- | COOH | Si(OC₂H₅)₃ | 80 | 1 | Anionic | 19 | — | — | 100 nm | TMOS | 100 nm |
| | | ula | | | | | Surfactant | | | | | | |
| | | 2 | | | | | 1 | | | | | | |
| Example 3 | PET | Form- | OH | Si(OC₂H₅)₃ | 80 | 1 | Anionic | 19 | — | — | 100 nm | TMOS | 100 nm |
| | | ula | | | | | Surfactant | | | | | | |
| | | 3 | | | | | 1 | | | | | | |
| Example 4 | PET | Form- | CONH₂ | Si(OCH₃)₃ | 80 | 1 | Anionic | 19 | — | — | 100 nm | TMOS | 100 nm |
| | | ula | | | | | Surfactant | | | | | | |
| | | 4 | | | | | 1 | | | | | | |
| Example 5 | PET | Form- | CONH₂ | Si(OC₃H₇)₃ | 80 | 1 | Anionic | 19 | — | — | 100 nm | TMOS | 100 nm |
| | | ula | | | | | Surfactant | | | | | | |
| | | 5 | | | | | 1 | | | | | | |
| Example 6 | PET | Form- | CONH₂ | Si(OC₂H₅)₃ | 80 | 1 | Anionic | 19 | — | — | 50 nm | TMOS | 100 nm |
| | | ula | | | | | Surfactant | | | | | | |
| | | 1 | | | | | 1 | | | | | | |
| Example 7 | PET | Form- | CONH₂ | Si(OC₂H₅)₃ | 80 | 1 | Anionic | 19 | — | — | 30 nm | TMOS | 100 nm |
| | | ula | | | | | Surfactant | | | | | | |
| | | 1 | | | | | 1 | | | | | | |
| Example 8 | PET | Form- | CONH₂ | Si(OC₂H₅)₃ | 80 | 1 | Anionic | 19 | — | — | 20 nm | TMOS | 100 nm |
| | | ula | | | | | Surfactant | | | | | | |
| | | 1 | | | | | 1 | | | | | | |
| Example 9 | PET | Form- | CONH₂ | Si(OC₂H₅)₃ | 80 | 1 | Anionic | 19 | — | — | 200 nm | TMOS | 100 nm |
| | | ula | | | | | Surfactant | | | | | | |
| | | 1 | | | | | 1 | | | | | | |
| Example 10 | PET | Form- | CONH₂ | Si(OC₂H₅)₃ | 80 | 1 | Anionic | 19 | — | — | 100 nm | — | — |
| | | ula | | | | | Surfactant | | | | | | |
| | | 1 | | | | | 1 | | | | | | |
| Example 11 | PET | Form- | CONH₂ | Si(OC₂H₅)₃ | 80 | 1 | Anionic | 19 | — | — | 100 nm | MTMS | 100 nm |
| | | ula | | | | | Surfactant | | | | | | |
| | | 1 | | | | | 1 | | | | | | |
| Example 12 | PET | Form- | CONH₂ | Si(OC₂H₅)₃ | 80 | 1 | Anionic | 19 | — | — | 100 nm | TMOS/ | 100 nm |
| | | ula | | | | | Surfactant | | | | | MTMS = | |
| | | 1 | | | | | 1 | | | | | 50/50 | |
| Example 13 | PET | Form- | CONH₂ | Si(OC₂H₅)₃ | 80 | 1 | Anionic | 19 | — | — | 100 nm | TMOS | 100 nm |
| | | ula | | | | | Surfactant | | | | | | |
| | | 6 | | | | | 1 | | | | | | |
| Com- | PET | Form- | CONH₂ | Si(OC₂H₅)₃ | 70 | 1 | Anionic | 19 | SNOWTEX | 10 | 100 nm | TMOS | 100 nm |
| parative | | ula | | | | | Surfactant | | C | | | | |
| Example 1 | | 1 | | | | | 1 | | | | | | |
| Com- | PET | Form- | CONH₂ | — | 100 | — | — | — | — | — | 100 nm | TMOS | 100 nm |
| parative | | ula | | | | | | | | | | | |
| Example 2 | | 7 | | | | | | | | | | | |
| Com- | PET | Form- | COOH | — | 100 | — | — | — | — | — | 100 nm | TMOS | 100 nm |
| parative | | ula | | | | | | | | | | | |
| Example 3 | | 8 | | | | | | | | | | | |
| Com- | PET | Form- | OH | — | 100 | — | — | — | — | — | 100 nm | TMOS | 100 nm |
| parative | | ula | | | | | | | | | | | |
| Example 4 | | 9 | | | | | | | | | | | |

TABLE 2

| | Antifogging | After Antifogging Cycle Test | | Rubbing | Self-Cleaning |
|---|---|---|---|---|---|
| | sustainability | Appearance | Contact Angle | Resistance | Property |
| Example 1 | 200 Cycles | Excellent | 10° | Excellent | Excellent |
| Example 2 | 200 Cycles | Excellent | 13° | Excellent | Excellent |
| Example 3 | 200 Cycles | Excellent | 13° | Excellent | Excellent |
| Example 4 | 200 Cycles | Excellent | 12° | Excellent | Excellent |
| Example 5 | 200 Cycles | Excellent | 11° | Excellent | Excellent |
| Example 6 | 200 Cycles | Excellent | 10° | Excellent | Excellent |
| Example 7 | 200 Cycles | Good | 15° | Good | Good |
| Example 8 | 200 Cycles | Good | 15° | Good | Good |
| Example 9 | 200 Cycles | Good | 10° | Excellent | Excellent |
| Example 10 | 150 Cycles | Excellent | 13° | Excellent | Excellent |
| Example 11 | 200 Cycles | Excellent | 12° | Excellent | Excellent |
| Example 12 | 200 Cycles | Excellent | 10° | Excellent | Excellent |
| Example 13 | 200 Cycles | Excellent | 11° | Excellent | Excellent |
| Comparative | 200 Cycles | Excellent | 11° | Bad | Bad |
| Example 1 | | | | | |
| Comparative | 30 Cycles | Bad | 65° | Bad | Bad |
| Example 2 | | | | | |
| Comparative | 45 Cycles | Bad | 62° | Bad | Bad |
| Example 3 | | | | | |
| Comparative | 30 Cycles | Bad | 65° | Bad | Bad |
| Example 4 | | | | | |

The initial contact angles before the antifogging cycle test of the examples and comparative examples were all 5° or less respectively.

In Table 1, “PET” represents a biaxially oriented polyethylene terephthalate film (thickness of 100 μm), “SNOWTEX C” represents colloidal silica (average diameter of 10 to 20 nm) produced by Nissan Chemical Industries, Ltd., “TMOS” represents tetramethoxysilane (reagent produced by Wako Pure Chemicals Industries, Ltd.), and “MTMS” represents methyltrimethoxysilane (reagent produced by Tokyo Chemical Industry Co., Ltd.).

### INDUSTRIAL APPLICABILITY

According to the invention, a hydrophilic film which has high hydrophilicity and is excellent in the sustainability of antifogging effect, rubbing resistance and self-cleaning property can be provided. Although the invention has been described in detail and by reference to specific embodiments, it is apparent to those skilled in the art that it is possible to add various alterations and modifications insofar as the alterations and modifications do not deviate from the spirit and the scope of the invention.

This application is based on a Japanese patent application filed on Jan. 30, 2009 (Japanese Patent Application No. 2009-20607), and the contents thereof are incorporated herein by reference.

1. A hydrophilic film comprising a hydrophilic layer formed with a hydrophilic composition on a polyester film, wherein the hydrophilic composition contains 80% by weight or more of a hydrophilic polymer based on a total solid content of the hydrophilic composition.

2. The hydrophilic film as claimed in claim 1, wherein the hydrophilic polymer contains at least one polar group selected from the following groups and an alkoxysilyl group:
Polar group: —CONH₂, —COOM and —OH
(wherein M represents a hydrogen atom, an alkali metal or an alkaline earth metal);
Alkoxysilyl group: —Si—(OR)ₙR₃₋ₙ
(wherein R each independently represents —CH₃, —C₂H₅ or —C₃H₇, and n represents 2 or 3).

3. The hydrophilic film as claimed in claim 1, which comprises an intermediate layer formed with a composition containing at least one compound selected from tetramethoxysilane, methyltrimethoxysilane, tetraethoxysilane and methyltriethoxysilane between the polyester film and the hydrophilic layer.

4. The hydrophilic film as claimed in claim 3, wherein the polar group of the hydrophilic polymer is at least one group selected from —CONH₂, —COOM and —OH and the intermediate layer is formed with a composition containing at least one compound selected from tetramethoxysilane and methyltrimethoxysilane.

5. The hydrophilic film as claimed in claim 3, wherein a thickness of the hydrophilic layer and the intermediate layer is from 30 to 200 nm.

6. The hydrophilic film as claimed in claim 1, wherein a water droplet contact angle on a surface of the hydrophilic layer after repeating 100 cycles of spraying water on the surface of the hydrophilic layer and drying at 80° C. for 5 seconds is 15° or less.

7. The hydrophilic film as claimed in claim 2, which comprises an intermediate layer formed with a composition containing at least one compound selected from tetramethoxysilane, methyltrimethoxysilane, tetraethoxysilane and methyltriethoxysilane between the polyester film and the hydrophilic layer.

8. The hydrophilic film as claimed in claim 7, wherein the polar group of the hydrophilic polymer is at least one group selected from —CONH₂, —COOM and —OH and the intermediate layer is formed with a composition containing at least one compound selected from tetramethoxysilane and methyltrimethoxysilane.

9. The hydrophilic film as claimed in claim 4, wherein a thickness of the hydrophilic layer and the intermediate layer is from 30 to 200 nm.

10. The hydrophilic film as claimed in claim 7, wherein a thickness of the hydrophilic layer and the intermediate layer is from 30 to 200 nm.

11. The hydrophilic film as claimed in claim 8, wherein a thickness of the hydrophilic layer and the intermediate layer is from 30 to 200 nm.

12. The hydrophilic film as claimed in claim 2, wherein a water droplet contact angle on a surface of the hydrophilic layer after repeating 100 cycles of spraying water on the surface of the hydrophilic layer and drying at 80° C. for 5 seconds is 15° or less.

13. The hydrophilic film as claimed in claim 3, wherein a water droplet contact angle on a surface of the hydrophilic layer after repeating 100 cycles of spraying water on the surface of the hydrophilic layer and drying at 80° C. for 5 seconds is 15° or less.

14. The hydrophilic film as claimed in claim 4, wherein a water droplet contact angle on a surface of the hydrophilic layer after repeating 100 cycles of spraying water on the surface of the hydrophilic layer and drying at 80° C. for 5 seconds is 15° or less.

15. The hydrophilic film as claimed in claim 5, wherein a water droplet contact angle on a surface of the hydrophilic layer after repeating 100 cycles of spraying water on the surface of the hydrophilic layer and drying at 80° C. for 5 seconds is 15° or less.

16. The hydrophilic film as claimed in claim 7, wherein a water droplet contact angle on a surface of the hydrophilic layer after repeating 100 cycles of spraying water on the surface of the hydrophilic layer and drying at 80° C. for 5 seconds is 15° or less.

17. The hydrophilic film as claimed in claim 8, wherein a water droplet contact angle on a surface of the hydrophilic layer after repeating 100 cycles of spraying water on the surface of the hydrophilic layer and drying at 80° C. for 5 seconds is 15° or less.

18. The hydrophilic film as claimed in claim 9, wherein a water droplet contact angle on a surface of the hydrophilic layer after repeating 100 cycles of spraying water on the surface of the hydrophilic layer and drying at 80° C. for 5 seconds is 15° or less.

19. The hydrophilic film as claimed in claim 10, wherein a water droplet contact angle on a surface of the hydrophilic layer after repeating 100 cycles of spraying water on the surface of the hydrophilic layer and drying at 80° C. for 5 seconds is 15° or less.

20. The hydrophilic film as claimed in claim 11, wherein a water droplet contact angle on a surface of the hydrophilic layer after repeating 100 cycles of spraying water on the surface of the hydrophilic layer and drying at 80° C. for 5 seconds is 15° or less.
